(19) United States
(12) Patent Application Publication
(10) Pub. No.: US 2026/0128833 A1
(43) Pub. Date: May 7, 2026

(54) LOW OVERHEAD CSI-RS TRANSMISSION AND CSI FEEDBACK FRAMEWORK

(71) Applicant: Samsung Electronics Co., Ltd., Suwon-si (KR)

(72) Inventors: Xinliang Zhang, Plano, TX (US); Young Han Nam, Plano, TX (US)

(21) Appl. No.: 19/367,747

(22) Filed: Oct. 23, 2025

Related U.S. Application Data
(60) Provisional application No. 63/716,529, filed on Nov. 5, 2024.
(60) Provisional application No. 63/724,134, filed on Nov. 22, 2024.
(60) Provisional application No. 63/758,092, filed on Feb. 13, 2025.
(60) Provisional application No. 63/789,037, filed on Apr. 15, 2025.
(60) Provisional application No. 63/852,399, filed on Jul. 28, 2025.

(51) Int. Cl. H04L 5/00; H04B 7/06; H04W 24/08

(52) U.S. Cl. CPC H04L 5/0051; H04B 7/0626; H04W 24/08

(57) ABSTRACT

A user equipment (UE) includes a transceiver configured to receive, from a base station (BS), a sparse channel state information (CSI)-reference signal (RS) resource configuration, and receive, from the BS, a CSI-RS based on the sparse CSI-RS resource configuration. The UE also includes a processor operably coupled to the transceiver. The processor is configured to generate, based on the sparse CSI-RS resource configuration, sparse CSI based on measurement of the received CSI-RS.

### CROSS-REFERENCE TO RELATED APPLICATION(S) AND CLAIM OF PRIORITY

This application claims priority under 35 U.S.C. § 119(e) to U.S. Provisional Patent Application No. 63/716,529 filed on Nov. 5, 2024, U.S. Provisional Patent Application No. 63/724,134 filed on Nov. 22, 2024, U.S. Provisional Patent Application No. 63/758,092 filed on Feb. 13, 2025, U.S. Provisional Patent Application No. 63/789,037 filed on Apr. 15, 2025, and U.S. Provisional Patent Application No. 63/852,399 filed on Jul. 28, 2025. The above-identified provisional patent applications are hereby incorporated by reference in their entirety.

### TECHNICAL FIELD

This disclosure relates generally to wireless networks. More specifically, this disclosure relates to low overhead channel state information (CSI)-reference signal (RS) transmission and CSI feedback frameworks.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies (RATs)) to flexibly accommodate various services/applications with different requirements, new multiple access schemes to support massive connections, etc.

### SUMMARY

This disclosure provides apparatuses and methods for low overhead CSI-RS transmission and CSI feedback.

In one embodiment, a user equipment (UE) is provided. The UE includes a transceiver configured to receive, from a base station (BS), a sparse channel state information CSI-RS resource configuration, and receive, from the BS, a CSI-RS based on the sparse CSI-RS resource configuration. The UE also includes a processor operably coupled to the transceiver. The processor is configured to generate, based on the sparse CSI-RS resource configuration, sparse CSI based on measurement of the received CSI-RS.

In another embodiment, A BS is provided. The BS includes a processor configured to generate a sparse CSI-RS resource configuration. The BS also includes a transceiver operably coupled to the processor. The transceiver is configured to transmit, to a UE, the sparse CSI-RS resource configuration, transmit, to the UE, a CSI-RS based on the sparse CSI-RS resource configuration, and receive, from the UE, a CSI report based on the CSI-RS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates example antenna beamforming architecture according to embodiments of the present disclosure;

FIG. 5 illustrates an example extremely massive MIMO antenna panel according to embodiments of the present disclosure;

FIG. 6 illustrates examples of sparse sub-sampling according to embodiments of the present disclosure;

FIG. 7 illustrates an example of pseudo-random low-density CSI-RS-resource-port-to-RE mapping according to embodiments of the present disclosure;

FIG. 8 illustrates an example of sparse & pseudo-random per-resource CSI-RS RE mapping provided across ports & PRBs according to embodiments of the present disclosure;

FIG. 9 illustrates an example CSI-RS triggering state according to embodiments of the present disclosure;

FIG. 10 illustrates an example CSI-RS-port-to-PRB mapping according to embodiments of the present disclosure;

FIG. 11 illustrates an example pseudo-random CSI-RS-port-to-PRB mapping according to embodiments of the present disclosure;

FIG. 12 illustrates another example pseudo-random CSI-RS-port-to-PRB mapping according to embodiments of the present disclosure;

FIGS. 13A and 13B illustrate an example AP-CSI state configuration according to embodiments of the present disclosure;

FIG. 14 illustrates an example multi-AP based CSI-RS transmission and reconstruction framework for efficient CSI handling according to embodiments of the present disclosure;

FIG. 15 illustrates an example UE side CSI encoder according to embodiments of the present disclosure;

FIG. 16 illustrates another example UE side CSI encoder according to embodiments of the present disclosure;

FIG. 17 illustrates an example of multiple training data sets according to embodiments of the present disclosure;

FIG. 18 illustrates an example of truncated input encoder training according to embodiments of the present disclosure;

FIG. 19 illustrates an example of RRC including extended CSI-RS configurations according to embodiments of the present disclosure;

FIG. 20 illustrates an example CSI-RS configuration according to embodiments of the present disclosure;

FIG. 21 illustrates an example of RRC including CSI-RS configuration templates according to embodiments of the present disclosure;

FIG. 22 illustrates an example CSI-RS configuration according to embodiments of the present disclosure;

FIG. 23 illustrates an example of CSI-RS port density indications according to embodiments of the present disclosure;

FIG. 24 illustrates another example of CSI-RS port density indications according to embodiments of the present disclosure;

FIG. 25 illustrates another example of CSI-RS port density indications according to embodiments of the present disclosure;

FIGS. 26-32 illustrate examples of CSI-RS RE mapping according to embodiments of the present disclosure;

FIGS. 33A and 33B illustrate an example mapping pattern generation according to embodiments of the present disclosure;

FIGS. 34A and 34B illustrate an example mapping pattern insertion according to embodiments of the present disclosure;

FIG. 35 illustrates an example CSI-RS resource configuration framework according to embodiments of the present disclosure;

FIG. 36 illustrates an example patch size and shape configuration according to embodiments of the present disclosure;

FIG. 37 illustrates another example patch size and shape configuration according to embodiments of the present disclosure;

FIGS. 38A and 38B illustrate example mapping patterns according to embodiments of the present disclosure;

FIG. 39 illustrates an example application of multiple orthogonal mapping patterns according to embodiments of the present disclosure;

FIG. 40 illustrates an example application of multiple orthogonal mapping patterns according to embodiments of the present disclosure;

FIG. 41 illustrates another example mapping pattern to physical resource mapping according to embodiments of the present disclosure;

FIGS. 42A and 42B illustrate an example mapping pattern to physical resource mapping according to embodiments of the present disclosure;

FIGS. 43A and 43B illustrate an example mapping pattern to physical resource mapping according to embodiments of the present disclosure;

FIGS. 44A and 44B illustrate an example mapping pattern to physical resource mapping according to embodiments of the present disclosure;

FIGS. 45-48 illustrate example CSI in-painting frameworks according to embodiments of the present disclosure;

FIG. 49 illustrates an example configuration signaling for CSI-RS resource and CSI-RS port to resource mapping according to embodiments of the present disclosure;

FIGS. 50-57 illustrate example configuration signaling for sparsely sub-sampled CSI-RS according to embodiments of the present disclosure;

FIG. 58 illustrates an example method for low overhead CSI-RS transmission and CSI feedback according to embodiments of the present disclosure; and

FIG. 59 illustrates another example method for low overhead CSI-RS transmission and CSI feedback according to embodiments of the present disclosure.

### DETAILED DESCRIPTION

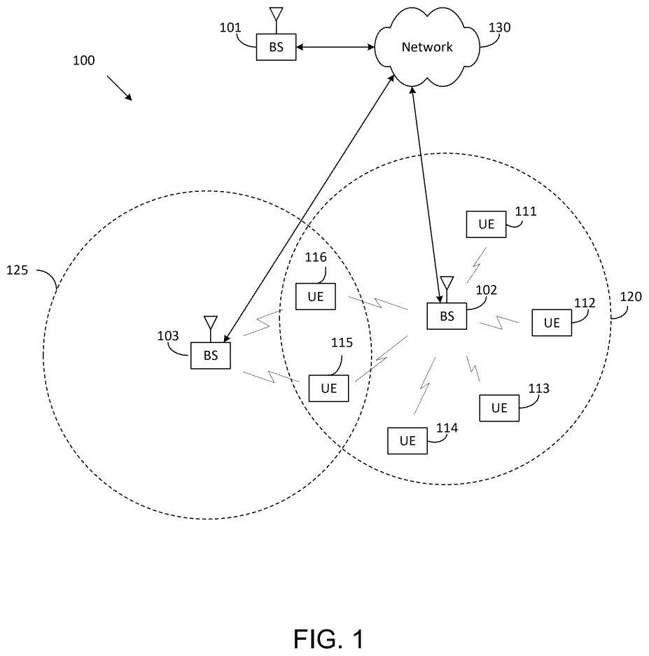

FIGS. 1 through 59, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for low overhead CSI-RS transmission and CSI feedback. In certain embodiments, one or more of the gNBs 101-103 includes circuitry, programing, or a combination thereof, to support low overhead CSI-RS transmission and CSI feedback in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

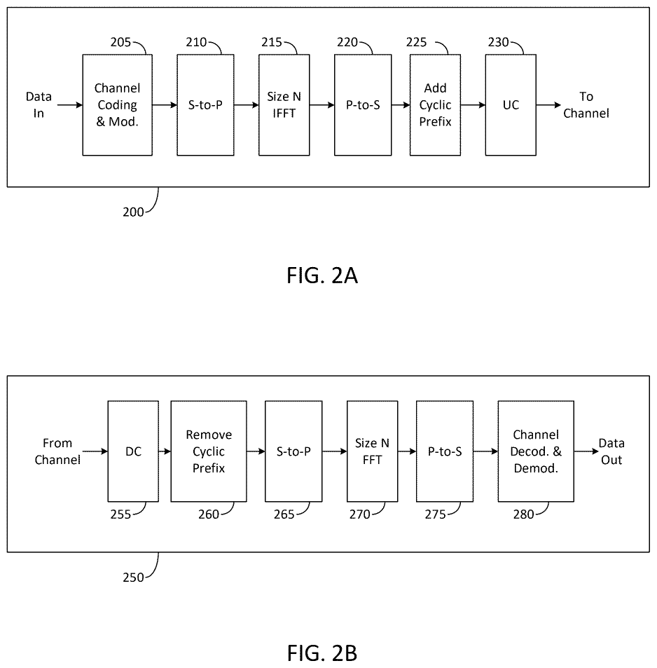

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support low overhead CSI-RS transmission and CSI feedback as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

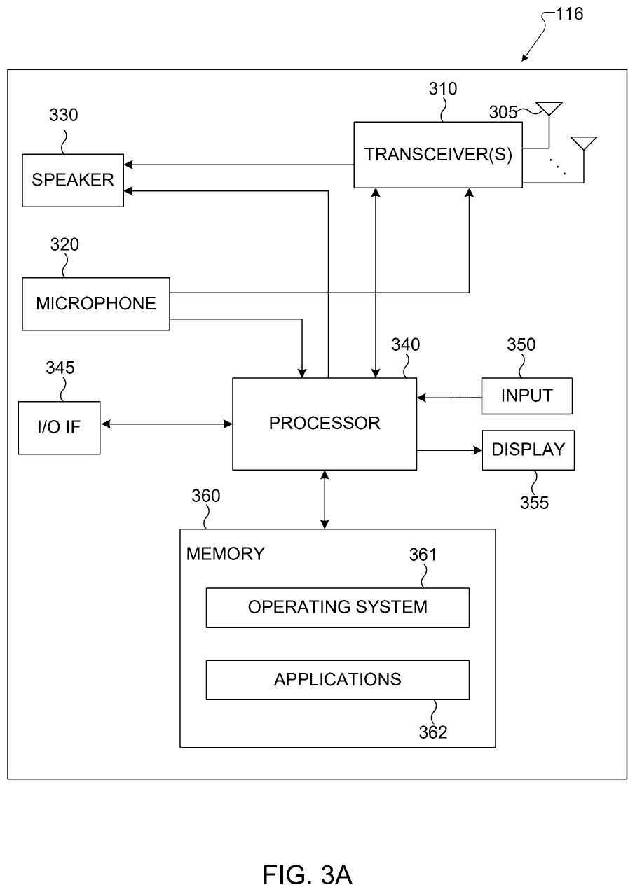

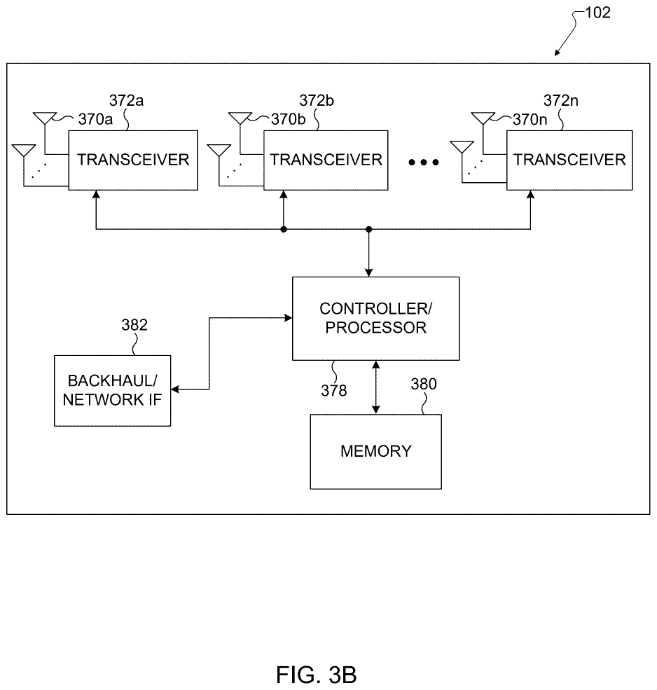

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for low overhead CSI-RS transmission and CSI feedback as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support low overhead CSI-RS transmission and CSI feedback as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports will remain more or less the same.

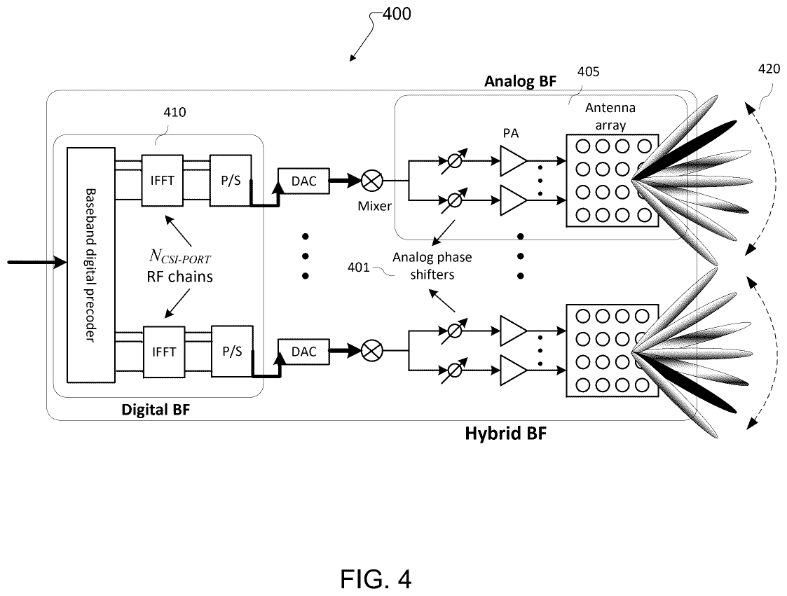

For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mm Wave frequencies) as illustrated by beamforming architecture 400 in FIG. 4.

FIG. 4 illustrates example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Although FIG. 4 illustrates one example antenna beamforming architecture 400, various changes may be made to FIG. 4. For example, various components in FIG. 4 could be combined, further subdivided, or omitted and additional components could be added according to particular needs.

Wireless networks may incorporate cell-free massive MIMO (Multiple-Input Multiple-Output). Unlike cellular networks that serve users with a single cell, cell-free MIMO utilizes a large number of distributed access points (APs) that cooperatively serve a smaller number of users, simultaneously, over the same frequency band. This approach dissolves cell boundaries, creating a cell-free experience. Some benefits of cell-free MIMO include:
Enhanced coverage and capacity: Cell-Free MIMO offers uniform coverage and increased capacity, especially in areas with high user density, such as stadiums, public venues, and urban centers.
Improved user experience: Users benefit from consistent and reliable connectivity, regardless of their location, with reduced handovers and seamless service continuity.
Increased efficiency: Cell-Free MIMO optimizes resource utilization, reducing interference and power consumption, leading to a more sustainable and environmentally friendly network infrastructure.

Cell-free MIMO technology is being integrated into 5G NR (New Radio) standards, enabling seamless deployment and interoperability. This provides a smooth transition from existing cellular networks to cell-free MIMO, leveraging existing infrastructure and facilitating widespread adoption.

In 5G NR, Radio Resource Control (RRC) signaling is utilized for establishing and maintaining connections between the User Equipment (UE) and the Base Station (BS) or gNodeB (gNB). RRC signaling supports tasks like connection establishment, handover, resource allocation, and configuration. A brief overview of how RRC signaling occurs and how much data is exchanged between the BS and UE is provided below.

A UE can operate in different RRC states, primarily RRC_IDLE, RRC_CONNECTED, and RRC_INACTIVE. In RRC_IDLE, the UE is not actively communicating with the network but can listen for paging messages and acquire system information. In RRC_CONNECTED, the UE has an active connection with the network, allowing data transfer and real-time signaling. RRC_INACTIVE allows the UE to retain some connection context for faster reconnection, reducing latency and signaling overhead. When the UE needs to send data or receive an incoming call, it transitions from RRC_IDLE or RRC_INACTIVE to RRC_CONNECTED via an RRC connection setup procedure.

RRC signaling procedures vary depending on the state transition and operation.
System Information Acquisition: The UE acquires system information from broadcast messages when it first connects or after a long idle period. System Information Blocks (SIBs), particularly MIB (Master Information Block) and SIB1, provide information on cell identity, access control, and RACH (Random Access Channel) configuration. A SIB1 can be around 50-100 bytes.
During, RRC Connection Setup: When moving from RRC_IDLE or RRC_INACTIVE to RRC_CONNECTED, the UE initiates an RRC Connection Request, and the gNB responds with an RRC Connection Setup message, including configuration information like security, mobility parameters, and bearer setup. RRC Connection Setup signaling typically uses ˜100-300 bytes in each direction.
RRC Reconfiguration: After establishing a connection, RRC Reconfiguration messages can be used to adjust UE settings, configure new bearers, or initiate a handover. Each RRC Reconfiguration message can range from 100-500 bytes, depending on the complexity of the configuration.
Handover: During mobility, RRC signaling manages handovers between cells. An RRC Reconfiguration message handles the handover and may involve data forwarding and synchronization. Handovers might use additional signaling (100-500 bytes) between the gNBs.
Paging: When the network wishes to reach a UE in RRC_IDLE or RRC_INACTIVE state, it sends a paging message, prompting the UE to resume a connection. Paging messages are lightweight, generally a few bytes.
Connection Release: When data transfer completes, the gNB may release the RRC connection, transitioning the UE back to RRC_IDLE or RRC_INACTIVE state. RRC Connection Release message is typically around 50-100 bytes.

The overall RRC signaling overhead between the BS and UE depends on the network activity. For instance, an initial connection setup typically involves a few hundred bytes, as it includes system information acquisition, connection setup, and security configuration. Reconfiguration or handover procedures have a moderate amount of data exchange but are more frequent in high-mobility scenarios. In summary, RRC signaling exchanges are usually lightweight but vary by state and operation. Generally:
Initial setup and configuration: ˜300-600 bytes.
Reconfiguration and handover: ˜100-500 bytes per procedure.
Paging and idle-to-active transitions: less than 100 bytes.

Frequent configuration signaling increases data exchange costs for beam management and CSI acquisition. Configuration signaling, for example RRC signaling, occurs during initial connections, UE state changes, and cell switching. This leads to increased data exchange costs especially at:
High mobility scenarios and dense network areas: In traditional cell-based networks, UEs with high mobility experience frequent cell switching and handovers. In areas with small cells with dense BS deployments, UEs often switch between base stations, resulting in repeated RRC signaling.
Advanced scenarios: Flexibility of the configurations requires more data in the due to a high number of configuration instance and states are required, For example, dynamic serving cluster in cell-free MIMO, flexible hybrid beam management in massive MIMO or extreme MIMO.

In scenarios that involve one or multiple serving TRPs, the physical resource consumption for CSI-RS transmission increases multiple times, as the CSI of all TRPs are utilized for reliable and high-throughput wireless transmissions. In cell-free MIMO, dynamic configuration of multiple RUs (Radio Units) in a serving cluster uses diverse signaling setups. The CSI-RS transmission overhead surges when multiple TRPs are scheduled to one UE.

Various embodiments of the present disclosure provide frameworks for CSI-RS management, and enhance system performance with scalability, especially for cell-free MIMO.

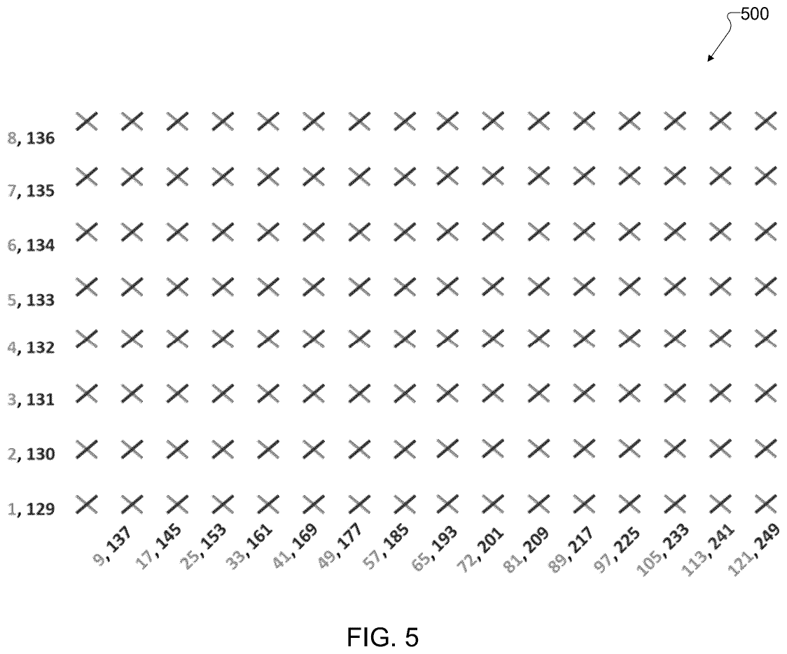

FIG. 5 illustrates an example extremely massive MIMO antenna panel 500 according to embodiments of the present disclosure. The embodiment of an extremely massive MIMO antenna panel of FIG. 5 is for illustration only. Different embodiments of an extremely massive MIMO antenna panel could be used without departing from the scope of this disclosure.

In the example of FIG. 5, the extremely massive MIMO antenna panel, comprises 256 dual-polarized digital ports placed on a 2D plane constructed according to some embodiments of the present disclosure. On the horizontal axis, there are 16 ports per polarization. On the vertical axis, there are 8 ports per polarization. The digital ports with the first polarization are demonstrated in light-gray color, with −45 degree slope, and indexing from 1 to 128; the second polarization are in a darker gray color, with 45 degree slope, and indexing from 129 to 256. In this example, the digital ports correspond to an array in [Nᵥ×Nₕ×Nₚ]=[8×16×2] in vertical, horizontal, and polarization respectively.

Although FIG. 5 illustrates one example extremely massive MIMO antenna panel 500, various changes may be made to FIG. 5. For example, various changes to the number of ports could be made, etc., according to particular needs.

In 5G New Radio (NR) or 6G networks, Channel State Information Reference Signals (CSI-RSs) are used to measure the channel quality and enable accurate channel estimation, beamforming, and link adaptation. However, the transmission of a CSI-RS incurs significant overhead, which can lead to reduced spectral efficiency and increased latency.

In existing wireless networks, a CSI-RS resource may be configured for each port. A dedicated instance of CSI-RS resource mapping configuration is used for each port or a code division multiplexing (CDM group) of ports. In massive MIMO (M-MIMO) or extreme MIMO (X-MIMO) systems, the number of antenna ports can be 64 or 256. Issues with CSI-RS resource configuration in existing wireless networks include:
High DL overhead and UE complexity: BS transmission and UE measurement of all the CSI-RS ports has a high DL overhead and UE side complexity. Due to UE side complexity constraint, reducing CSI-RS ports degrades CSI accuracy.
High RRC signaling overhead: Configuring CSI-RS port for each antenna port uses a large number of CSI-RS resource mapping instances in the configuration signaling, (i.e., RRC signaling).
Over design with redundant flexibility: In such systems, the network does not need the full flexibility of mapping CSI-RS port to an arbitrary location of the resource grid.

Various embodiments of the present disclosure provide a patch-pattern based sparse CSI-RS resource configuration and CSI feedback configuration framework, which reduce the overhead of CSI-RS resource transmission and associated signaling.

The concept of sub-sampled CSI-RS has been introduced to wireless networks to mitigate the overhead of CSI-RS transmission. The idea behind sub-sampled CSI-RS is to reduce the density of CSI-RS transmission in the time-frequency domain, while still maintaining acceptable channel estimation performance. Sub-sampled CSI-RS involves transmitting CSI-RS only on a subset of resource elements (REs) within a resource block (RB). This is achieved by introducing a sub-sampling factor, which determines the spacing between consecutive CSI-RS REs.

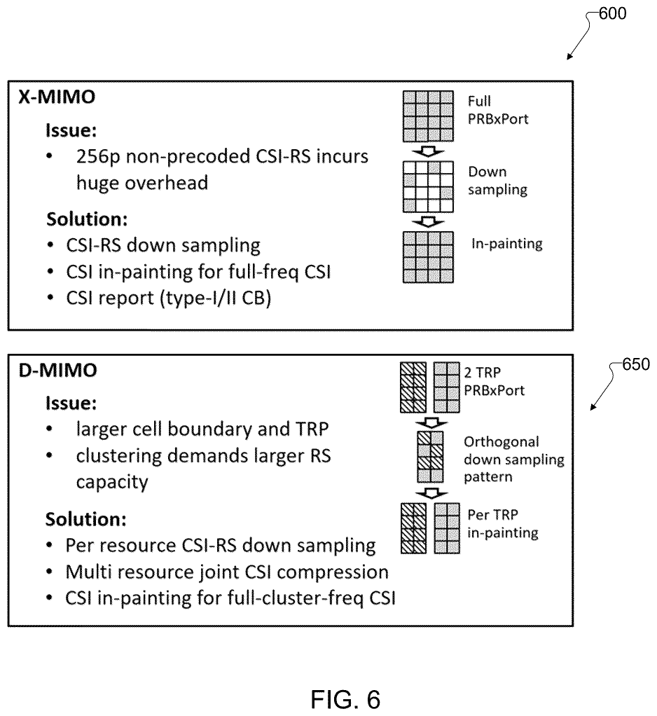

Examples of X-MIMO and distributed MIMO (D-MIMO) with CSI-RS sparse sub-sampling are illustrated in FIG. 6.

FIG. 6 illustrates examples of sparse sub-sampling 600 and 650 according to embodiments of the present disclosure. The embodiments of sparse sub-sampling of FIG. 6 are for illustration only. Different embodiments of sparse sub-sampling could be used without departing from the scope of this disclosure.

In the example of FIG. 6, sparse sub-sampling 600 is an example of sparse sub-sampling for X-MIMO, and sparse sub-sampling 650 is an example of sparse sub-sampling for D-MIMO.

Although FIG. 6 illustrates examples of sparse sub-sampling 600 and 650, various changes may be made to FIG. 6. For example, various changes to down sampling patterns could be made, etc., according to particular needs.

The use of sub-sampled CSI-RS offers several benefits, including:
Reduced overhead: By transmitting CSI-RS on fewer REs, the overall overhead of CSI-RS transmission is reduced.
Improved spectral efficiency: With reduced overhead, more resources become available for data transmission, leading to improved spectral efficiency.
Enhanced latency performance: By reducing the overhead of CSI-RS transmission, latency-critical applications can benefit from faster channel estimation and link adaptation.

While sub-sampled CSI-RS offers significant benefits, there are still challenges to be addressed, such as:
Channel estimation accuracy: Sub-sampled CSI-RS may lead to reduced channel estimation accuracy, particularly in scenarios with high mobility or frequency selectivity.
Optimization of sub-sampling factors: The choice of sub-sampling factors can significantly impact the performance of sub-sampled CSI-RS.

Sparse CSI-RS reduces CSI-RS overhead which is beneficial in massive MIMO networks. In such a scenario, not all the CSI-RS port will be transmitted in a certain band, for example, in one or multiple RBs.

For a UE to perform full channel reconstruction from sparse CSI-RS, the BS should indicate the CSI-RS ports and relative configuration of the sparsely sub-selected CSI-RS ports to the UE. However, existing wireless networks do not support the signaling of sparse CSI-RS.

In present wireless networks, a UE assumes all CSI-RS port are transmitted. The UE infers CSI-RS port numbering from the RE mapping, in which, the UE cannot acquire the actual CSI-RS port numbering from the received sub-sampled CSI-RS.

Various embodiments of the present disclosure provide for signaling to indicate CSI-RS ports and relative configuration of sparsely sub-selected CSI-RS ports to a UE.

As noted above, various embodiments of the present disclosure provide frameworks for CSI-RS management.

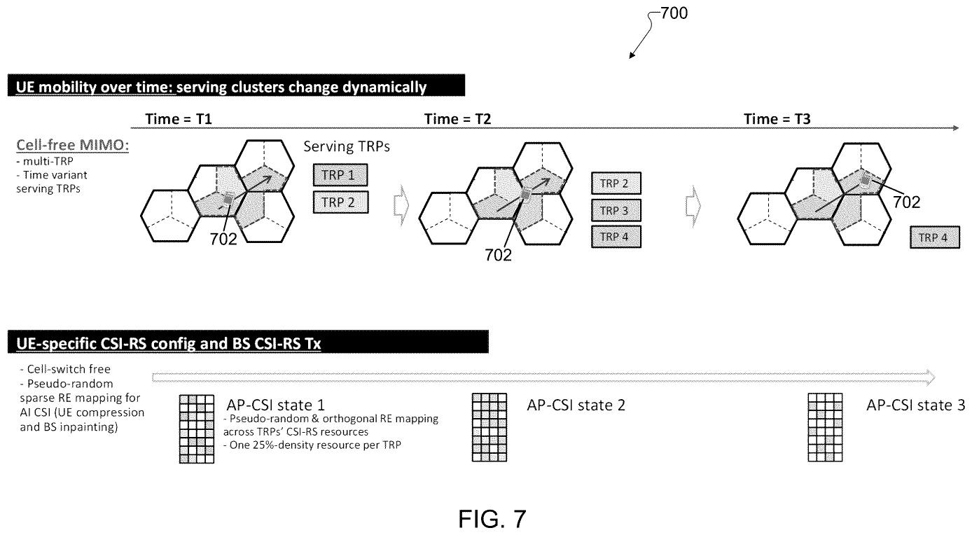

In some embodiments, a UE may receive CSI-RS with pseudo-random low-density CSI-RS-resource-port-to-RE mapping, similar as shown in FIG. 7.

FIG. 7 illustrates an example of pseudo-random low-density CSI-RS-resource-port-to-RE mapping 700 according to embodiments of the present disclosure. The embodiment of pseudo-random low-density CSI-RS-resource-port-to-RE mapping of FIG. 7 is for illustration only. Different embodiments of pseudo-random low-density CSI-RS-resource-port-to-RE mapping could be used without departing from the scope of this disclosure.

In the example of FIG. 7, a unified set of CSI-RS configurations that remains valid over a large area. Along the trajectory of a UE 702, the UE 702's reception of CSI-RS is configured with pseudo-random CSI-RS-resource-port-to-RE mapping with a low-density. As shown in FIG. 7, per transmission time interval (TTI) selected aperiodic-CSI (AP-CSI) states (e.g., state 1 at time T1, etc.) are configured. Each AP-CSI state associates with one or multiple CSI-RS resources with pseudo-random mapping with ¼ density (0.25 REs per port per PRB for each CSI-RS resource) and orthogonal RE pattern applied. All of the CSI-RS ports associated to the AP-CSI state are transmitted, while the CSI-RS overhead is reduced by the CSI-RS port density of the mapping pattern.

Although FIG. 7 illustrates one of example pseudo-random low-density CSI-RS-resource-port-to-RE mapping 700, various changes may be made to FIG. 7. For example, various changes to the RE mapping could be made, etc., according to particular needs.

In some embodiments, signaling is provided for pseudo-random and low-density CSI-RS-to-RE-resource mapping configuration, enabling dynamic CSI-RS resources allocation mechanisms that adjust CSI-RS resources based on a real-time serving cluster of UE mobility, adapting resource usage for enhanced CSI measurement and reconstruction precision. Various embodiments of the present disclosure provide different combinations of configuration signaling (RRC) and indication signaling (DCI).

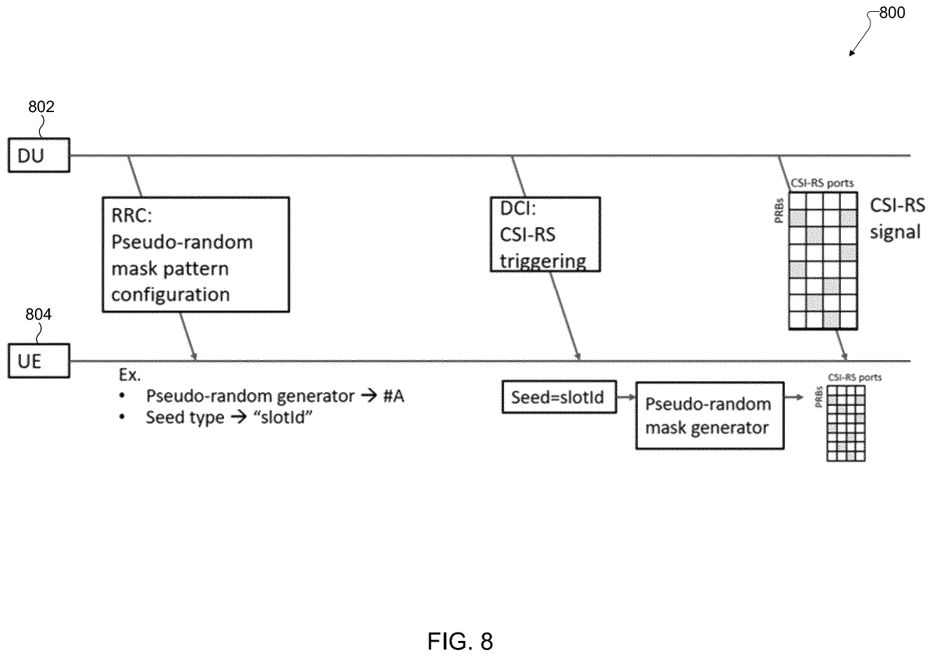

In some embodiments, sparse & pseudo-random per-resource CSI-RS RE mapping may be provided across ports & PRBs, similar as shown in FIG. 8.

FIG. 8 illustrates an example of sparse & pseudo-random per-resource CSI-RS RE mapping provided across ports & PRBs 800 according to embodiments of the present disclosure. The embodiment of sparse & pseudo-random per-resource CSI-RS RE mapping provided across ports & PRBs of FIG. 8 is for illustration only. Different embodiments of sparse & pseudo-random per-resource CSI-RS RE mapping provided across ports & PRBs could be used without departing from the scope of this disclosure.

In the example of FIG. 8, a sparse, pseudo-random mapping strategy across RE and CSI-RS ports is employed. The CSI-RS density is reduced per CSI-RS resource to ease the CSI-RS overhead with a varying serving cluster. The pseudo-random CSI-RS port to RE mapping improves CSI compression efficiency and BS CSI in-painting reconstruction accuracy.

As shown in FIG. 8, a DU 802 configures a UE 804 with the CSI-RS RE resource mapping pattern through RRC, including the pseudo-random CSI-RS port to RE resource mapping pattern generator, and a seed configuration. When UE 804 receives the CSI-RS triggering signal, the UE 804 is able to generate the RE resource mapping pattern and the corresponding RE mapping for CSI-RS signal reception.

Although FIG. 8 illustrates one example of sparse & pseudo-random per-resource CSI-RS RE mapping provided across ports & PRBs 800, various changes may be made to FIG. 8. For example, various changes to pseudo random mask pattern could be made, etc., according to particular needs.

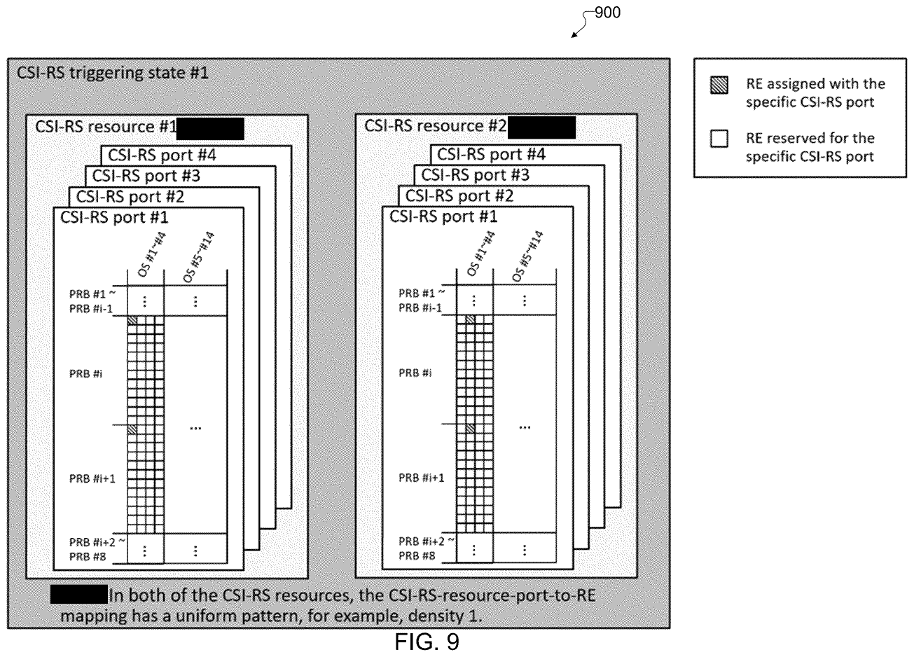

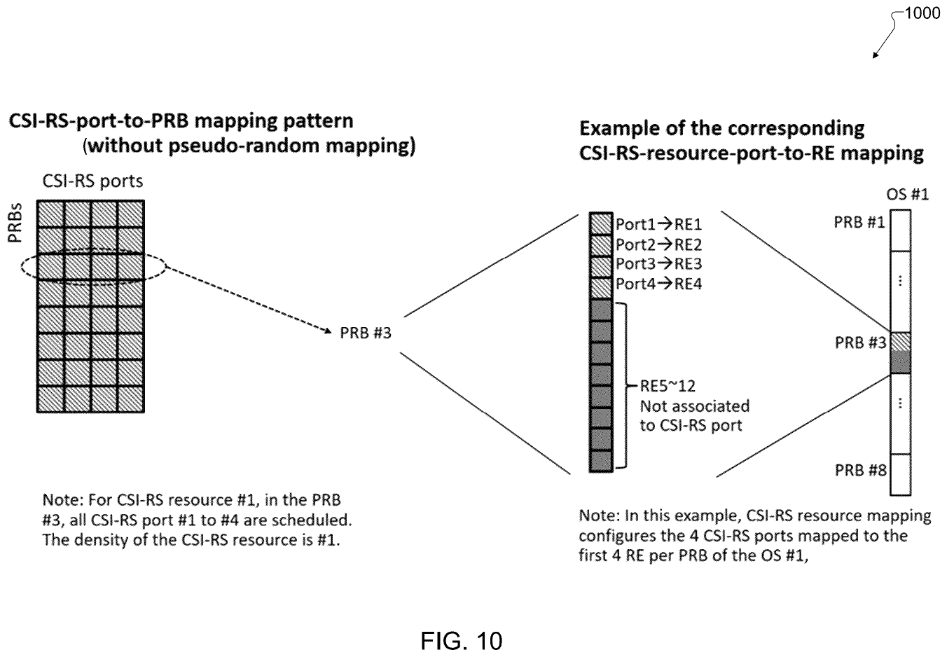

In some wireless networks, a CSI-RS triggering state may be associated to one or multiple CSI-RS resource configurations, and each configuration may contain one or multiple CSI-RS ports, similar as shown in FIG. 9. The RE resource mapping of the CSI-RS ports may have a uniform density across the RE in the frequency domain.

FIG. 9 illustrates an example CSI-RS triggering state 900 according to embodiments of the present disclosure. The embodiment of a CSI-RS triggering state of FIG. 9 is for illustration only. Different embodiments of a CSI-RS triggering state could be used without departing from the scope of this disclosure.

In the example of FIG. 9, A CSI-RS triggering state #1 is associated with 2 CSI-RS resources, each of which has 4 CSI-RS ports with density 1, (i.e., per PRB one RE is scheduled for the CSI-RS port). In order of maintaining the orthogonality of the in total 8 CSI-RS ports in the 2 CSI-RS resources, the RE resource mapping of the CSI-RS port within each of the CSI-RS resource and across the CSI-RS resources ought to be orthogonal. In this example, the CSI-RS ports in CSI-RS resource #1 occupies the first 4 REs of every PRB in the OS #1, while the CSI-RS ports in CSI-RS resource #2 occupies the first 4 REs of every PRB in the OS #2.

Although FIG. 9 illustrates one example CSI-RS triggering state 900, various changes may be made to FIG. 9. For example, various changes to the number of CSI-RS ports could be made, etc., according to particular needs.

FIG. 10 illustrates an example CSI-RS-port-to-PRB mapping 1000 according to embodiments of the present disclosure. The embodiment of CSI-RS-port-to-PRB mapping of FIG. 10 is for illustration only. Different embodiments of a CSI-RS-port-to-PRB mapping could be used without departing from the scope of this disclosure.

In the example of FIG. 10, density 1 is assumed for simplicity and clearness. In FIG. 10, an illustration of CSI-RS-port-to-PRB mapping (without pseudo-random mapping) is shown together with the conversion from CSI-RS-port-to-PRB mapping to CSI-RS-resource-port-to-RE mapping of CSI-RS resource #1 as shown in FIG. 9. In the CSI-RS-port-to-PRB domain, all of the 4 CSI-RS ports are mapped per PRB for both CSI-RS resource #1 and #2. Due to the difference in CSI-RS resource mapping in CSI-RS resource #1 and #2, the CSI-RS ports in CSI-RS resource #2 are mapped to the OS #2.

Although FIG. 10 illustrates one example CSI-RS-port-to-PRB mapping 1000, various changes may be made to FIG. 1000. For example, various changes to the number of CI-RS ports could be made, etc., according to particular needs.

In some embodiments, a mapping of the CSI-RS ports to an RE resource may be pseudo-random. In embodiments such as these, instead of a regular and uniform CSI-RS port to RE resource mapping as shown in FIG. 9, the CSI-RS ports to RE resource mapping is controlled by a pseudo-random process with a configurable deduced density. In some embodiments, a CSI-RS port may not be mapped to every PRB (for example with density 1) but with a pseudo-random interval of REs.

By configuring the pseudo-random generator and seeds for each CSI-RS transmission, the same CSI-RS-resource-port-to-RE mapping patterns are available at both the BS and UE sides.

Various embodiments of the present disclosure enable multiple CSI-RS resources to share a common RE resources through orthogonal pseudo-random low-density CSI-RS-resource-port-to-RE mapping patterns. For clarity of explanation, the CSI-RS-resource-port-to-RE mapping patterns are explained herein in the CSI-RS-port-to-PRB domain. With configured RE mapping for the mapped CSI-RS ports, the CSI-RS-resource-port-to-RE mapping pattern may uniquely identified.

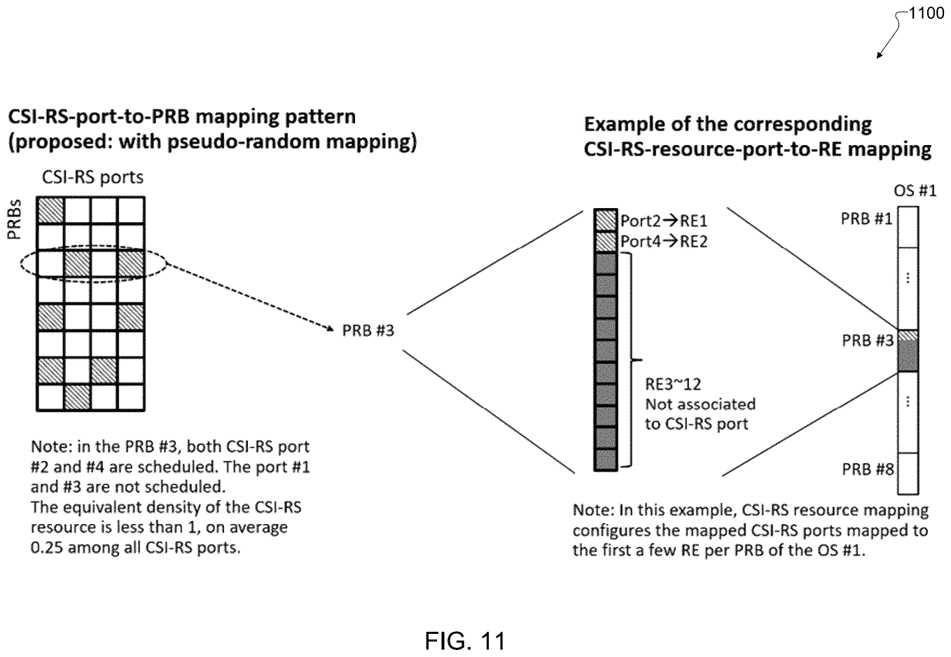

FIG. 11 illustrates an example pseudo-random CSI-RS-port-to-PRB mapping 1100 according to embodiments of the present disclosure. The embodiment of pseudo-random CSI-RS-port-to-PRB mapping of FIG. 11 is for illustration only. Different embodiments of pseudo-random CSI-RS-port-to-PRB mapping could be used without departing from the scope of this disclosure.

In the example of FIG. 11, 25% of the REs are mapped with CSI-RS ports pseudo-randomly, (i.e., density ¼ [0.25 REs per port per PRB for each CSI-RS resource on average, compared to the example in FIG. 10 with a regular and uniform mapping pattern]). The impact of the pseudo-random mapping views clearer in the CSI-RS-port-to-PRB domain. By converting the CSI-RS-resource-port-to-RE domain to the CSI-RS-port-to-PRB domain, the CSI-RS port that mapped to a RE in the CSI-RS-resource-port-to-RE domain is marked as a strip pattern in the left side of the FIG. 11 (i.e., the mapping pattern in CSI-RS-port-to-PRB domain). In total, 25% of the elements in the CSI-RS-port-to-PRB domain are used.

Although FIG. 11 illustrates one example pseudo-random CSI-RS-port-to-PRB mapping 1100, various changes may be made to FIG. 11. For example, various changes to the number of CI-RS ports could be made, etc., according to particular needs.

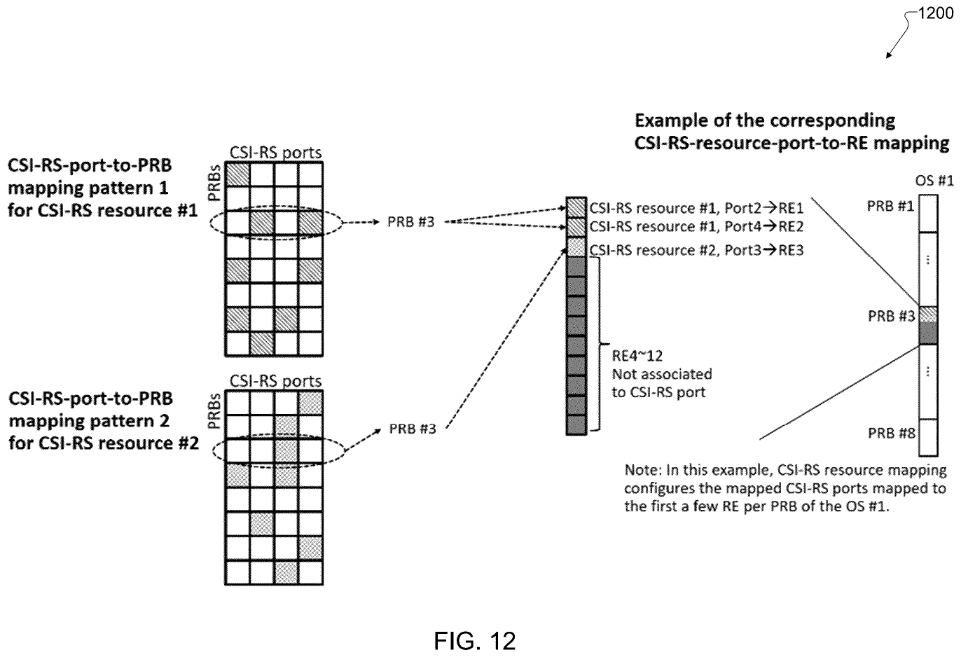

FIG. 12 illustrates another example pseudo-random CSI-RS-port-to-PRB mapping 1200 according to embodiments of the present disclosure. The embodiment of pseudo-random CSI-RS-port-to-PRB mapping of FIG. 12 is for illustration only. Different embodiments of pseudo-random CSI-RS-port-to-PRB mapping could be used without departing from the scope of this disclosure.

In the example of FIG. 12, two orthogonal CSI-RS-port-to-PRB mapping patterns are attached to two CSI-RS resources #1 and #2. Even if the RE mapping of the two CSI-RS resources are exactly overlapped, for example, in the same OS and the on the same REs, with the actually mapped RE will be orthogonal across all CSI-RS ports among all the CSI-RS resources. Compared to regular and uniform mapping, all of the 8 ports of the 2 CSI-RS resources are transmitted but 25% of the physical resource are used.

Although FIG. 12 illustrates one example pseudo-random CSI-RS-port-to-PRB mapping 1200, various changes may be made to FIG. 12. For example, various changes to the number of CI-RS ports could be made, etc., according to particular needs.

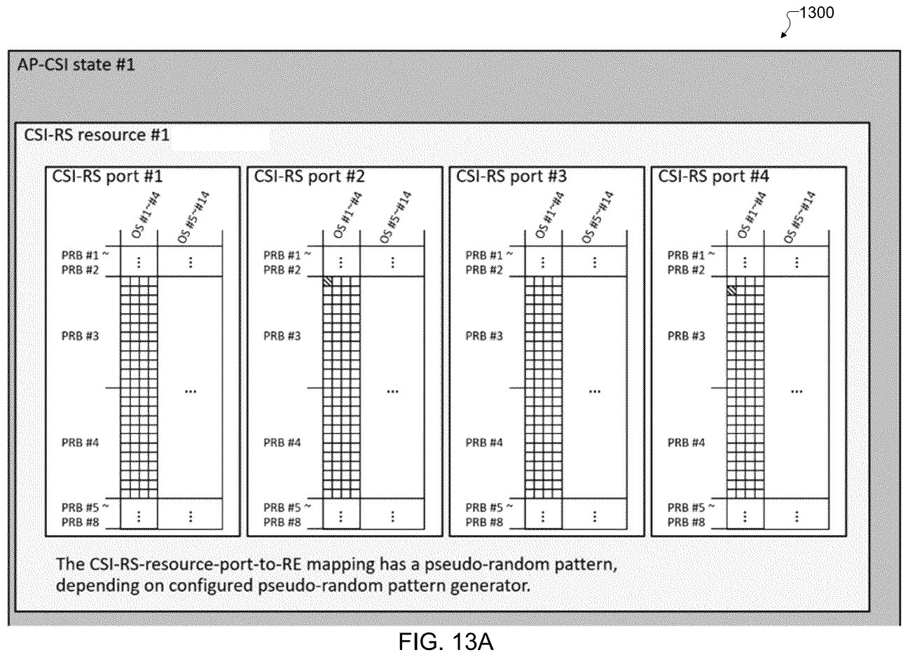

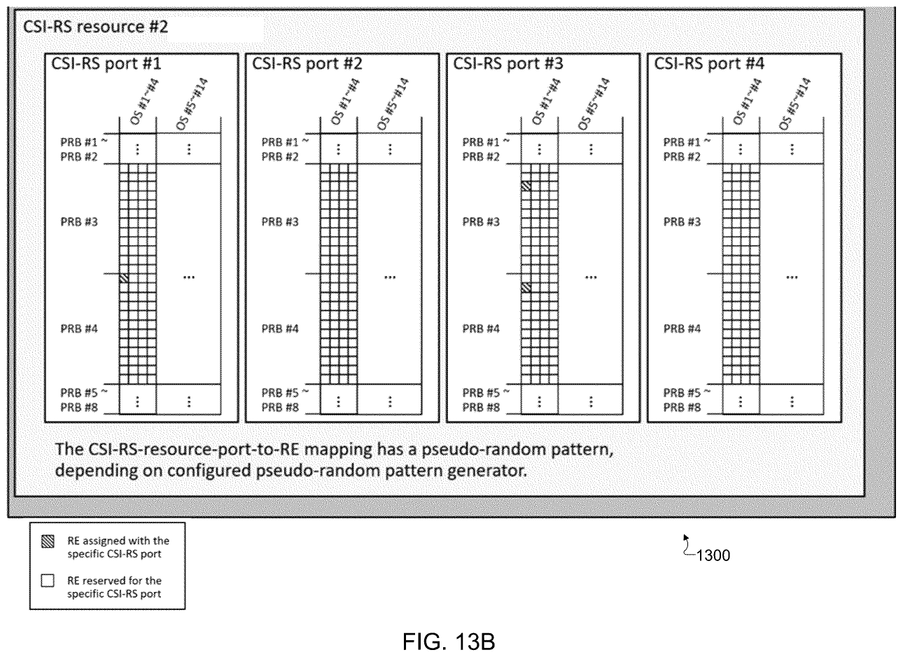

FIGS. 13A and 13B illustrate an example AP-CSI state configuration 1300 according to embodiments of the present disclosure. The embodiment of an AP-CSI state configuration of FIGS. 13A and 13B is for illustration only. Different embodiments of an AP-CSI state configuration could be used without departing from the scope of this disclosure.

In the example of FIGS. 13A and 13B a configuration of an AP-CSI state is shown which is aligned with the CSI-RS-port-to-PRB mapping pattern and CSI-RS-resource-port-to-RE mapping pattern shown in FIG. 12. For the PRB #3, CSI-RS ports #2 and 4 in CSI-RS resource #1 are selected by the pseudo-random mapping pattern, and the two ports are mapped to the RE #1 and #2 of the OS #1 respectively. CSI-RS port #3 in CSI-RS resource #2 is selected by the pseudo-random mapping pattern, the port is mapped to the RE #3 of the OS #1. The RE resources of the selected ports from the CSI-RS resource #1 and #2 are orthogonal.

Although FIGS. 13A and 13B illustrates one example AP-CSI state configuration 1300, various changes may be made to FIGS. 13A and 13B. For example, various changes to the number of PRBs could be made, etc., according to particular needs.

The techniques illustrated in FIGS. 9-13B establish a flexible CSI-RS framework with flexible CSI-RS ports of one or multiple CSI-RS resources to RE resource mapping. The pseudo-random and low-density mapping pattern reduces the CSI-RS transmission overhead for time variant serving cluster configuration and adapts to AI-native and data-driven-based BS and UE side solutions.

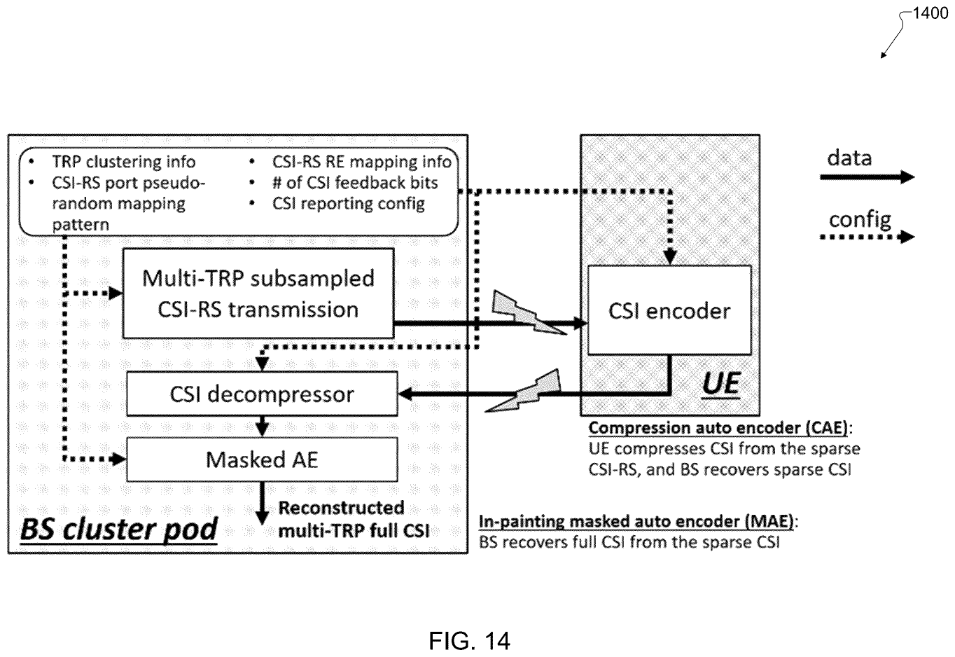

In some embodiments, an extended CSI-RS configuration with pseudo-random and low-density RE resource mapping pattern may be applied to the PRB-to-CSI-RS-port domain for sparse CSI-RS port allocation to physical resources, for example similar as shown in FIG. 14.

FIG. 14 illustrates an example multi-AP based CSI-RS transmission and reconstruction framework for efficient CSI handling 1400 according to embodiments of the present disclosure. The embodiment of a CSI-RS transmission and reconstruction framework of FIG. 14 is for illustration only. Different embodiments of a CSI-RS transmission and reconstruction framework could be used without departing from the scope of this disclosure.

In the example of FIG. 14, multiple APs within a serving cluster collaborate to transmit subsampled CSI-RS. The BS cluster pod schedules AP clustering information and provides RE resource mapping pattern guiding and the transmission strategy. The received CSI at the UE side is encoded through a compression auto encoder (CAE), which compresses the sparse CSI and reduces the CSI feedback overhead. The BS cluster pod then uses a CSI decompressor and a masked auto encoder (MAE) to reconstruct the full multi-AP CSI from the sparse and compressed feedback information. This in-painting mechanism restores full-CSI (for example per PRB per CSI-RS port per AP), optimizing both down-link and up-link physical resource usage and CSI reconstruction accuracy in cell-free MIMO.

Although FIG. 14 illustrates one example multi-AP based CSI-RS transmission and reconstruction framework for efficient CSI handling 1400, various changes may be made to FIG. 14. For example, various changes to the compression scheme could be made, etc., according to particular needs.

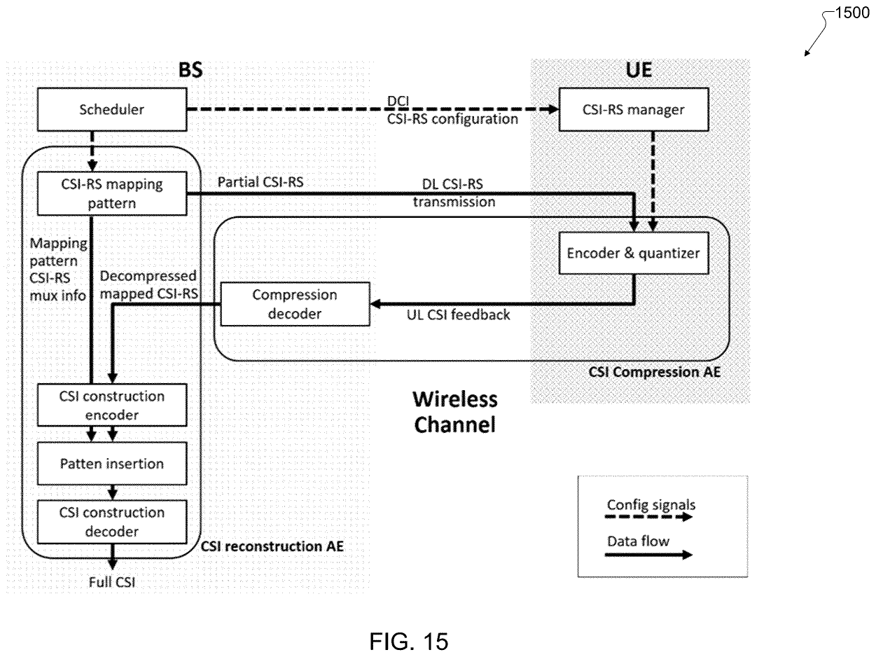

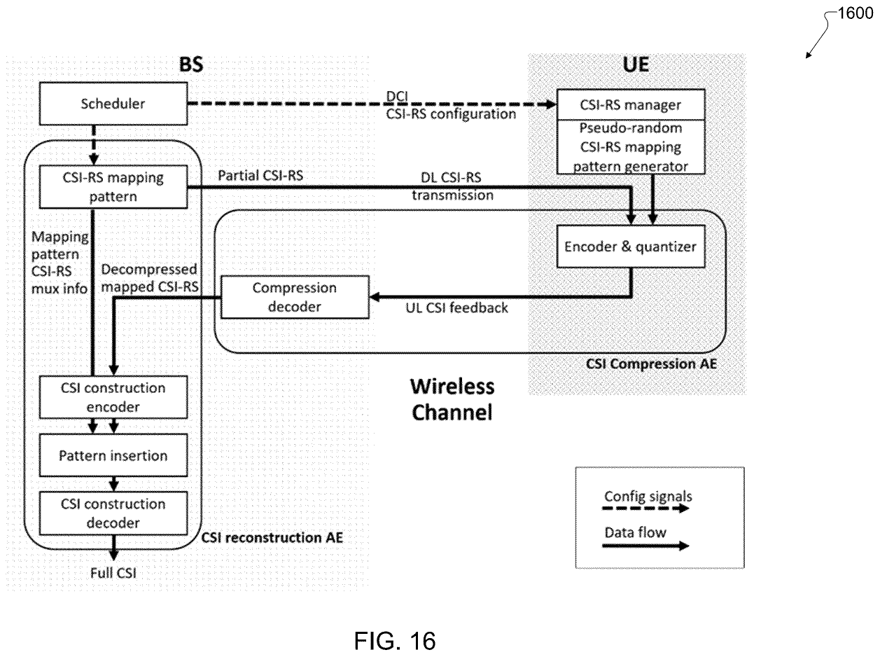

Two alternatives of UE side CSI encoders for use for example, with the framework of FIG. 14, are shown in FIG. 15 and FIG. 16. In each of FIG. 15 and FIG. 16, it is presumed that the UE reports the capability of the CSI encoder, and the BS configures and provides a training data set for the UE side CSI encoder for training purposes.

FIG. 15 illustrates an example UE side CSI encoder 1500 according to embodiments of the present disclosure. The embodiment of a UE side CSI encoder of FIG. 15 is for illustration only. Different embodiments of a UE side CSI encoder could be used without departing from the scope of this disclosure.

In the example of FIG. 15, the CSI-RS RE resource mapping is transparent to the UE's CSI encoder. Therefore, the encoder and quantizer at the UE side does not require CSI-RS RE resource mapping information to perform encoding.

Although FIG. 15 illustrates one example UE side CSI encoder 1500, various changes may be made to FIG. 15. For example, various changes to the CSI-RS configuration could be made, etc., according to particular needs.

FIG. 16 illustrates another example UE side CSI encoder 1600 according to embodiments of the present disclosure. The embodiment of a UE side CSI encoder of FIG. 16 is for illustration only. Different embodiments of a UE side CSI encoder could be used without departing from the scope of this disclosure.

In the example of FIG. 16, the CSI-RS port to RE resource mapping pattern is utilized (non-transparent) to the UE's CSI encoder. The RE resource mapping pattern provides per AP CSI-RS port allocation information, that provides capability to enhance the compression efficiency for the encoder and quantizer at the UE side.

Although FIG. 16 illustrates one example UE side CSI encoder 1600, various changes may be made to FIG. 16. For example, various changes to the CSI-RS configuration could be made, etc., according to particular needs.

Due to the flexibility of the configuration indicated by the BS cluster pod, the input and output size of the UE side CSI encoder varies.

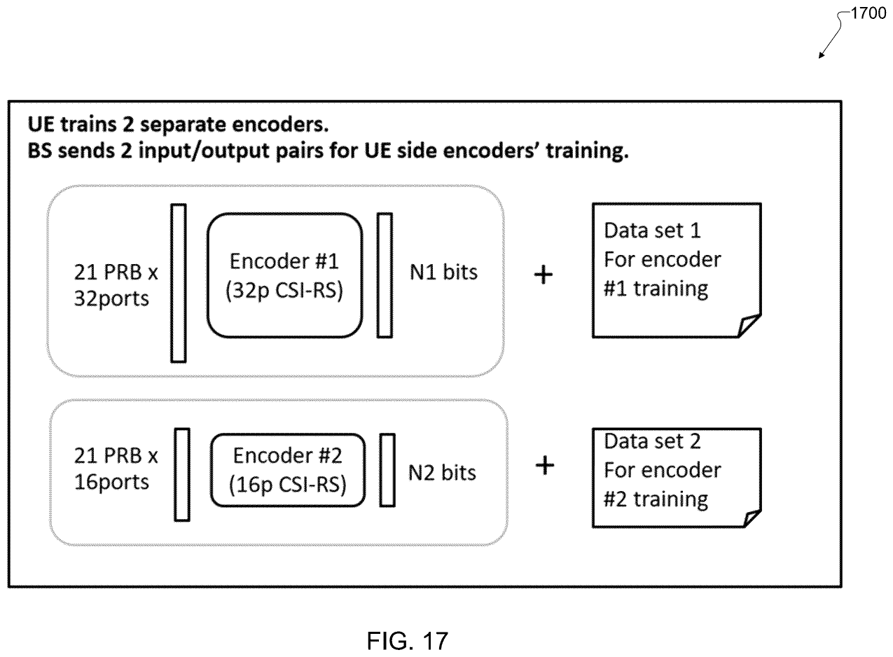

In some embodiments, the BS provides multiple training data sets, and each set has its own input and output size. In embodiments such as these the UE may train one or multiple CSI encoders depending on UE implementation, similar as shown in FIG. 17.

FIG. 17 illustrates an example of multiple training data sets 1700 according to embodiments of the present disclosure. The embodiment of training data sets of FIG. 17 is for illustration only. Different embodiments of multiple training data sets could be used without departing from the scope of this disclosure.

In the example of FIG. 17, a BS sends two data sets with different input/output pairs to a UE for the UE to train its encoders. Each set has its own input and output size. The UE uses first data set to train a first encoder, and the second data set to train a second encoder.

Although FIG. 17 illustrates one example of multiple training data sets 1700, various changes may be made to FIG. 17. For example, various changes to the number of training data sets could be made, etc., according to particular needs.

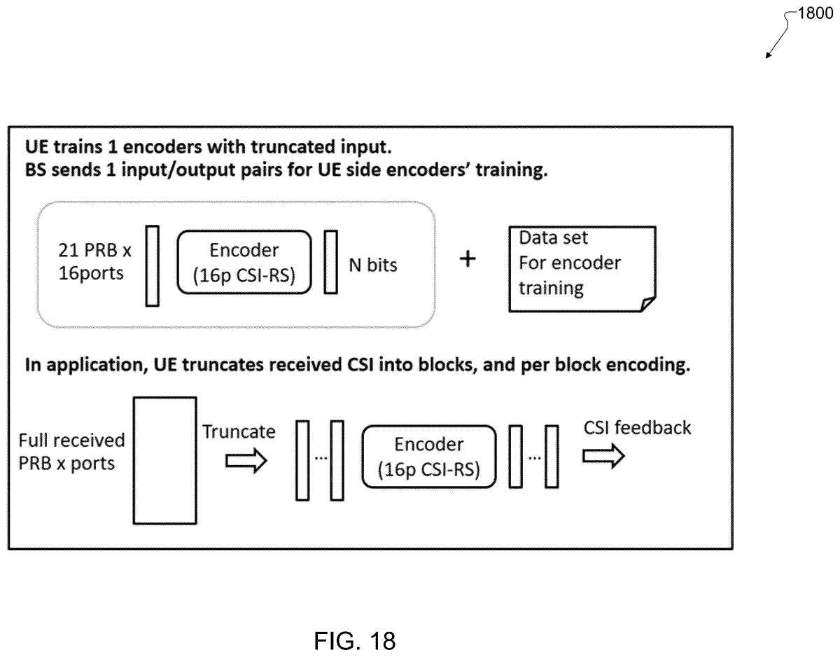

In some embodiments, the BS may indicate for the UE to truncate the input of the CSI encoder to blocks whose size is configured by the BS similar as shown in FIG. 18.

FIG. 18 illustrates an example of truncated input encoder training 1800 according to embodiments of the present disclosure. The embodiment of encoder training of FIG. 18 is for illustration only. Different embodiments of truncated input encoder training could be used without departing from the scope of this disclosure.

In the example of FIG. 18, the BS provides the UE one training data set according to the configured input/output size. After training, in application the UE truncates the received CSI, feeds the truncated CIS into the trained CSI encoder, and cascades the output before providing CSI feedback to the BS.

Although FIG. 18 illustrates one example of truncated input encoder training 1800, various changes may be made to FIG. 18. For example, various changes to the training data set could be made, etc., according to particular needs.

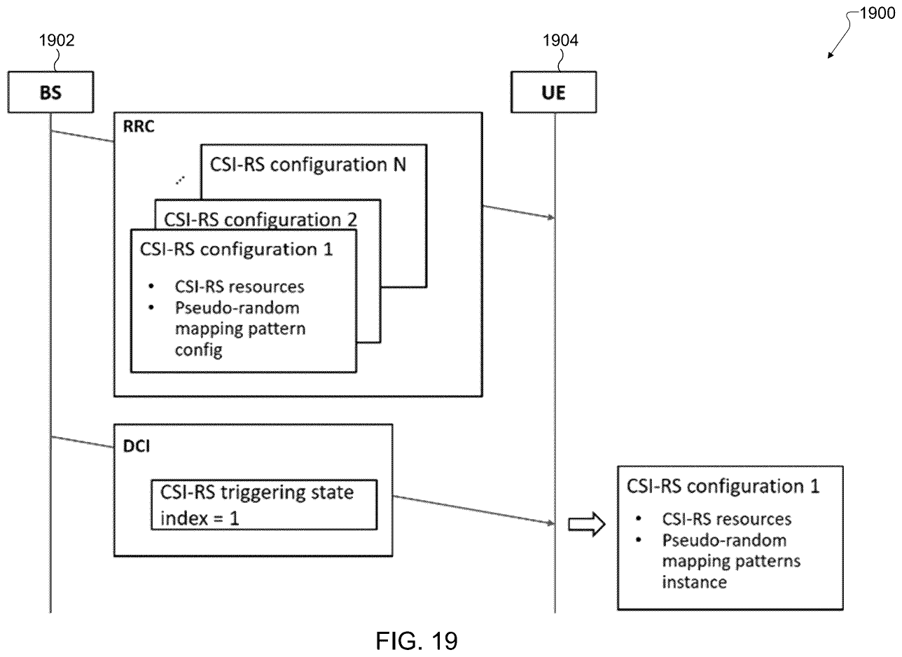

In some embodiments, a BS may configure one RRC for the UE corresponding with a large area, similar as shown in FIG. 19.

FIG. 19 illustrates an example of RRC including extended CSI-RS configurations 1900 according to embodiments of the present disclosure. The embodiment of extended CSI-RS configurations of FIG. 19 is for illustration only. Different embodiments of RRC including extended CSI-RS configurations could be used without departing from the scope of this disclosure.

In the example of FIG. 19, a BS 1902 transmits RRC signaling to a UE 1904. The RRC signaling includes multiple extended CSI-RS configurations that are associated to one or multiple CSI aperiodic trigger states for indication use in DCI, though it should be understood that the RRC signaling may only include a single extended CSI-RS configuration in some circumstances. In addition to configurations included in a regular CSI-RS configuration, an extended CSI-RS configuration may include a configuration of the pseudo-random and low-density mapping pattern of CSI-RS port to RE resources, such as:
An indication of the pseudo-random generator;
An indication of a seed to the pseudo-random generator for any aperiodic CSI-RS transmission;
An indication of CSI-RS port density of each pseudo-random mapping pattern. For example, CSI-RS port density ¼ means 0.25 REs per port per PRB for each CSI-RS resource on average.
An indication of one or multiple indexes of the orthogonal mapping pattern corresponding to the CSI-RS resources in the extended CSI-RS configurations.

In DCI, one or multiple CSI aperiodic trigger states are indicated to the UE 1904 by the BS 1902, each associated to an extended CSI-RS configuration. The exact RE resource mapping pattern is not explicitly included in the extended CSI-RS configuration, however, this will be resolved at both the BS side and the UE side once the seed is known. Unlike a regular CSI-RS configuration, the frequency domain density of each CSI-RS port is not uniform. With time variant RE resource mapping pattern configurations, all the CSI-RS ports are stochastically sounded in multiple CSI-RS transmissions, which adapts to AI-native CSI processing. For instance, in an example where 256 unique extended CSI-RS configurations are configured in the RRC and configured within CSI aperiodic trigger states, at least 8 bits are needed to identify an extended CSI-RS configuration in the DCI.

Although FIG. 19 illustrates one example of RRC including extended CSI-RS configurations 1900 according to embodiments of the present disclosure, various changes may be made to FIG. 19. For example, various changes to number of CSI configurations could be made, etc., according to particular needs.

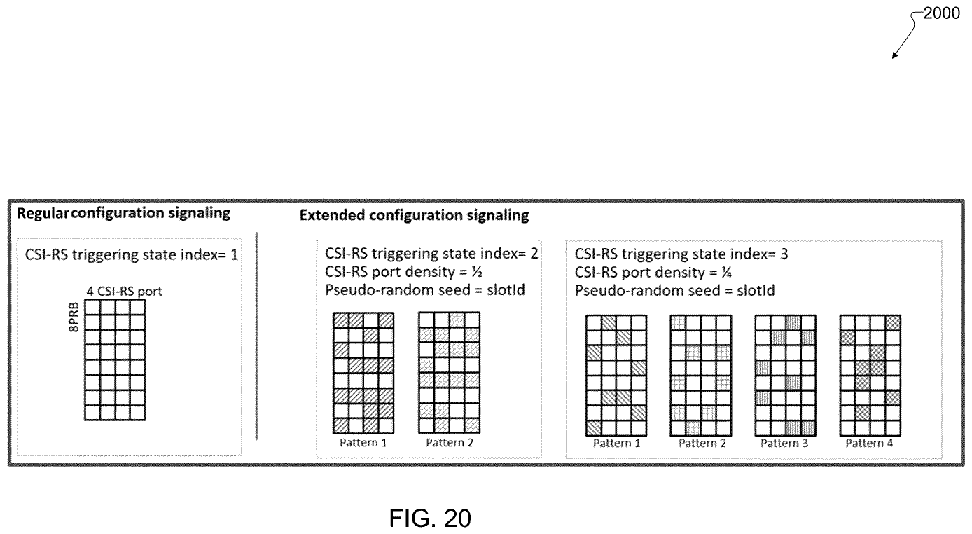

FIG. 20 illustrates an example CSI-RS configuration 2000 according to embodiments of the present disclosure. The embodiment of CSI-RS configuration of FIG. 20 is for illustration only. Different embodiments of a CSI-RS configuration could be used without departing from the scope of this disclosure.

In the example of FIG. 20, 4 CSI-RS ports are included in a CSI-RS configuration for physical resources across 8 PRBs. As shown in the left example in FIG. 20, which shows a regular CSI-RS configuration with density 1, all of the 4 CSI-RS ports are configured in each of the 8 PRBs. In the extended CSI-RS configuration, a field, for example, CSI-RS port density, is included, indicating the density of mapped CSI-RS ports in the PRB-to-CSI-RS-port domain, as shown on the middle and right side of FIG. 20. For example, CSI-RS port density ½ indicates 2 of RE resource mapping pattern exists at each configuration instances. For each RE resource mapping pattern, ½ of the CSI-RS ports in PRB-to-CSI-RS-port domain are mapped (i.e., available for CSI-RS transmission). Each of the 2 RE resource mapping patterns is determined by pseudo-random generator with a RE resource mapping pattern seed configured in the extended CSI-RS configuration. In another example, CSI-RS port density ¼ indicates a maximum 4 RE resource mapping pattern exists at each configuration instances. For each RE resource mapping pattern, ¼ of the CSI-RS ports in PRB-to-CSI-RS-port domain are mapped (i.e., available for CSI-RS transmission). Each of the 4 RE resource mapping patterns is determined by a pseudo-random generator with a RE resource mapping pattern seed configured in the extended CSI-RS configuration.

Although FIG. 20 illustrates one example CSI-RS configuration 2000, various changes may be made to FIG. 20. For example, various changes to the patterns could be made, etc., according to particular needs.

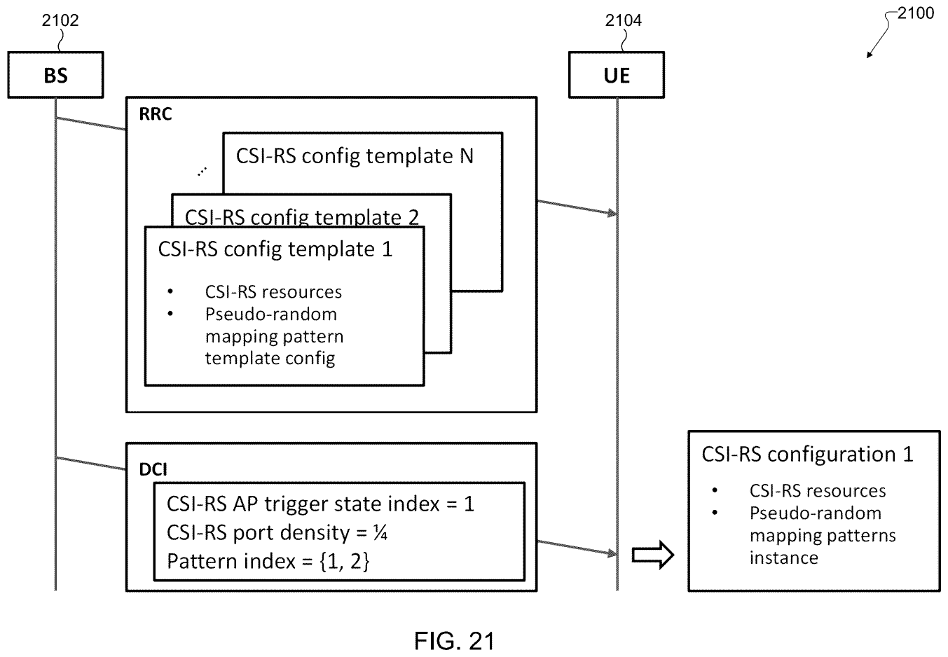

In some embodiments, a dynamic CSI-RS resources allocation mechanism may adjust CSI-RS resources based on real-time UE cluster mobility to provide adaptive resource usage for enhanced CSI measurement and reconstruction precision, similar as shown in FIG. 21.

FIG. 21 illustrates an example of RRC including CSI-RS configuration templates 2100 according to embodiments of the present disclosure. The embodiment of CSI-RS configuration templates of FIG. 21 is for illustration only. Different embodiments of RRC including CSI-RS configuration templates could be used without departing from the scope of this disclosure.

In the example of FIG. 21, a BS 2102 configures a UE 2104 with multiple CSI-RS configuration templates through RRC signaling, though it should be understood that the RRC signaling may only include a single CSI-RS configuration template. In FIG. 21, CSI aperiodic trigger states and two instances of supplemental information are indicated for an aperiodic CSI-RS configuration with pseudo-random and low-density CSI-RS-resource-port-to-RE mapping patterns.

The CSI-RS configuration templates include configuration of a CSI-RS resource or resource set, common configuration of an RE resource mapping pattern which includes a pseudo-random RE resource mapping pattern generator, seed type, and mapped CSI-RS port to RE mapping configuration. The CSI-RS port density and RE resource mapping pattern indexes are indicated through DCI signaling.

One or multiple CSI-RS configuration templates are indicated in DCI for aperiodic CSI-RS triggering. For each CSI-RS configuration template triggered by a DCI, two instances of supplemental information are indicated:
CSI-RS port density: Indicates the density of each pseudo-random CSI-RS-resource-port-to-RE mapping pattern. For example, CSI-RS port density ¼ means 0.25 REs per port per PRB for each CSI-RS resource on average. The maximum number of orthogonal mapping patterns can be inferred.
Pattern index: Indicates one or multiple orthogonal mapping patterns configured with CSI-RS.

With both CSI-RS configuration templates in RRC and supplemental information in DCI, the exact CSI-RS port to RE resource mapping pattern is not explicitly included in the (SI-RS configuration templates in RRC nor supplemental information in DCI, however, it will be resolved at the UE side when the CSI-RS configuration templates, supplemental information, and the seed are resolved. For instance, in an example where 8 CSI-RS configuration templates are configured in the RRC and associated to CSI aperiodic trigger states, 2 bits for CSI-RS port density and 3 bits for pattern index indications in the DCI, at least 8 bits (8=log₂(8)+2+3) are needed to identify the CSI-RS configuration in the DCI, which is equivalent to having 256 CSI-RS configurations in the RRC, but the RRC signaling requires less overhead.

Although FIG. 21 illustrates one example of RRC including CSI-RS configuration templates 2100 according to embodiments of the present disclosure, various changes may be made to FIG. 19. For example, various changes to number of CSI configuration templates could be made, etc., according to particular needs.

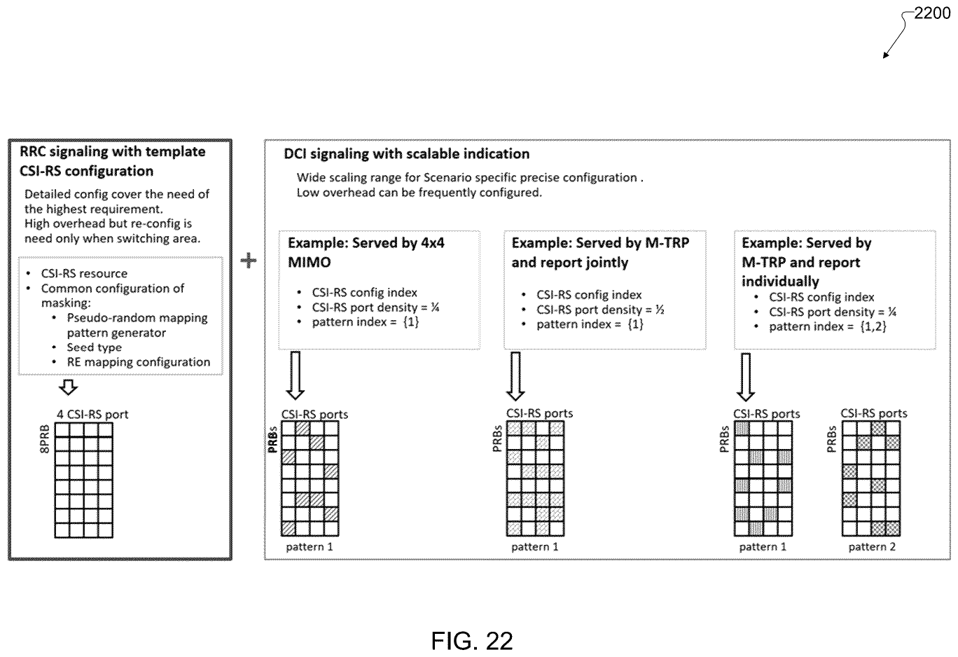

FIG. 22 illustrates an example CSI-RS configuration 2200 according to embodiments of the present disclosure. The embodiment of CSI-RS configuration of FIG. 22 is for illustration only. Different embodiments of a CSI-RS could be used without departing from the scope of this disclosure.

In the example of FIG. 22, a template of the CSI-RS configuration is configured through RRC signaling. The network indicates a CSI-RS template to the UE, including the configuration of CSI-RS resource or resource set, common configuration of RE resource mapping pattern which includes pseudo-random RE resource mapping pattern generator, seed type, mapped CSI-RS port to RE mapping configuration, the CSI-RS port density and RE resource mapping pattern indexes through DCI signaling. The CSI-RS configuration is determined by both the template and indications. If multiple RE resource mapping patterns are configured, the RE resource mapping patterns are orthogonal in PRB-to-CSI-RS-port domain.

When handover and switching is needed, for example if the UE moved to another large area, the RRC signaling overhead is reduced while maintaining the scalability of the extended CSI-RS configurations.

Although FIG. 22 illustrates one example CSI-RS configuration 2200, various changes may be made to FIG. 22. For example, various changes to the patterns could be made, etc., according to particular needs.

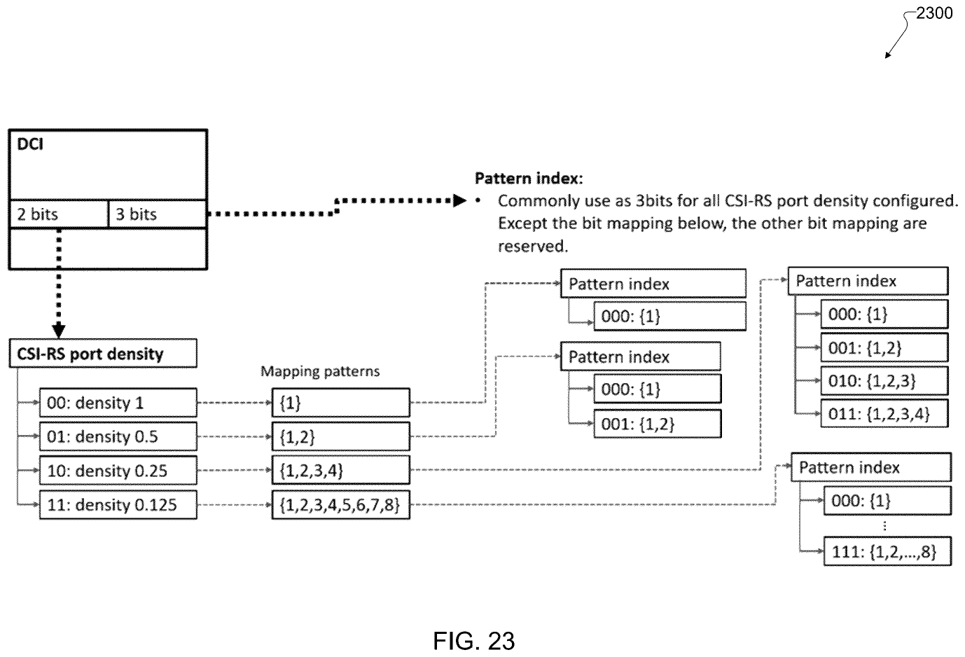

In some embodiments, the CSI-RS port density and pattern index may be indicated in the DCI for an extended CSI-RS configuration on the template of CSI-RS configuration indicated by the triggering index, similar as shown in FIG. 23.

FIG. 23 illustrates an example of CSI-RS port density indications 2300 according to embodiments of the present disclosure. The embodiment of CSI-RS port density indications of FIG. 23 is for illustration only. Different embodiments of CSI-RS port density indications could be used without departing from the scope of this disclosure.

In the example of FIG. 23, 2 bits in a DCI indicate the CSI-RS port density configurations, and four different CSI-RS port densities may be supported (i.e., 1, ½, ¼, ⅛). In some embodiments, a pattern index may commonly use 3 bits for all CSI-RS port density configurations. In the example of FIG. 23, bit mappings other than shown in FIG. 23 are reserved.

Although FIG. 23 illustrates one example of CSI-RS port density indications 2300, various changes may be made to FIG. 23. For example, various changes to pattern indexes could be made, etc., according to particular needs.

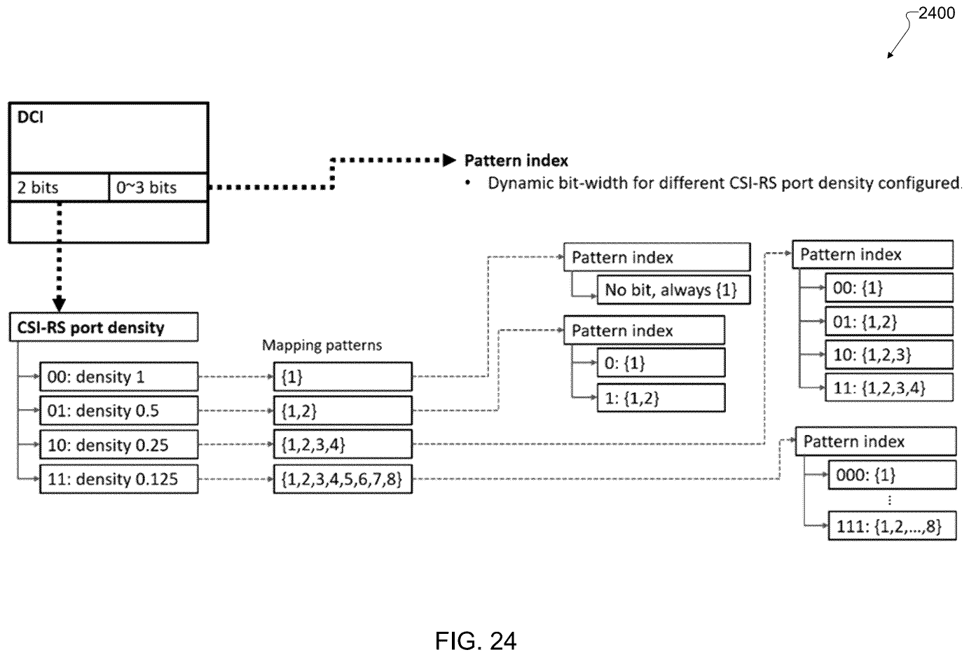

In some embodiments the pattern index may have a dynamic bit-width for different CSI-RS port density configurations, similar as shown in FIG. 24.

FIG. 24 illustrates another example of CSI-RS port density indications 2400 according to embodiments of the present disclosure. The embodiment of CSI-RS port density indications of FIG. 24 is for illustration only. Different embodiments of CSI-RS port density indications could be used without departing from the scope of this disclosure.

In the example of FIG. 24, the pattern index has a dynamic bit-width for different CSI-RS port density configurations. A different number of RE resource mapping patterns configurations are supported. The combinations of the RE resource mapping patterns are indexed by 0 to 3 bits depending on the CSI-RS port density configured. In the example of FIG. 24, bit mappings other than shown in FIG. 24 are reserved.

Although FIG. 24 illustrates one example of CSI-RS port density indications 2400, various changes may be made to FIG. 24. For example, various changes to pattern indexes could be made, etc., according to particular needs.

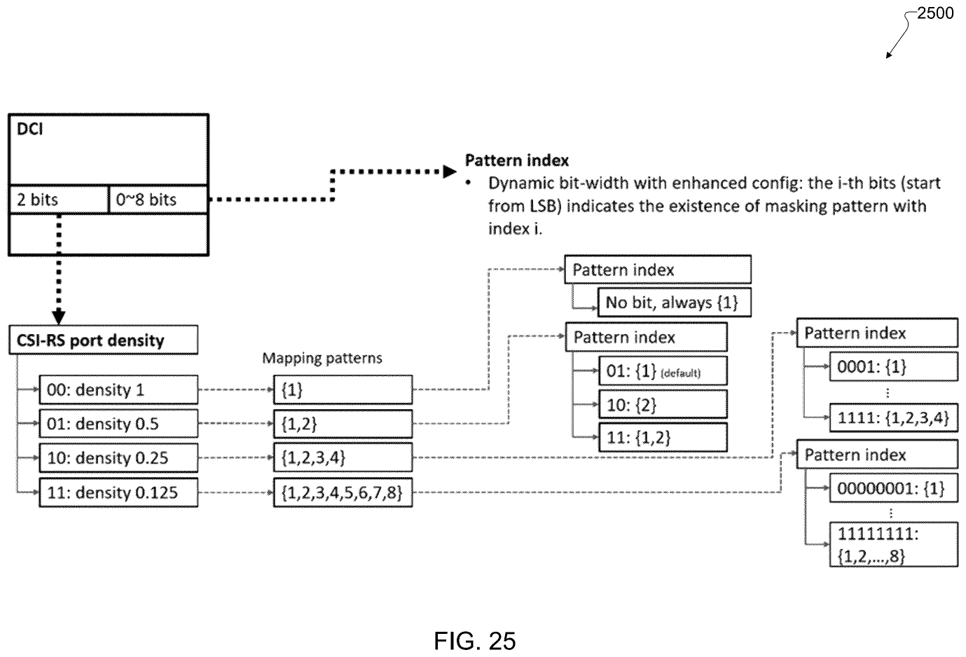

In some embodiments, the pattern index may have a dynamic bit-width for different CSI-RS port density configurations, similar as shown in FIG. 25.

FIG. 25 illustrates another example of CSI-RS port density indications 2500 according to embodiments of the present disclosure. The embodiment of CSI-RS port density indications of FIG. 25 is for illustration only. Different embodiments of CSI-RS port density indications could be used without departing from the scope of this disclosure.

In the example of FIG. 25 the pattern index has a dynamic bit-width for different CSI-RS port density configurations. Arbitrary combinations of RE resource mapping pattern configurations are supported. The combinations of the RE resource mapping patterns are indexed by 0, 2, 4, or 8 bits depending on the CSI-RS port density configured. In the example of FIG. 25, bit mappings other than shown in FIG. 25 are reserved.

Although FIG. 25 illustrates one example of CSI-RS port density indications 2500, various changes may be made to FIG. 25. For example, various changes to pattern indexes could be made, etc., according to particular needs.

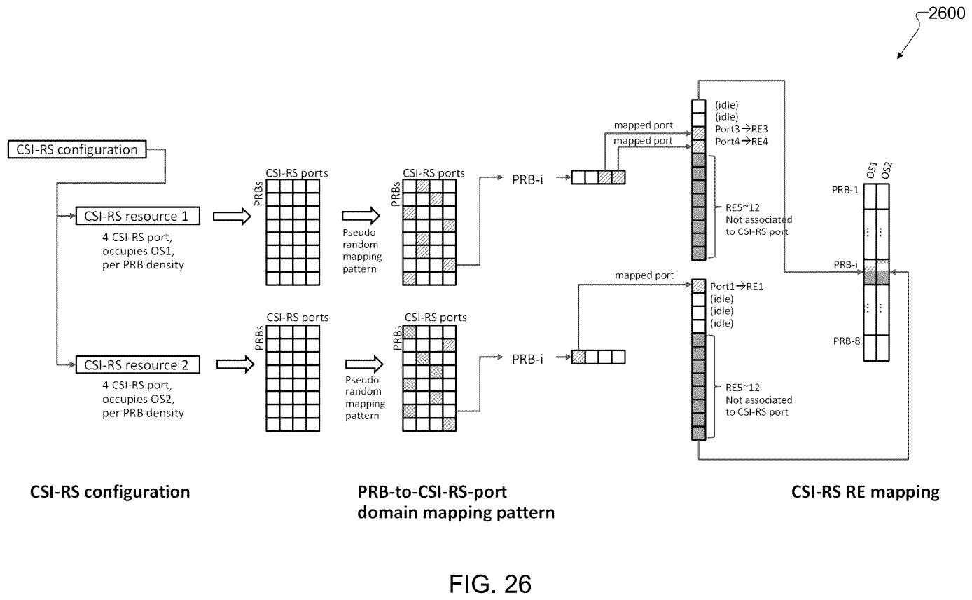

In some embodiments, mapped CSI-RS ports may be transmitted in the physical resource grids configured in an extended CSI-RS configuration. For example, in some embodiments, one extended CSI-RS configuration may have one or multiple CSI-RS resources. If multiple CSI-RS resources are configured, those CSI-RS resources have orthogonal physical resource allocations. Each CSI-RS resource has its own RE resource mapping pattern. Each element marked in the PRB-to-CSI-RS-port domain is associated to one RE. For the CSI-RS port in a PRB that is mapped, the BS will not transmit CSI-RS on the corresponding RE. For the CSI-RS port in a PRB that is unmapped, the BS will transmit CSI-RS on the corresponding RE. An example is shown in FIG. 26, where the CSI-RS ports are reserved with or without a mapping configuration.

FIG. 26 illustrates an example of CSI-RS RE mapping 2600 according to embodiments of the present disclosure. The embodiment of CSI-RS RE mapping of FIG. 26 is for illustration only. Different embodiments of CSI-RS RE mapping could be used without departing from the scope of this disclosure.

Although FIG. 26 illustrates one example of CSI-RS RE mapping 2600, various changes may be made to FIG. 26. For example, various changes to the mapping patterns could be made, etc., according to particular needs.

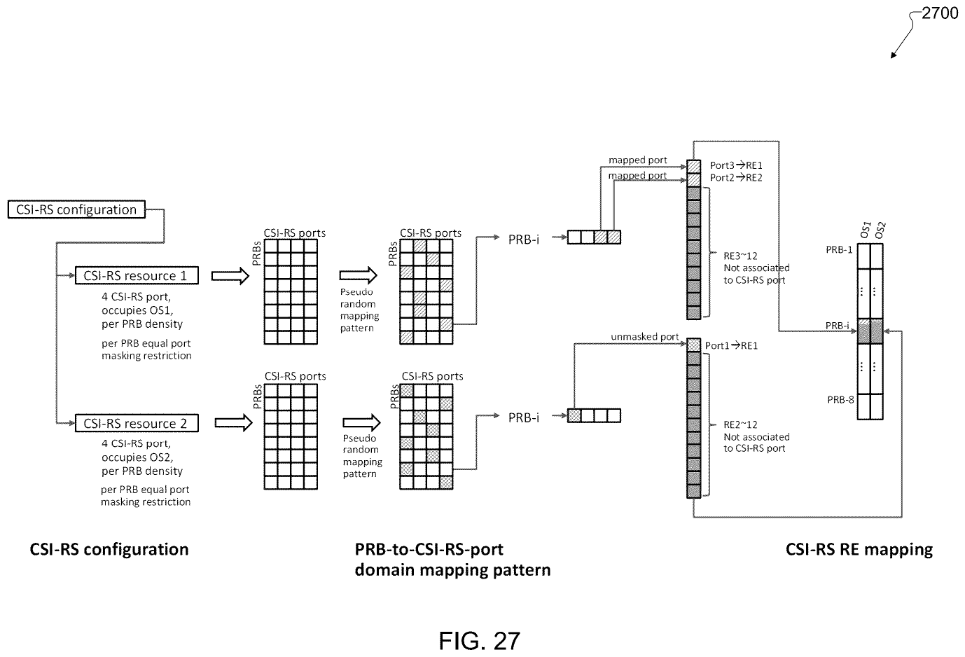

In some embodiments, one extended CSI-RS configuration may have one or multiple CSI-RS resources. If multiple CSI-RS resources are configured, those CSI-RS resources have orthogonal physical resource allocation. Each CSI-RS resource has its own RE resource mapping pattern. Each element marked in the PRB-to-CSI-RS-port domain is associated to one RE. Assume Nₚₒᵣₜ CSI-RS ports are configured. For the CSI-RS port in a PRB that is mapped, the BS will not transmit CSI-RS on any RE. For the N_{mapped} CSI-RS port in a PRB that is unmapped, the BS will transmit CSI-RS on the first N_{mapped} corresponding RE, the rest Nₚₒᵣₜ-N_{mapped} REs can be used for non-CSI-RS transmissions. An example is shown in FIG. 27, where the CSI-RS ports actually used depend on the RE resource mapping pattern.

FIG. 27 illustrates another example of CSI-RS RE mapping 2700 according to embodiments of the present disclosure. The embodiment of CSI-RS RE mapping of FIG. 27 is for illustration only. Different embodiments of CSI-RS RE mapping could be used without departing from the scope of this disclosure.

In some embodiments, a BS may configure pseudo-random RE resource mapping pattern generation that has non-restriction to per PRB mapped or mapped CSI-RS ports. In the example of FIG. 27, the CSI-port density is ¼ which means 25% of the ports are mapped. For each PRB, the number of mapped CSI-RS ports can be any number from 0 to 4, i.e., non-restricted. Thus, the actual CSI-RS ports is dynamic per PRB. The BS and UE know the CSI-RS ahead of the CSI-RS transmission. Thus, the non-CSI-RS REs can be used for other transmissions.

Although FIG. 27 illustrates one example of CSI-RS RE mapping 2700, various changes may be made to FIG. 27. For example, various changes to the mapping patterns could be made, etc., according to particular needs.

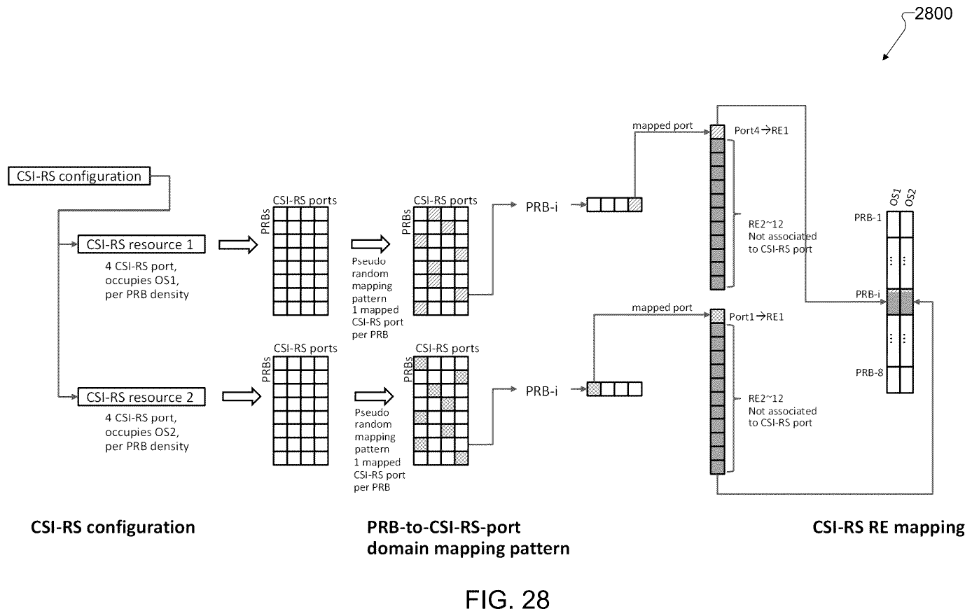

In some embodiments, a BS may configure pseudo-random RE resource mapping pattern generation that has restriction to per PRB unmapped or mapped CSI-RS ports, similar as shown in FIG. 28. The restriction may be inferred by the pseudo-random RE resource mapping pattern generator configured by the BS, or explicitly indicated by the BS.

FIG. 28 illustrates another example of CSI-RS RE mapping 2800 according to embodiments of the present disclosure. The embodiment of CSI-RS RE mapping of FIG. 28 is for illustration only. Different embodiments of CSI-RS RE mapping could be used without departing from the scope of this disclosure.

In the example of FIG. 28, an equal number of mapped CSI-RS port per PRB is configured. The CSI-port density is ¼ which means 25% of the ports are mapped. For each PRB, one and only one of the CSI-RS ports is mapped. Thus, the actual CSI-RS ports is one per PRB, (i.e., a common number). The non-CSI-RS REs can be simply derived from the CSI-port density, before generating the pseudo-random RE resource mapping pattern. The unused RE can be scheduled for other transmissions.

Although FIG. 28 illustrates one example of CSI-RS RE mapping 2800, various changes may be made to FIG. 28. For example, various changes to the mapping patterns could be made, etc., according to particular needs.

In some embodiments, one extended CSI-RS configuration may have one or multiple CSI-RS resources. If only one CSI-RS resource is configured, the multiple CSI-RS RE resource mapping patterns are derived from the CSI-RS resource. If multiple CSI-RS resources are configured, those CSI-RS resources have shared physical resource allocation. In embodiments, such as these, the CSI-RS resources have correlated RE resource mapping patterns such that the RE resource mapping patterns are orthogonal in the PRB-to-CSI-RS-port domain.

Consider an example where four CSI-RS resources are configured. Each has one pseudo-random RE resource mapping pattern. The four pseudo-random RE resource mapping patterns are four orthogonal portions from one pseudo-random permutation sequence of all the CSI-RS ports in all the PRBs. Thus, the four pseudo-random RE resource mapping patterns are orthogonal in PRB-to-CSI-RS-port domain. Each element marked in the PRB-to-CSI-RS-port domain is associated to one RE. The same element in the PRB-to-CSI-RS-port domain of the CSI-RS resources refer to the same RE.

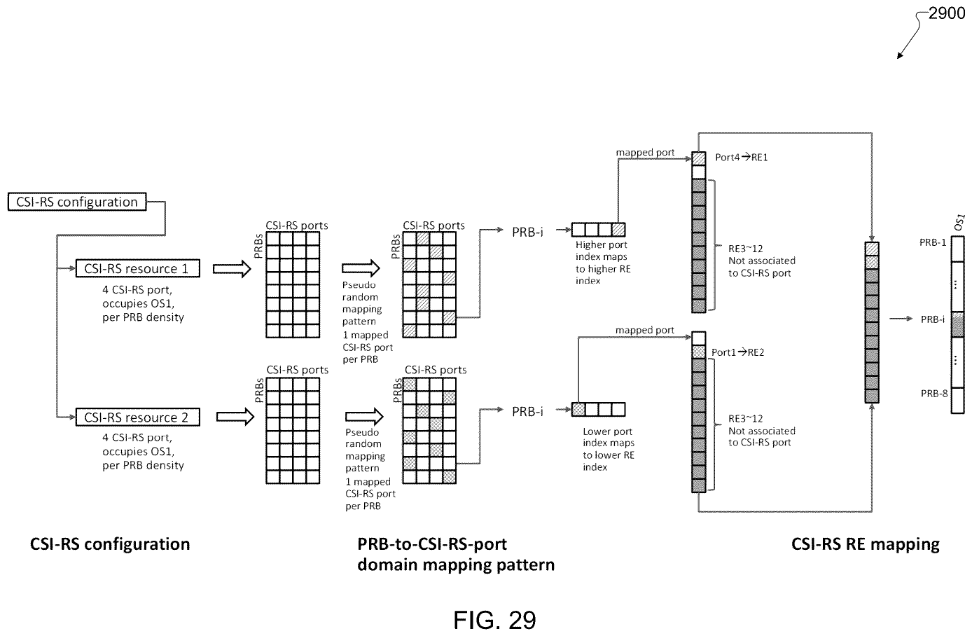

FIG. 29 illustrates another example of CSI-RS RE mapping 2900 according to embodiments of the present disclosure. The embodiment of CSI-RS RE mapping of FIG. 29 is for illustration only. Different embodiments of CSI-RS RE mapping could be used without departing from the scope of this disclosure.

In the example of FIG. 29, two CSI-RS resources are configured on the same physical resources. With the CSI-RS RE resource mapping pattern, the actual CSI-RS RE mapping of the CSI-RS resources are orthogonal. The CSI-port density is ¼ which means 25% of the ports are mapped. For the i-th PRB, the mapped one or multiple CSI-RS ports of the 1^{st} CSI-RS resources are mapped to the first REs of the i-th PRB in the 1^{st} OS. The mapped one or multiple CSI-RS ports of the 2^{nd} CSI-RS resources are mapped to the next one or a few the REs of the i-th PRB in the 1^{st} OS.

Although FIG. 29 illustrates one example of CSI-RS RE mapping 2900, various changes may be made to FIG. 29. For example, various changes to the mapping patterns could be made, etc., according to particular needs.

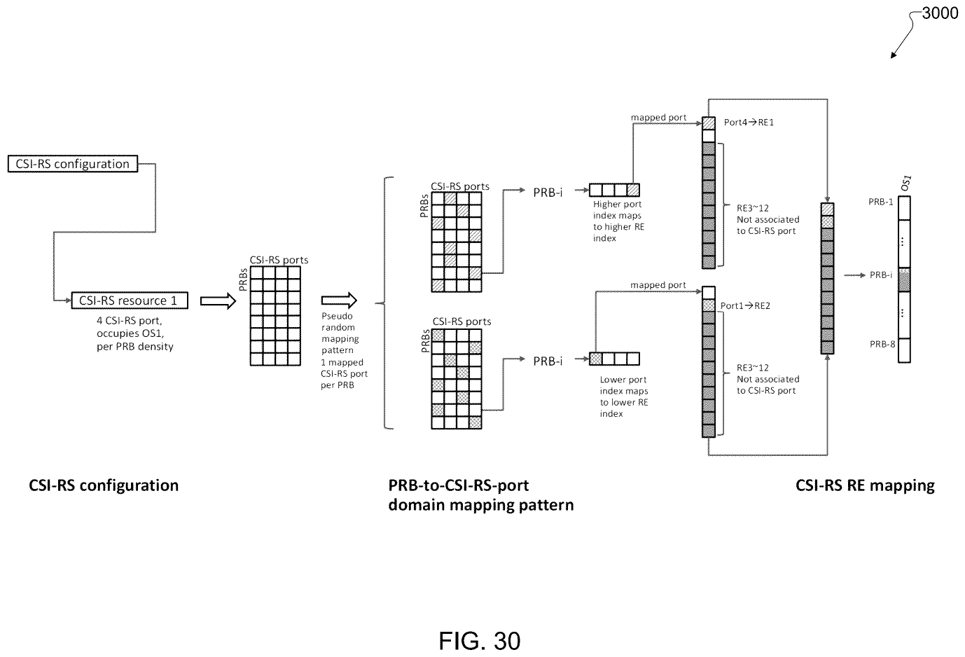

FIG. 30 illustrates another example of CSI-RS RE mapping 3000 according to embodiments of the present disclosure. The embodiment of CSI-RS RE mapping of FIG. 30 is for illustration only. Different embodiments of CSI-RS RE mapping could be used without departing from the scope of this disclosure.

In the example of FIG. 30, only one CSI-RS resource is configured and the multiple CSI-RS RE resource mapping patterns are derived from the CSI-RS resource. With the CSI-RS RE resource mapping pattern, the actual CSI-RS RE mapping of the CSI-RS resources are orthogonal. The CSI-port density is ¼ which means 25% of the ports are mapped. For the i-th PRB, the mapped one or multiple CSI-RS ports of the 1^{st} CSI-RS resources are mapped to the first REs of the i-th PRB in the 1^{st} OS. The mapped one or multiple CSI-RS ports of the 2^{nd} CSI-RS resources are mapped to the next one or a few the REs of the i-th PRB in the 1^{st} OS.

Although FIG. 30 illustrates one example of CSI-RS RE mapping 3000, various changes may be made to FIG. 30. For example, various changes to the mapping patterns could be made, etc., according to particular needs.

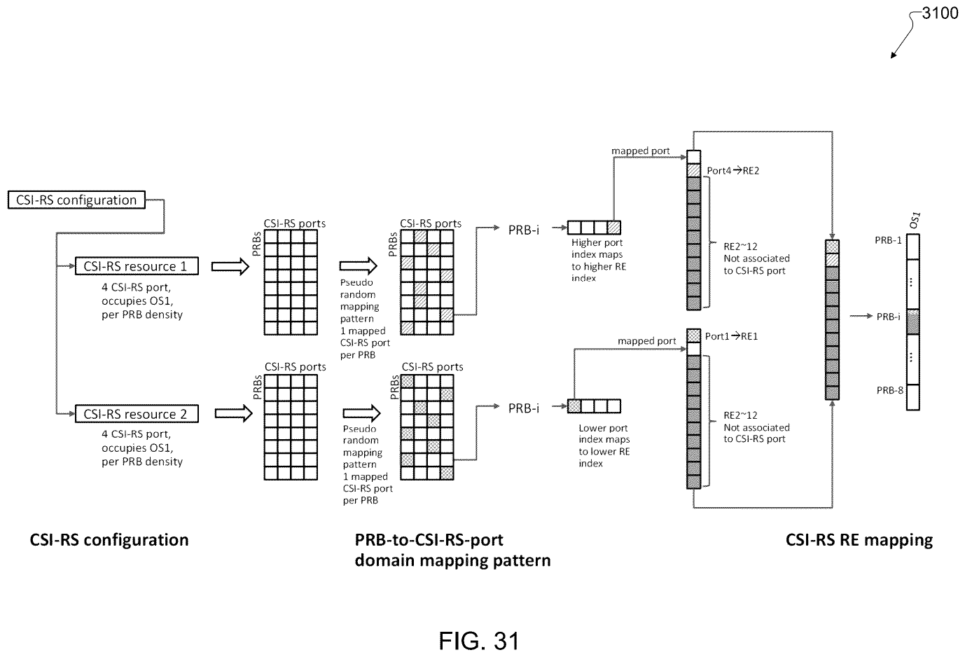

FIG. 31 illustrates another example of CSI-RS RE mapping 3100 according to embodiments of the present disclosure. The embodiment of CSI-RS RE mapping of FIG. 31 is for illustration only. Different embodiments of CSI-RS RE mapping could be used without departing from the scope of this disclosure.

In the example of FIG. 31, two CSI-RS resources are configured on the same physical resources. With the CSI-RS RE resource mapping pattern, the actual CSI-RS RE mapping of the CSI-RS resources are orthogonal. The CSI-port density is ¼ which means 25% of the ports are mapped. For the i-th PRB, the mapped one or multiple CSI-RS ports of the two CSI-RS resources are mapped to the REs of the i-th PRB in the 1^{st} OS, the CSI-RS ports with lower index are mapped to the RE with lower index in the PRB.

Although FIG. 31 illustrates one example of CSI-RS RE mapping 3100, various changes may be made to FIG. 31. For example, various changes to the mapping patterns could be made, etc., according to particular needs.

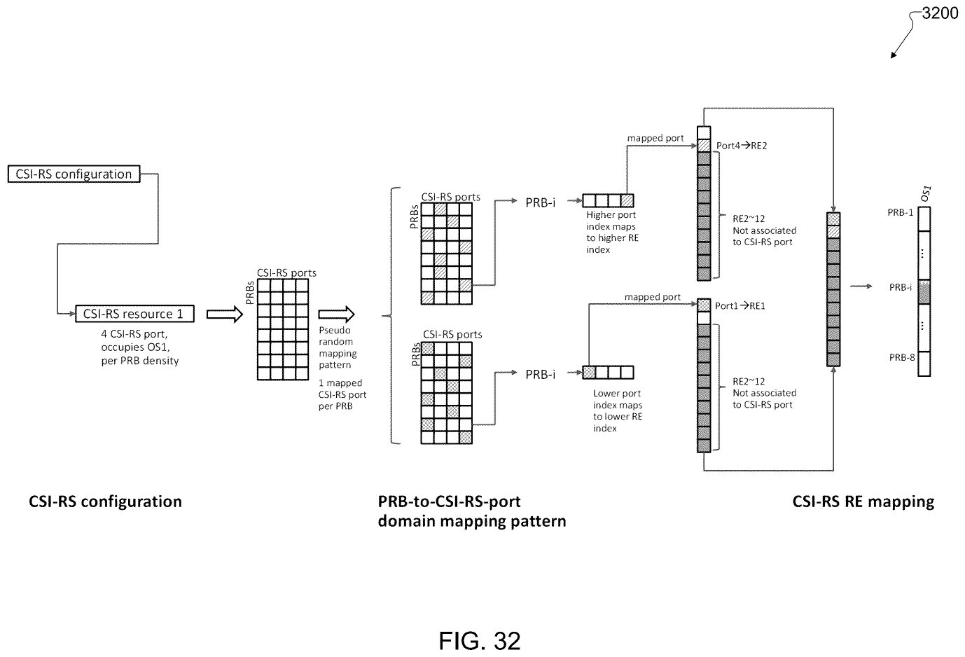

FIG. 32 illustrates another example of CSI-RS RE mapping 3200 according to embodiments of the present disclosure. The embodiment of CSI-RS RE mapping of FIG. 32 is for illustration only. Different embodiments of CSI-RS RE mapping could be used without departing from the scope of this disclosure.

In the example of FIG. 32, only one CSI-RS resource is configured and the multiple CSI-RS RE resource mapping patterns are derived from the CSI-RS resource. With the CSI-RS RE resource mapping pattern, the actual CSI-RS RE mapping of the CSI-RS resources are orthogonal. The CSI-port density is ¼ which means 25% of the ports are mapped. For the i-th PRB, the mapped one or multiple CSI-RS ports of the two CSI-RS resources are mapped to the REs of the i-th PRB in the 1^{st} OS, the CSI-RS ports with lower index are mapped to the RE with lower index in the PRB.

Although FIG. 32 illustrates one example of CSI-RS RE mapping 3200, various changes may be made to FIG. 32. For example, various changes to the mapping patterns could be made, etc., according to particular needs.

In some embodiments, for the RE resource mapping pattern restrictions, the BS configures a pseudo-random RE resource mapping pattern generation that has non-restriction to per PRB unmapped or mapped CSI-RS ports for each of the CSI-RS resources. Consider, for example, that 2 CSI-RS resources and 4 CSI-RS port per CSI-RS resources is configured. The CSI-RS port density is ¼. The number of the mapped CSI-RS port of each CSI-RS resource can be 0,1,2,3,4, while the RE resource mapping patterns are reminded to be orthogonal.

In some embodiments, for the RE resource mapping pattern restrictions, the BS configures a pseudo-random RE resource mapping pattern generation that has restriction to per PRB unmapped or mapped CSI-RS ports for each of the CSI-RS resources. The restriction may be inferred by the pseudo-random RE resource mapping pattern generator configured by the BS, or explicitly indicated by the BS. Consider, for example, 2 CSI-RS resources and 4 CSI-RS port per CSI-RS resources is configured. The CSI-RS port density is ¼. The number of the mapped CSI-RS port of each CSI-RS resource is 1.

In some embodiments, for the RE resource mapping pattern restrictions, the BS configures a pseudo-random RE resource mapping pattern generation that has restriction to per PRB unmapped or mapped CSI-RS ports jointly of the all the CSI-RS resources. The restriction may be inferred by the pseudo-random RE resource mapping pattern generator configured by the BS, or explicitly indicated by the BS. Consider, for example, 2 CSI-RS resources and 4 CSI-RS port per CSI-RS resources is configured. The CSI-RS port density is ¼. The number of the mapped CSI-RS port of each CSI-RS resource can use more than be more than 1. However, the summation of the mapped CSI-RS ports is 2 for each PRB.

In some embodiments, a sparse, pseudo-random mapping strategy may be applied across REs and CSI-RS ports. In embodiments such as these, the CSI-RS density may be dynamically adapted per CSI-RS resource to maintain CSI-RS overhead. The pseudo-random RE mapping increases UE CSI compression efficiency and BS CSI in-painting reconstruction accuracy.

In some embodiments, the pseudo-random RE resource mapping pattern configuration may include two fields in the extended CSI-RS configuration. The first field is a pseudo-random RE resource mapping pattern generator index, configured from one of the standardized pseudo-random RE resource mapping pattern generators that are known by both the BS and the UE. The other field is the seed type for pseudo-random RE resource mapping pattern generation.

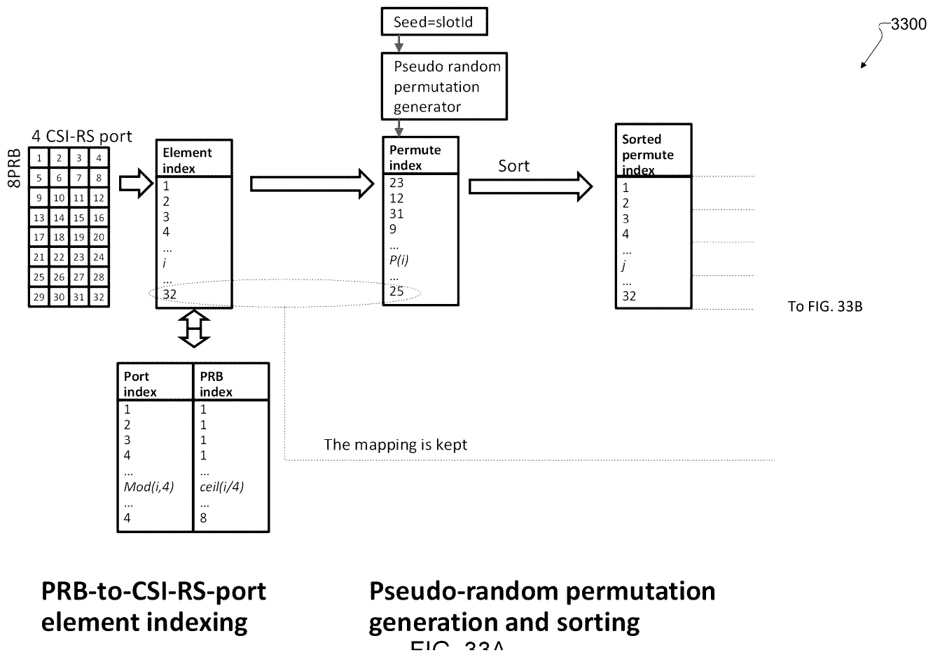

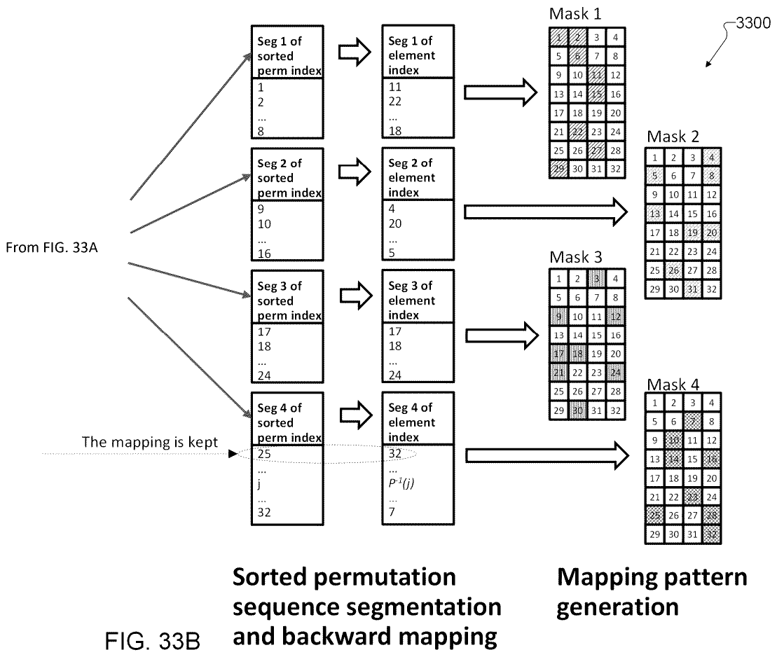

In some embodiments, the orthogonal RE resource mapping patterns may be generated through a pseudo-random permutation sequence generator, similar as shown in FIGS. 33A and 33B. In embodiments such as these, no restriction of the number of CSI-RS ports per PRB that are mapped is applied.

FIGS. 33A and 33B illustrate an example mapping pattern generation 3300 according to embodiments of the present disclosure. The embodiment of mapping pattern generation of FIGS. 33A and 33B is for illustration only. Different embodiments of mapping pattern generation could be used without departing from the scope of this disclosure.

In the example of FIGS. 33A and 33B, orthogonal RE resource mapping patterns are generated with 8 PRBs and 4 CSI-RS ports. The PRB-to-CSI-RS-port domain elements inside the CSI-RS resource template are indexed by an integer sequence, named as element index sequence. The pseudo-random permutation sequence generator generates a permutation sequence based on the configured seed, for example using the slot ID. The permutation sequence has a one-to-one mapping with the element index sequence. The permutation sequence is sorted and partitioned into several segments. The number of the segments depends on the CSI-RS port density. For example, if the CSI-RS port density is ¼, there are 4 segments. The segments of the element index sequence can be backwardly obtained from the segments of permutation sequence. The RE resource mapping pattern is thus obtained per segment of element index sequence from the element index sequence port index and PRB index mapping. Only the configured index of the RE resource mapping patterns need to be generated (for example, if only RE resource mapping pattern with index {1,3} are required, the RE resource mapping pattern with index {2,4} does not need to be generated).

Although FIGS. 33A and 33B illustrate one example mapping pattern generation 3300, various changes may be made to FIGS. 33A and 33B. For example, various changes to mappings could be made, etc., according to particular needs.

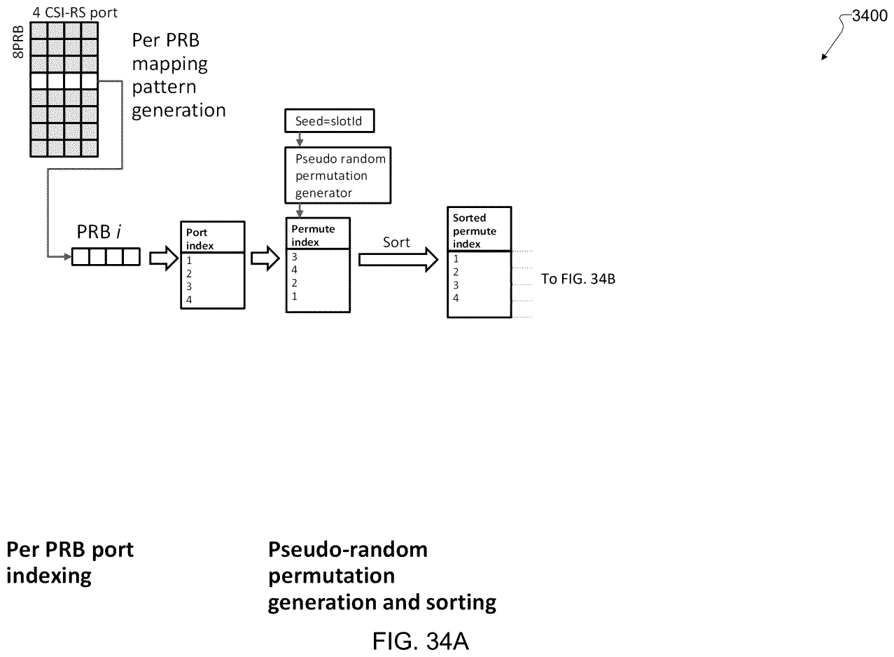

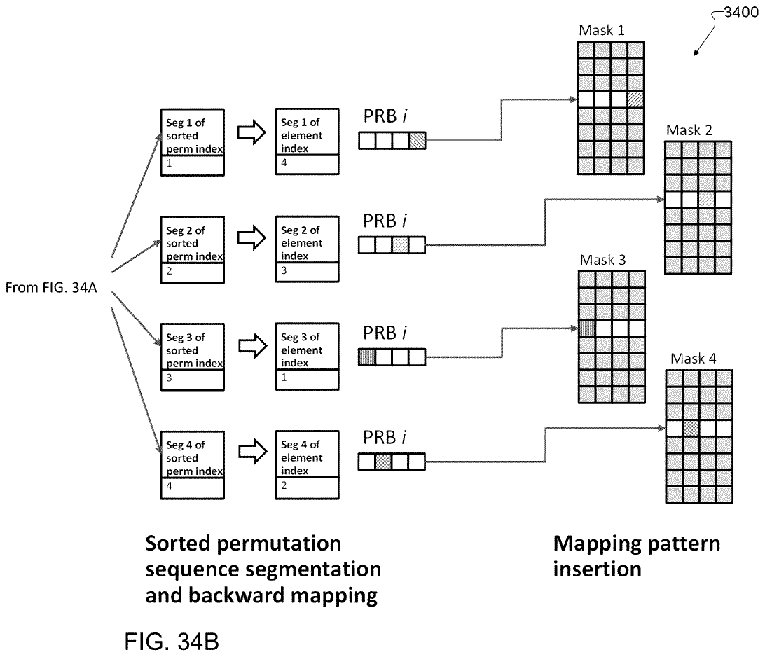

In some embodiments, the orthogonal RE resource mapping patterns may be generated through a pseudo-random permutation sequence generator, similar as shown in FIGS. 34A and 34B. In embodiments such as these, per PRB per RE resource mapping pattern an equal number of mapped CSI-RS port restriction is applied.

FIGS. 34A and 34B illustrate an example mapping pattern insertion 3400 according to embodiments of the present disclosure. The embodiment of mapping pattern insertion of FIGS. 34A and 34B is for illustration only. Different embodiments of mapping pattern insertion could be used without departing from the scope of this disclosure.

In the example of FIGS. 34A and 34B, the RE resource mapping pattern is generated per PRB with 8 PRBs and 4 CSI-RS. In each PRB, the CSI-RS ports are indexed by an integer sequence, named as port index sequence. In terms of pseudo-random permutation sequence generation, in some embodiments, the pseudo-random permutation sequence generator may generate a per PRB permutation sequence in a queue, where the initial seed follows a BS configuration, for example using the slot ID. The permutated sequence per PRB is deterministic. The permutation sequence has a one-to-one mapping with the port index sequence. The permutation sequence is sorted and partitioned into several segments. The number of the segments depends on the CSI-RS port density. For example, if the CSI-RS port density is ¼, there are 4 segments. The segments of the element index sequence can be backwardly obtained from the segments of the permutation sequence. The RE resource mapping pattern is thus obtained per segment of the element index sequence from the element index sequence port index and PRB index mapping. After the RE resource mapping pattern generation of all the PRBs, the whole of the RE resource mapping patterns are obtained. Only the configured indexes of the RE resource mapping patterns need to be generated (for example, if only RE resource mapping pattern with index {1,3} are required, the RE resource mapping pattern with index {2,4} does not need to be generated).

Although FIGS. 34A and 34B illustrates one example mapping pattern insertion 3400, various changes may be made to FIGS. 34A and 34B. For example, various changes to mappings could be made, etc., according to particular needs.

In some embodiments, the orthogonal RE resource mapping patterns are generated through a pseudo-random permutation sequence generator, where per PRB an equal number of total mapped CSI-RS ports from all configured RE resource mapping patterns is applied as a restriction. Consider an example where a two-step RE resource mapping pattern generation skim is configured. In the first step, the procedure of FIGS. 34A and 34B is used to select a configured number of CSI-RS ports per PRB. In the next step, the procedure of FIGS. 33A and 33B is used on top of the mapped CSI-RS port from the first step, to generate the number of RE resource mapping pattern as configured. For each PRB, the number of mapped CSI-RS port per RE resource mapping pattern is not a fixed number (due to the procedure of FIGS. 33A and 33B), however, the total number of mapped CSI-RS port among all generated RE resource mapping pattern is the same (due to the procedure of FIGS. 34A and 34B).

In some embodiments, the BS may configure the seed to the UE through a CSI-RS configuration in RRC signaling or DCI. For example, the CSI-RS configuration may include a parameter ‘seed type’=‘configured’.

In some embodiments, the BS may configure the acquisition of the seed for the pseudo-random RE resource mapping pattern generation. For example, in some embodiments, the BS may configure the UE to use the slot ID as the seed or compute the seed for the pseudo-random RE resource mapping pattern generation, i.e., ‘seed type’=‘slot ID’. In other embodiments, the BS may configure the UE to use the carrier ID or bandwidth part (BWP) as the seed or compute the seed for the pseudo-random RE resource mapping pattern generation, i.e., ‘seed type’=‘carrier ID’ or ‘BWP ID’.

As noted above, various embodiments of the present disclosure provide a patch-pattern based sparse CSI-RS resource configuration and CSI feedback configuration framework. In these embodiments:
A CSI-RS resource patch (also referred to herein as a patch) defined in the CSI-RS-port-to-frequency domain may be configured, indicating one or a group of CSI-RS ports or their certain frequency locations, for example PRBs.
   The (SI-RS-port-to-PRB domain represents the configurable CSI-RS ports in a configured range of PRBs.
   The patch is defined in CSI-RS-port-to-PRB domain, which represents the configurable PRBs for CSI-RS ports. A patch contains a group of elements in the CSI-RS-port-to-PRB domain, in a certain shape and size. For example, a rectangular patch with size (1, 4) means each patch refers to a 1×4 (1 PRB by4 CSI-RS port) element in the CSI-RS-port-to-PRB domain.
A CSI-RS resource port mapping pattern of the patch (also referred to herein as a mapping pattern) is configured, which represents a configuration of sparse CSI-RS port down-selection across frequency locations.
   The mapping pattern refers to a certain configuration that some patches are selected from the CSI-RS-port-to-PRB domain, and the others are not. The BS configures the mapping pattern of patches rather than configure each individual patch. The sparse selection of patches is controlled by the mapping pattern of patches.
The BS configures the patch and mapping pattern and their resource mapping in the configuration signaling, rather than configuring each of the patch, port, or group of ports and the related resource mapping.
The patch and mapping pattern can be utilized at the UE side for CSI in-paining and compression applications with the AI-based functions.

Embodiments such as these reduce overhead of CSI-RS resource transmission and associated signaling. With a patch-pattern signaled, embodiments such as these enable AI-native UE side CSI inpainting and compression methods.

In some embodiments, a patch-pattern based sparse CSI-RS resource configuration and CSI feedback configuration framework may be supported by signaling. For example, in some embodiments, the signaling may include:
Patch configuration: An abstract configuration of a patch, indicating the shape and size of the patch. The UE derives the PRB index of each CSI-RS port referred in the patch. The exact CSI-RS port index will be determined with the mapping pattern instance configuration and controlled UE realization.
Mapping pattern configuration: An abstract configuration of a mapping pattern, indicating the way the patches are down selected. The UE derives one or multiple possibilities of the relative location of the patches in the CSI-RS-port-to-PRB domain. The exact patch location will be determined with the mapping pattern instance configuration and controlled UE realization.
CSI-RS resource to RE mapping configuration: An abstract configuration of mapping selected CSI-RS ports in CSI-RS-port-to-PRB domain to the time-frequency domain resource grid.
Mapping pattern instance configuration: A deterministic configuration of the mapping pattern instance for the UE to apply. The mapping pattern will be determined with the patch, mapping pattern, and other higher-level configurations. The UE derives the location of each patch and CSI-RS port in the CSI-RS-port-to-PRB domain, and the location of CSI-RS port in the time-frequency domain resource grid.

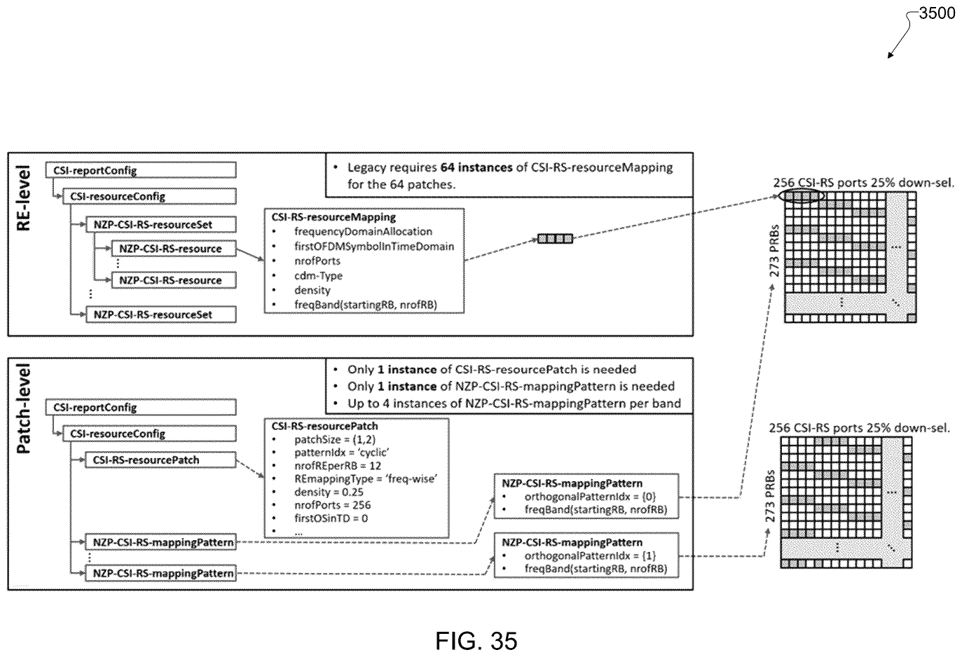

An example of a CSI-RS resource configuration framework is shown in FIG. 35.

FIG. 35 illustrates an example CSI-RS resource configuration framework 3500 according to embodiments of the present disclosure. The embodiment of a CSI-RS resource configuration framework of FIG. 35 is for illustration only. Different embodiments of a CSI-RS resource configuration framework could be used without departing from the scope of this disclosure.

In the example of FIG. 35, The BS has a X-MIMO array with 256 TRx and configures 256 CSI-RS port in a non-precoded or fully-precoded manner.
In some embodiments, the CSI-RS ports may be grouped (CDM-group), for example, with 4 CSI-RS ports in each group. For each group, an instance of CSI-RS-resourceMapping is required to indicate the physical resource of the corresponding CSI-RS ports in the group.
   In total, 64 instances of CSI-RS-resourceMapping are used to configure the pattern shown on the top-right of FIG. 35.
In some embodiments, the CSI-RS port patch and pattern configurations are configured once, for example, in one instance of (SI-RS-resourcePatch. Such CSI-RS-resourcePatch configuration indicates to the UE the shape, size, etc., of the patch and the mapping pattern of the patches. Due to the mapping pattern being sparse, multiple orthogonal mapping patterns exist in the (SI-RS-port-to-PRB domain. For example, the sparse ratio is controlled by a density field in the CSI-RS-resourcePatch configuration, up to 1/density mapping patterns exists. The BS can indicate which one or multiple of the mapping patterns are to be configured, for example, through NZP-CSI-RS-mappingPattern.
In total, 1 instance of CSI-RS-resourcePatch and 1 instance of NZP-CSI-RS-mappingPattern are used to configure the pattern shown on the top-right of FIG. 35.

Although FIG. 35 illustrates one example CSI-RS resource configuration framework 3500, various changes may be made to FIG. 35. For example, various changes to patch sizes could be made, etc., according to particular needs.

In some embodiments, the BS configures the shape and size of patches for the UE in the configuration signaling.

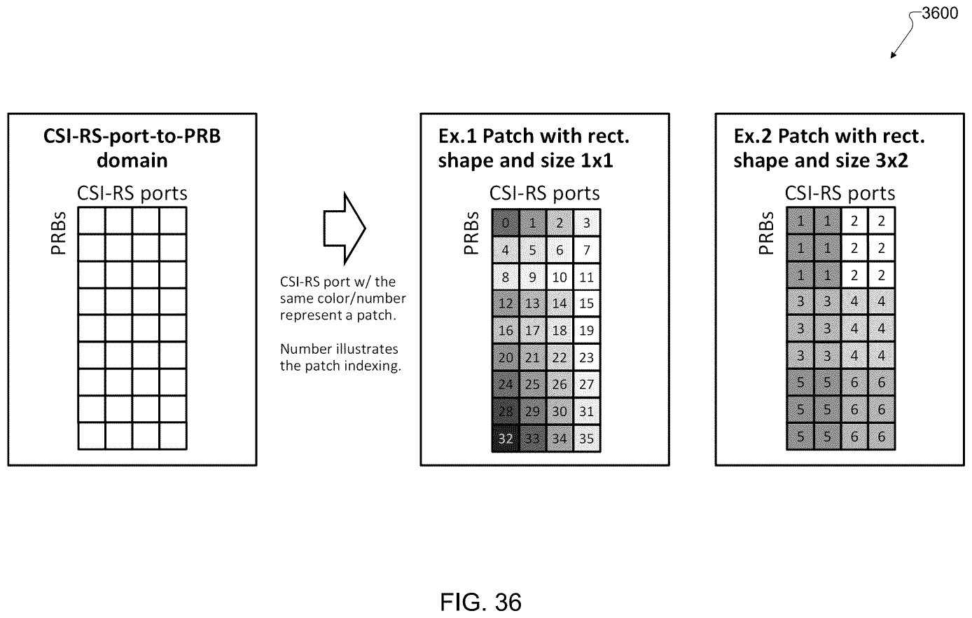

In some embodiments, the patch may have a rectangular shape, and the BS may configure the size of the shape (i.e., the number of PRB and the number of CSI-RS ports in a patch, and the patch indexing methodology) similar as shown in FIG. 36.

FIG. 36 illustrates an example patch size and shape configuration 3600 according to embodiments of the present disclosure. The embodiment of a patch size and shape configuration of FIG. 36 is for illustration only. Different embodiments of a patch size and shape configuration could be used without departing from the scope of this disclosure.

In the example of FIG. 36, blocks with the same digits refer to the same patch, and blocks that have different digits refer to a different patch.

In some embodiments, the BS may configure for the UE the patch size as [1 PRB by 1 CSI-RS port] as shown in the middle column in FIG. 36. The patch indexing is “row-wise”. In some embodiments, the BS may configure for the UE the patch size as [3 PRBs by 2 CSI-RS ports] as shown in the right column in FIG. 36. The patch indexing is “row-wise”.

In some embodiments, the BS may configure the patch indexing as “row-wise” explicitly to the UE. In some embodiments, the BS may not explicitly configure the patch indexing methodology. In embodiments such as these, the “row-wise” patch indexing methodology is by default or not available to the UE.

Although FIG. 36 illustrates one example patch size and shape configuration 3600, various changes may be made to FIG. 36. For example, various changes to size and shape could be made, etc., according to particular needs.

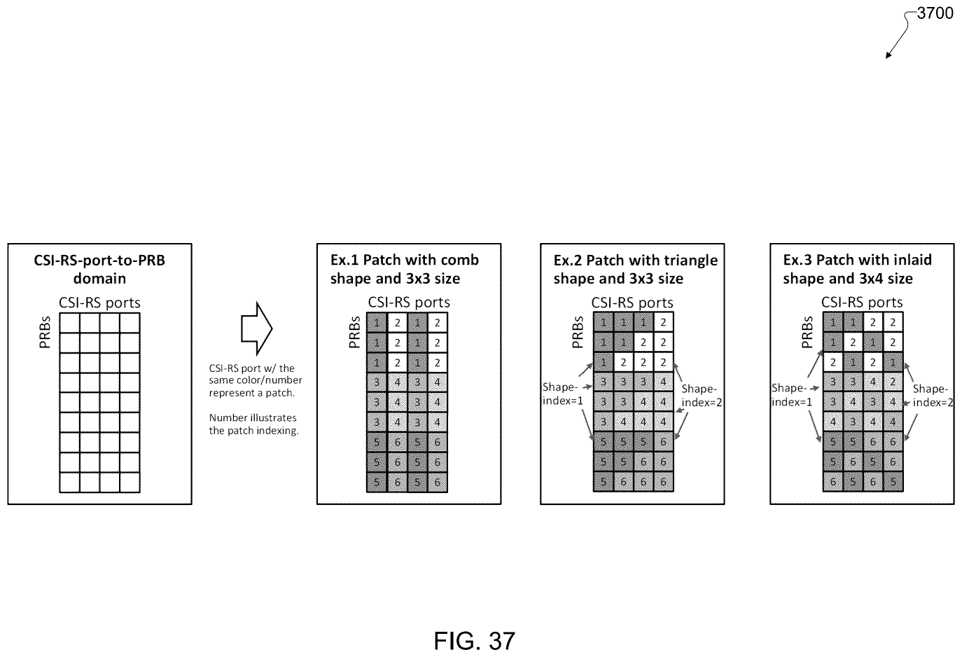

In some embodiments, a patch may have a shape specified by the BS, and the BS may configure the type of the shape, size of the shape, the indexes of the shape if more than one, and the patch indexing methodology, similar as shown in FIG. 37.

FIG. 37 illustrates another example patch size and shape configuration 3700 according to embodiments of the present disclosure. The embodiment of a patch size and shape configuration of FIG. 37 is for illustration only. Different embodiments of a patch size and shape configuration could be used without departing from the scope of this disclosure.

In the example of FIG. 37, blocks with the same digits refer to the same patch, and blocks that have different digits refer to a different patch.

In some embodiments, the BS may configure for the UE the patch as shown in the 2^{nd} column in FIG. 37, which occupies six CSI-RS ports, but the middle column of CSI-RS ports does not belong to that patch. For the signaling of the shape, the BS uses an index of patch-shape from the standardized patch shapes. For the signaling of the patch-size:
In some embodiments, the size of this patch-shape may be [3 PRBs by 2 CSI-RS ports] as the actual patch occupies.
In some embodiments, the size of this patch-shape may be [3 PRBs by 3 CSI-RS ports] as the largest area in CSI-RS-port-to-PRB domain that the patch occupies.

The patch indexing is “row-wise”. For the signaling of patch indexing:
In some embodiments, the BS may configure the patch indexing as “row-wise” explicitly to the UE.
In some embodiments, the BS may not explicitly configure the patch indexing methodology. In embodiments such as these, The “row-wise” patch indexing methodology is by default or not available to the UE.

In some embodiments, the BS may configure for the UE the patch as shown in the 3^{rd} and 4^{th} column in FIG. 37, which occupies 6 CSI-RS ports, but in a triangular or a spatial shape. For the signaling of the shape, the BS uses an index of patch-shape from the standardized patch shapes. For the signaling of the patch-size in some embodiments, the size of this patch-shape is [3 PRBs by 3 CSI-RS ports] or [3 PRBs by 4 CSI-RS ports] as the largest area in CSI-RS-port-to-PRB domain that the patch occupies, for the examples in the 3^{rd} and 4th column in FIG. 37.

Due to multiple shapes existing in such a patch-shape, each shape has its own shape-index, as shown in the 3^{rd} and 4^{th} column in FIG. 37. The patch indexing is “row-wise”. For the signaling of patch indexing:
In some embodiments, the BS may configure the patch indexing as “row-wise” explicitly to the UE.
In some embodiments, the BS may not explicitly configure the patch indexing methodology. In embodiments such as these, the “row-wise” patch indexing methodology is by default or not available to the UE.

Although FIG. 37 illustrates one example patch size and shape configuration 3600, various changes may be made to FIG. 37. For example, various changes to size and shape could be made, etc., according to particular needs.

In some embodiments, the BS may configure the UE the mapping pattern type, and CSI-RS port down-selection density (also referred to herein as density) of the mapping pattern configuration. The mapping pattern is repeatable of scalable, therefore:
In some embodiments, the BS may not configure the exact size of the mapping pattern (i.e., the BS does not configure the number of PRBs and the number of CSI-RS ports or the number of patches in the PRB and CSI-RS port domain as a part of the abstract mapping pattern configuration). The exact size of the mapping pattern may be determined with the patch configuration and mapping pattern instance configuration.
In some embodiments, the BS may configure the exact size of the mapping pattern, (i.e., the BS configures the number of PRBs and the number of CSI-RS ports or the number of patches in the PRB and CSI-RS port domain as a part of the abstract mapping pattern configuration.

In some embodiments, multiple orthogonal mapping patterns may be available in the mapping pattern generation process. The number of the orthogonal mapping patterns may be equal to 1 divided by the density. For example, if the density is ¼, there are 4 orthogonal mapping patterns. The orthogonal mapping patterns have a default or configured index of orthogonal mapping patterns in the signaling.

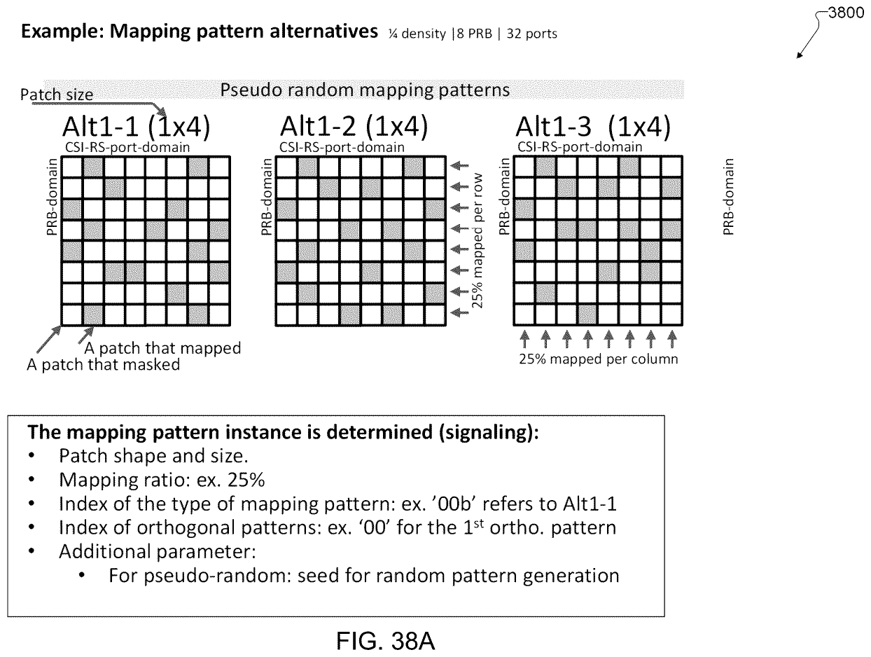

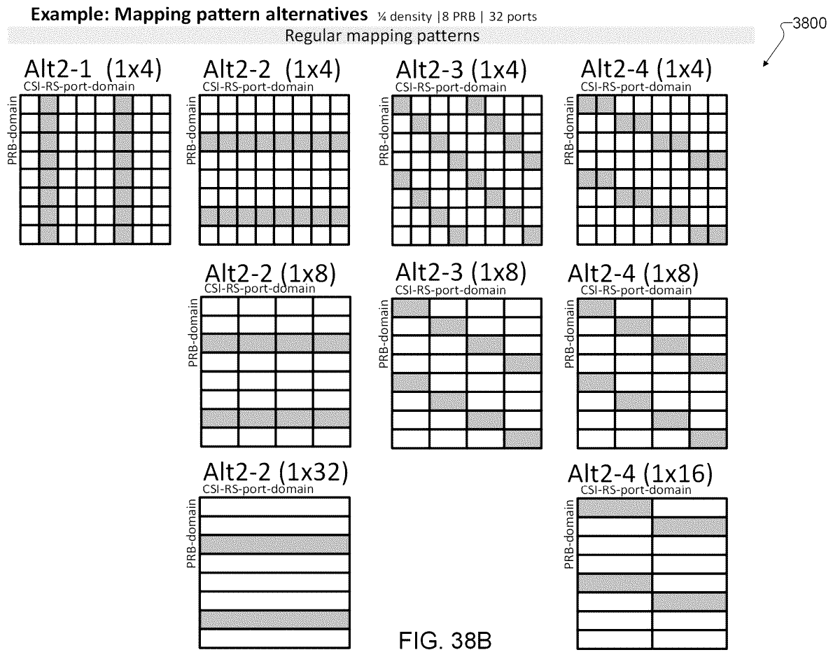

In some embodiments, the BS can configure one of multiple standardized mapping pattern types, similar as shown in FIGS. 38A and 38B.

FIGS. 38A and 38B illustrate example mapping patterns 3800 according to embodiments of the present disclosure. The embodiment of mapping patterns of FIGS. 38A and 38B is for illustration only. Different embodiments of mapping patterns could be used without departing from the scope of this disclosure.

In some embodiments, the mapping patterns may be generated through a pseudo random process. For example, in some embodiments the BS may configure the type of the mapping pattern, and the type indicates a specific pseudo random process, including the seed, pseudo random generator, the mapping pattern generation algorithm, etc. In some embodiments, the BS may configure the type of the mapping pattern as pseudo random. In embodiments such as these, the BS explicitly configures the UE of the seed, pseudo random generator, the mapping pattern generation algorithm, etc.

Three examples of pseudo random mapping patterns are shown in FIG. 38A:
Alt1-1 has no constraint of the patches selected from the CSI-RS-port-to-PRB domain.
Alt1-2 has a restriction that the number of patches selected from each PRB should be the same.
Alt1-3 has a restriction that the number of patches selected from each CSI-RS port should be the same.

In some embodiments, the mapping patterns may be regularly generated. In embodiments such as these, the mapping patterns are distinguished though the mapping pattern type configuration.

Four examples of regular mapping patterns are shown in FIG. 38B:
Alt2-1 has uniform down-selection in port domain, select all PRB of a CSI-RS port. The first selected patch in CSI-RS port domain is controlled by the orthogonal mapping pattern index.
Alt2-2 has uniform down-selection in port domain, select all port of a PRB. The first selected patch in PRB domain is controlled by the orthogonal mapping pattern index.
Alt2-3 uniformly down-selection in port domain, starting from first PRB and first port, cyclic shift is applied for every incremental PRB.
Alt2-4 down-selects consecutive patches in port domain according to mapping ratio, starting from first PRB and first port, cyclic shift is applied for every incremental PRB.

Although FIGS. 38A and 38B illustrate one example of mapping patterns 3800, various changes may be made to FIGS. 38A and 38B. For example, various changes to the mapping patterns could be made, etc., according to particular needs.

In some embodiments, only one of the orthogonal mapping patterns may be applied, indicating a CSI-RS port down selection configuration.

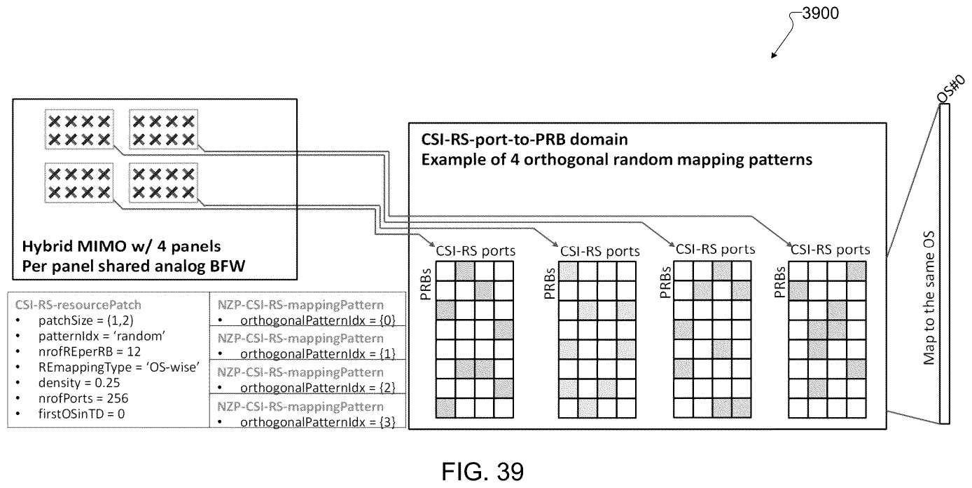

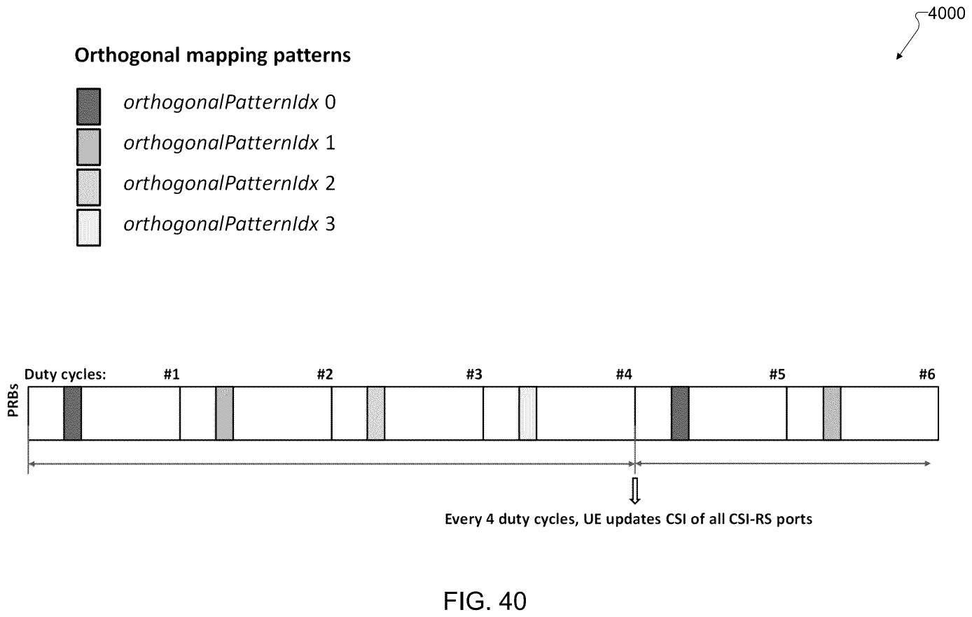

In some embodiments, multiple orthogonal mapping patterns are applied, similar as shown in FIG. 39 or FIG. 40.

FIG. 39 illustrates an example application of multiple orthogonal mapping patterns 3900 according to embodiments of the present disclosure. The embodiment of application of multiple orthogonal mapping patterns of FIG. 39 is for illustration only. Different embodiments of application of multiple orthogonal mapping patterns could be used without departing from the scope of this disclosure.

In the example of FIG. 39, the BS configures density ¼ and uses the 4 orthogonal mapping patterns for the CSI-RS port from 4 antenna panels or digital panels that have different analog beamforming configurations.

Although FIG. 39 illustrates one example application of multiple orthogonal mapping patterns 3900, various changes may be made to FIG. 39. For example, various changes to the density could be made, etc., according to particular needs.

FIG. 40 illustrates an example application of multiple orthogonal mapping patterns 4000 according to embodiments of the present disclosure. The embodiment of application of multiple orthogonal mapping patterns of FIG. 40 is for illustration only. Different embodiments of application of multiple orthogonal mapping patterns could be used without departing from the scope of this disclosure.

In the example of FIG. 40, the BS configures density ¼ and the configures cyclic repetition of the 4 orthogonal mapping patterns in the CSI-RS duty cycles. After the 4th duty cycle, the UE can update all the CSI from the CSI-RS ports.

Although FIG. 40 illustrates one example application of multiple orthogonal mapping patterns 4000, various changes may be made to FIG. 40. For example, various changes to the density could be made, etc., according to particular needs.

In some embodiments, when a mapping pattern is determined through patch configuration, mapping pattern configuration, and mapping pattern instance configuration, the mapped patch or CSI-RS ports may be further mapped to the physical (time-frequency) resource grid for the transmission.

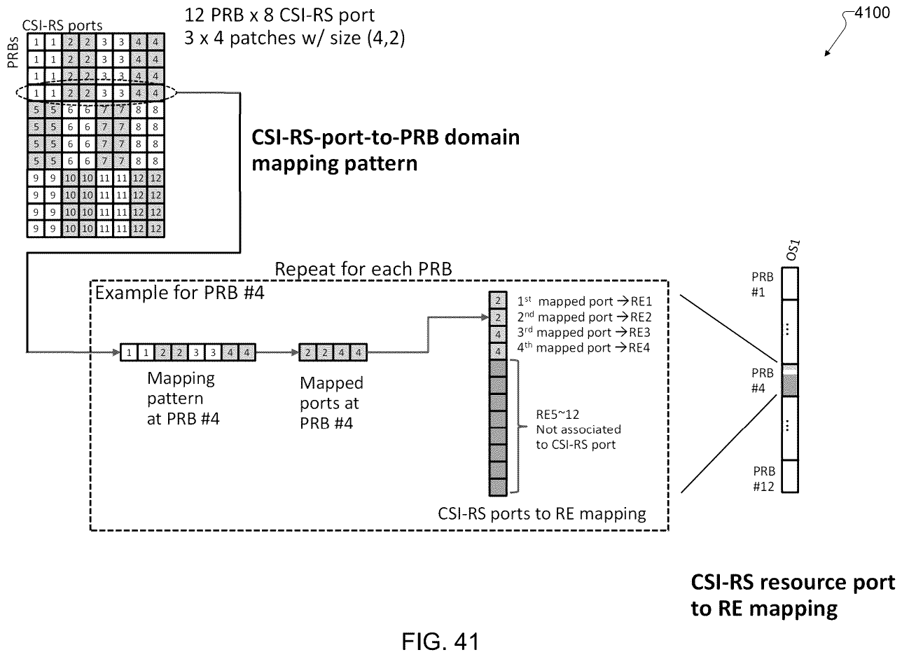

In some embodiments, the mapping pattern to physical resource mapping may be processed for each PRB in the mapping pattern, similar as shown in FIGS. 41-43B. In embodiments such as these, for each PRB, the mapped CSI-RS ports from the mapped patches are vectorized and mapped to the physical resource of the corresponding PRB. If no constraint of RE in the PRB for CSI-RS resource port mapping is configured, the CSI-RS ports will be mapped from the 1^{st} RE and occupies the consecutive REs in the PRB. If a specific constraint of a subset of RE is configured for CSI-RS resource port mapping, the CSI-RS port will be mapped from the 1^{st} RE in the constrained subset and occupy the consecutive REs in that constrained subset. If more than one OFDM symbol is required, the CSI-RS resource ports are mapped from the 1^{st} configured OFDM symbol and occupy the consecutive OFDM symbols until all the CSI-RS resource ports indicated in the mapping pattern are mapped to the resource grid.

FIG. 41 illustrates another example mapping pattern to physical resource mapping 4100 according to embodiments of the present disclosure. The embodiment of mapping of FIG. 41 is for illustration only. Different embodiments of mapping pattern to physical resource mapping could be used without departing from the scope of this disclosure.

In the example of FIG. 41, a CSI-RS-port-to-PRB domain mapping pattern includes 12 PRB by 8 CSI-RS ports. Rectangular patches with size 4 PRB by 2 CSI-RS port are configured. The CSI-RS ports belonging to the same patch have the same number in FIG. 41. When a mapping pattern is determined and there are less than 12 CSI-RS ports to be mapped, those CSI-RS ports will be mapped to the consecutive Res. CSI-RS port with a higher port index will be mapped to the RE with the higher RE index.

Although FIG. 41 illustrates one example mapping pattern to physical resource mapping 4100, various changes may be made to FIG. 41. For example, various changes to mapping the pattern could be made, etc., according to particular needs.

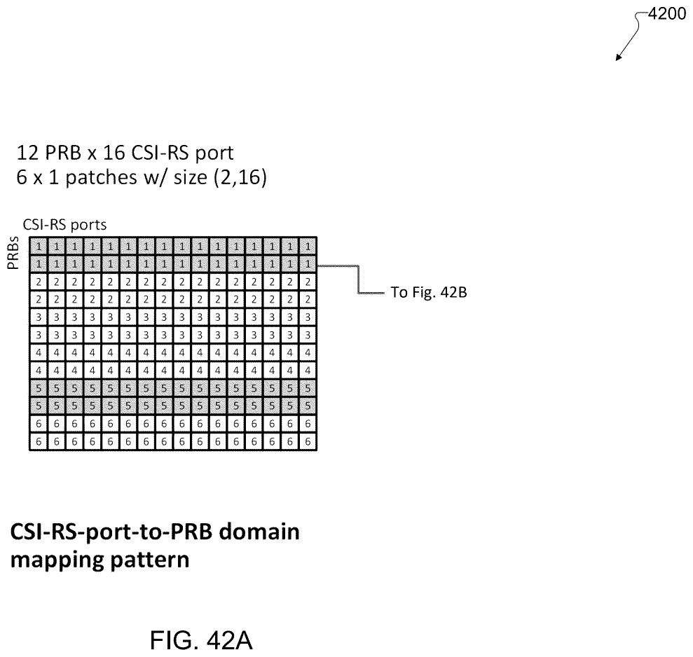

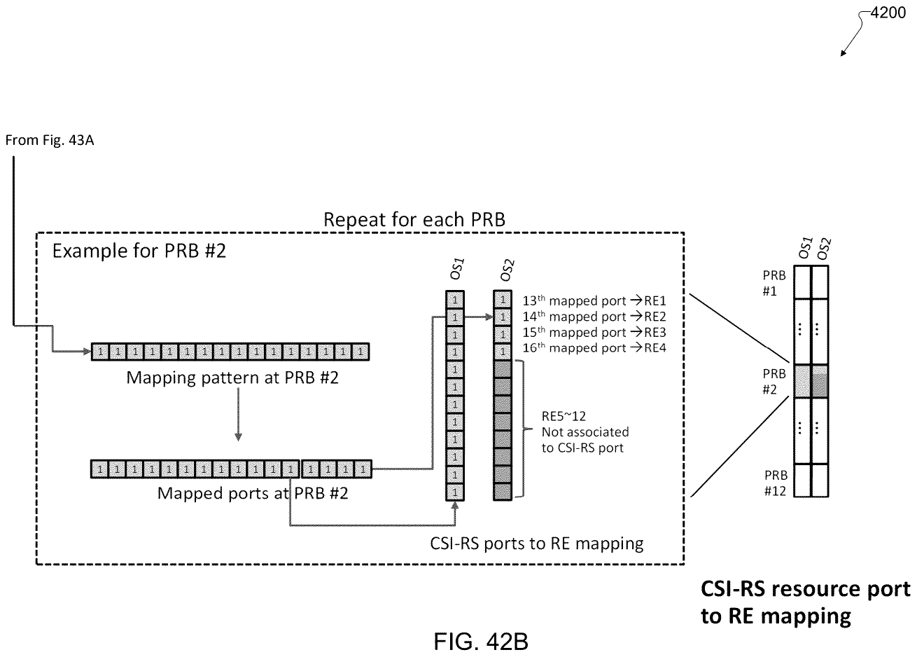

FIGS. 42A and 42B illustrate an example mapping pattern to physical resource mapping 4200 according to embodiments of the present disclosure. The embodiment of mapping of FIGS. 42A and 42B is for illustration only. Different embodiments of mapping pattern to physical resource mapping could be used without departing from the scope of this disclosure.

In the example of FIGS. 42A and 42B, a CSI-RS-port-to-PRB domain mapping pattern includes 12 PRB by 16 CSI-RS ports. Rectangular patches with size 2 PRB by 16 CSI-RS port are configured. The CSI-RS ports belonging to the same patch have the same number in FIGS. 42A and 42B. When a mapping pattern is determined and there are more than 12 CSI-RS ports to be mapped, the first CSI-RS ports will be mapped to the all REs of the 1^{st} OFDM symbol, and the last 4 CSI-RS port are mapped to the first 4 REs in the 2^{nd} OFDM symbol. CSI-RS port with a higher port index will be mapped to the RE with the higher RE index in each OFDM symbol.

Although FIGS. 42A and 42B illustrate one example mapping pattern to physical resource mapping 4200, various changes may be made to FIGS. 42A and 42B. For example, various changes to the mapping pattern could be made, etc., according to particular needs.

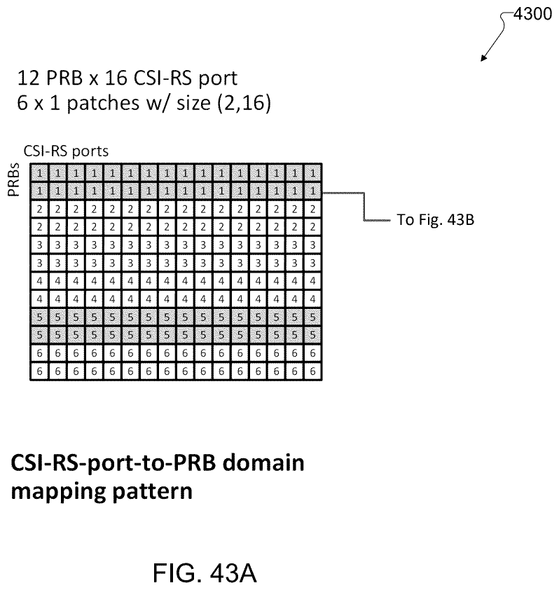

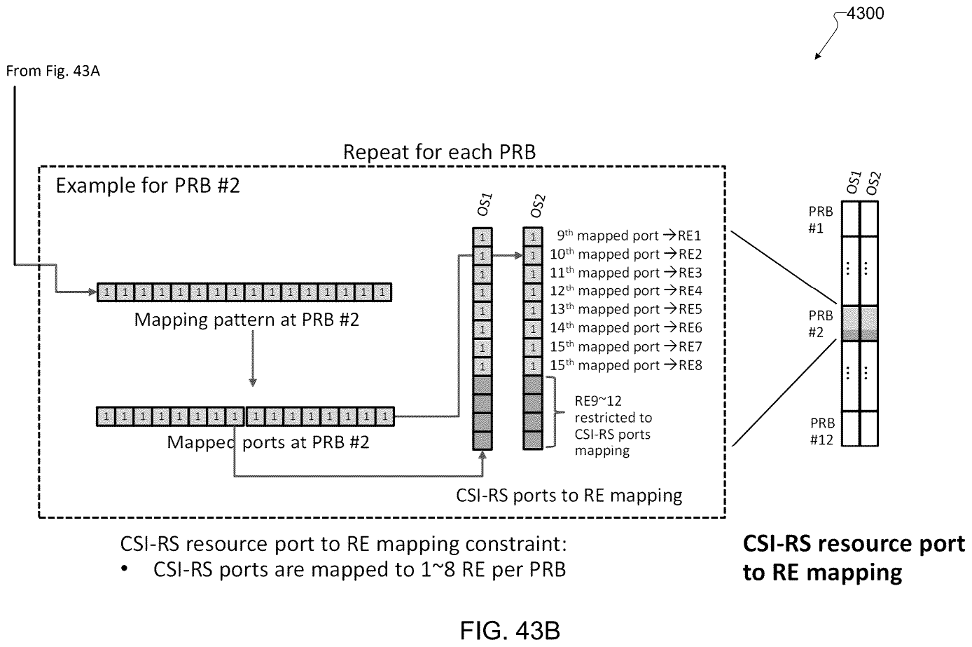

FIGS. 43A and 43B illustrate an example mapping pattern to physical resource mapping 4300 according to embodiments of the present disclosure. The embodiment of mapping of FIGS. 43A and 43B is for illustration only. Different embodiments of mapping pattern to physical resource mapping could be used without departing from the scope of this disclosure.

In the example of FIGS. 43A and 43B, a CSI-RS-port-to-PRB domain mapping pattern includes 12 PRBs by 16 CSI-RS ports. Rectangular patches with size 2 PRB by 16 CSI-RS ports are configured. The CSI-RS ports belonging to the same patch have the same number in FIGS. 43A and 43B. The BS configures an CSI-RS resource port to RE mapping constraint that the CSI-RS ports can only be mapped to the first 8 RE in each PRB. When a mapping pattern is determined and there are more than 8 CSI-RS ports to be mapped, the first 8 CSI-RS ports will be mapped to the first 8 REs of the 1^{st} OFDM symbol, and the last 8 CSI-RS port are mapped to the first 8 REs in the 2^{nd} OFDM symbol. CSI-RS port with a higher port index will be mapped to the RE with the higher RE index in each OFDM symbol.

Although FIGS. 43A and 43B illustrate one example mapping pattern to physical resource mapping 4300, various changes may be made to FIGS. 43A and 43B. For example, various changes to the mapping pattern could be made, etc., according to particular needs.

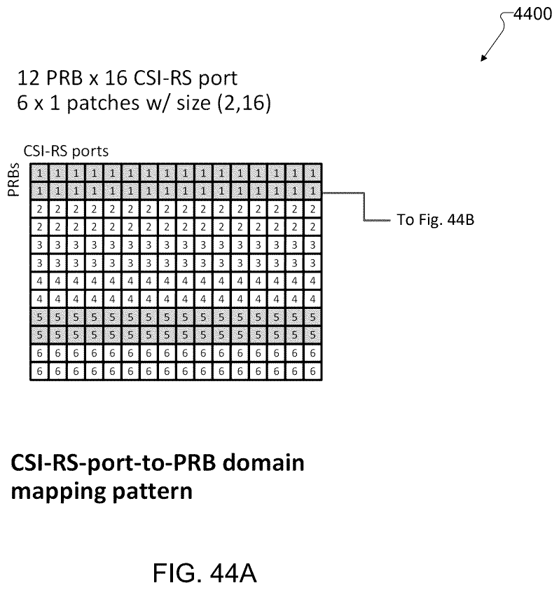

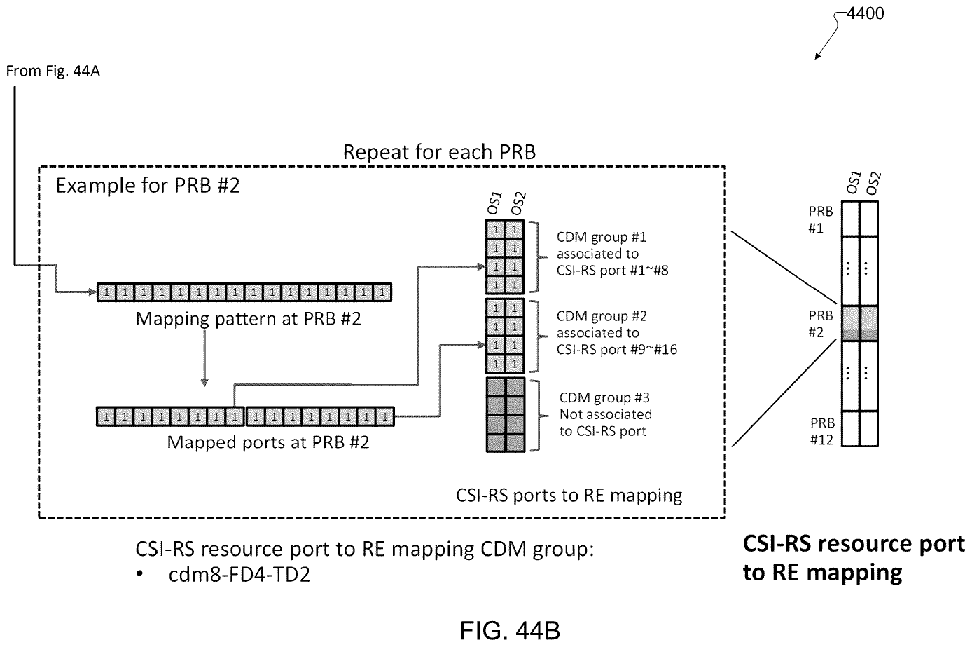

In some embodiments, the BS may configure CDM groups for mapped CSI-RS ports to be mapped, including the shape and location of the CDM groups. In embodiments such as these, the mapping pattern to physical resource mapping may be processed for each PRB in the mapping pattern, similar as shown in FIGS. 44A and 44B. For each PRB, the mapped CSI-RS ports from the mapped patches are vectorized and mapped to the physical resource of the corresponding PRB. The mapped CSI-RS ports are mapped to the configured CDM groups. When one CDM is fully mapped with CSI-RS ports, the consecutive CSI-RS ports will be mapped to the next CDM group, until all the CSI-RS ports are mapped.

FIGS. 44A and 44B illustrate an example mapping pattern to physical resource mapping 4400 according to embodiments of the present disclosure. The embodiment of mapping of FIGS. 44A and 44B is for illustration only. Different embodiments of mapping pattern to physical resource mapping could be used without departing from the scope of this disclosure.

In the example of FIGS. 44A and 44B, a CSI-RS-port-to-PRB domain mapping pattern includes 12 PRBs by 16 CSI-RS ports. Rectangular patches with size 2 PRB by 16 CSI-RS port are configured. The CSI-RS ports belonging to the same patch have the same number in FIGS. 44A and 44B. The BS configures CDM-8 groups with frequency domain 4 REs and time domain 2 REs. When a mapping pattern is determined, the first 8 CSI-RS ports will be mapped to the 1^{st} CDM-8 group and the last 8 CSI-RS port are mapped to the 2^{nd} CDM-8 group. The CDM-8 groups will be mapped to the first 8 REs in the PRB and occupy 2 OFDM symbols.

Although FIGS. 44A and 44B illustrate one example mapping pattern to physical resource mapping 4400, various changes may be made to FIGS. 44A and 44B. For example, various changes to mapping pattern could be made, etc., according to particular needs.

In some embodiments artificial intelligence (AI)/machine learning (ML) algorithms may be used at the UE and/or BS side for patch-level sparse CSI in-painting and full-frequency CSI acquisition. Through the signaling of patch and mapping patterns, the UE side patch-level processing is enabled.

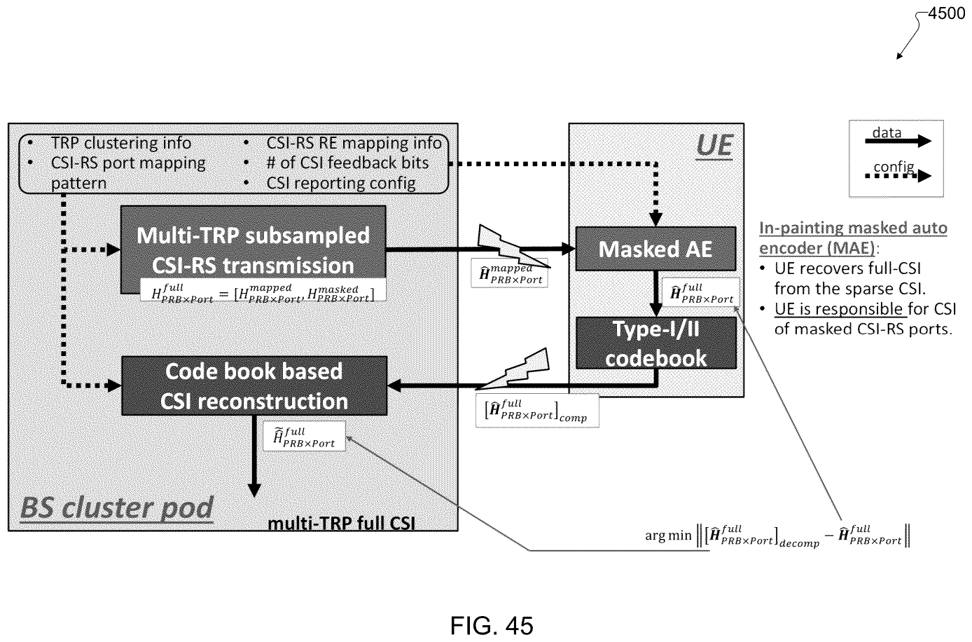

Four embodiments of CSI in-painting frameworks are shown in FIGS. 45-48 introduced below. Commonly among the embodiments of FIGS. 45-48, the BS configures the patch, mapping pattern, CSI-RS resource to RE mapping, and mapping pattern instance to the UE. The targeted full-frequency CSI is noted as

$${H}_{PRB \times Port}^{full} ,$$

the mapped or visible CSI-RS ports are referred in

$${H}_{PRB \times Port}^{mapped} ,$$

and the masked or invisible CSI-RS ports are referred in

$${H}_{PRB \times Port}^{masked} .$$

### Only the

$${H}_{PRB \times Port}^{mapped}$$

SCI-RS ports are transmitted, and UE obtains

$${\hat{H}}_{PRB \times Port}^{mapped}$$

after measurement. Depending on the embodiment, the UE reports compressed CSI of the mapped CSI-RS port in

$${[ {\hat{H}}_{PRB \times Port}^{mapped} ]}_{comp} ,$$

of the UE reports full-frequency CSI in

$${[ {\hat{H}}_{PRB \times Port}^{full} ]}_{comp} .$$

Eventually, the BS decompresses and post processes the CSI report and obtains the full-frequency CSI as

$${\tilde{\hat{H}}}_{PRB \times Port}^{full} .$$

FIG. 45 illustrates an example CSI in-painting framework 4500 according to embodiments of the present disclosure. The embodiment of a CSI in-painting framework of FIG. 45 is for illustration only. Different embodiments of a CSI in-painting framework could be used without departing from the scope of this disclosure.

In the example of FIG. 45, the UE performs CSI in-painting, for example through a masked autoencoder. The UE uses a Type-I or Type-II codebook to compress the full-frequency CSI as

$${[ {\hat{H}}_{PRB \times Port}^{full} ]}_{comp} .$$

The BS decodes and obtains the full-frequency CSI. The AI module is one-sided (i.e., only at the UE side).

Although FIG. 45 illustrates one example CSI in-painting framework 4500, various changes may be made to FIG. 45. For example, various changes to compression could be made, etc., according to particular needs.

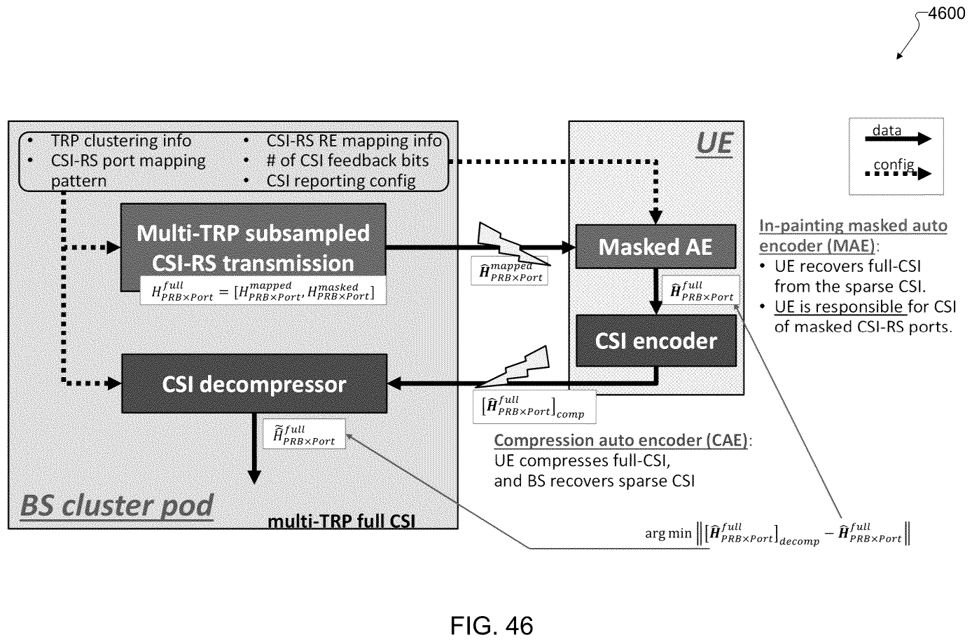

FIG. 46 illustrates another example CSI in-painting framework 4600 according to embodiments of the present disclosure. The embodiment of a CSI in-painting framework of FIG. 46 is for illustration only. Different embodiments of a CSI in-painting framework could be used without departing from the scope of this disclosure.

In the embodiment of FIG. 46, the UE performs CSI in-painting, for example through a masked autoencoder. The UE uses an AI-based encoder to compress the full-frequency CSI as

$${[ {\hat{H}}_{PRB \times Port}^{full} ]}_{comp} .$$

The BS uses a corresponding decoder and obtains the full-frequency CSI. The AI module is two-sided (i.e., at both the UE and BS side).

Although FIG. 46 illustrates one example CSI in-painting framework 4600, various changes may be made to FIG. 46. For example, various changes to compression could be made, etc., according to particular needs.

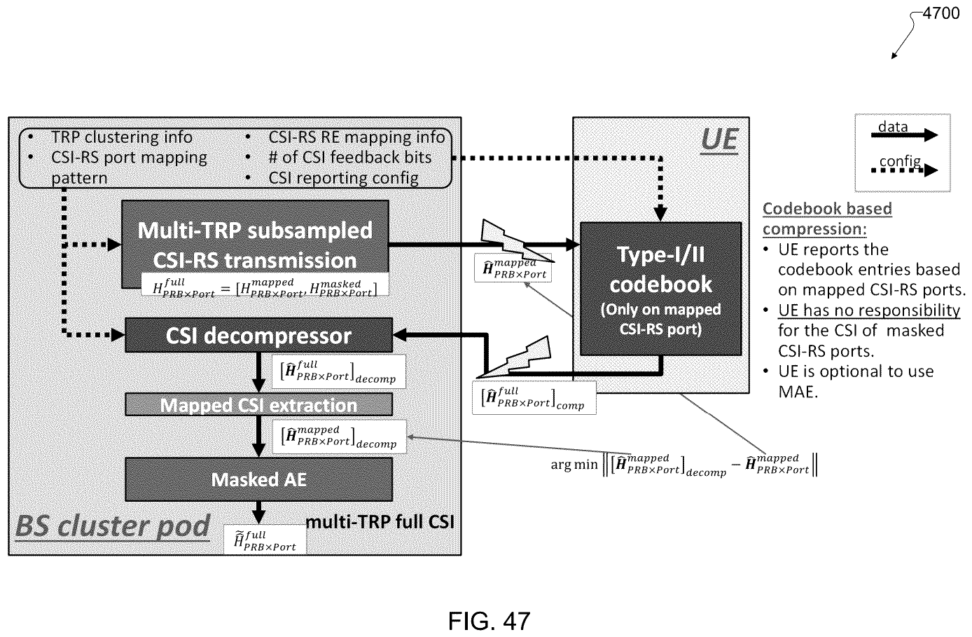

FIG. 47 illustrates another example CSI in-painting framework 4700 according to embodiments of the present disclosure. The embodiment of a CSI in-painting framework of FIG. 47 is for illustration only. Different embodiments of a CSI in-painting framework could be used without departing from the scope of this disclosure.

In the example of FIG. 47, the UE uses a Type-I or Type-II codebook to compress mapped CSI to full-frequency CSI, however, the UE only considers the accuracy of recovering the mapped CSI and ignores the accuracy of the masked CSI. The UE will report full-frequency CSI

$${[ {\hat{H}}_{PRB \times Port}^{full} ]}_{comp}$$

through the full-frequency CSI. Then, the BS re-extracts the masked CSI and performs CSI in-painting. The AI module is one-sided (i.e., only at the BS side).

Although FIG. 47 illustrates one example CSI in-painting framework 4700, various changes may be made to FIG. 47. For example, various changes to compression could be made, etc., according to particular needs.

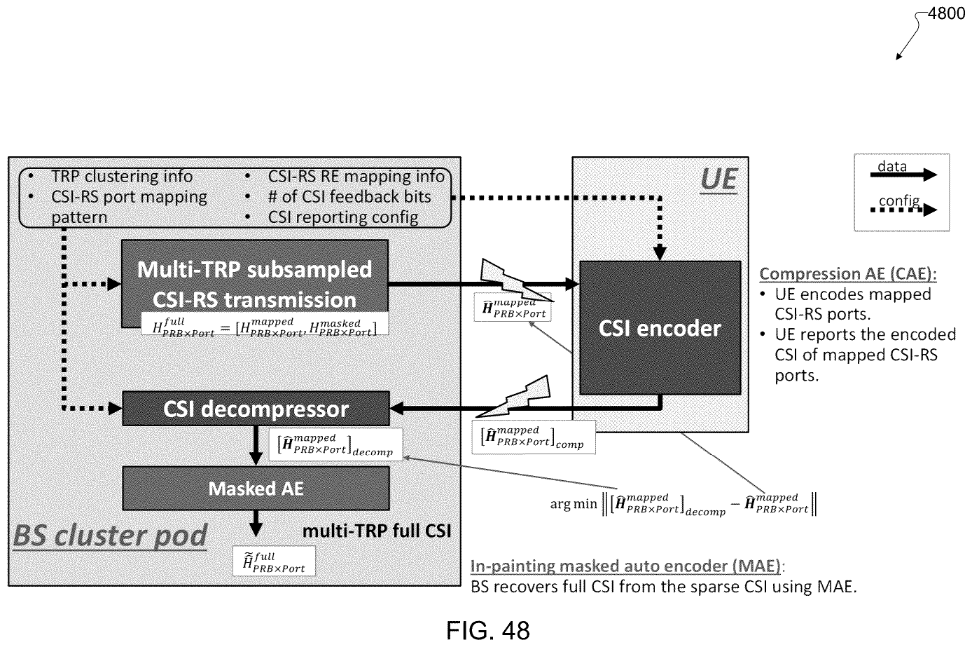

FIG. 48 illustrates another example CSI in-painting framework 4800 according to embodiments of the present disclosure. The embodiment of a CSI in-painting framework of FIG. 48 is for illustration only. Different embodiments of a CSI in-painting framework could be used without departing from the scope of this disclosure.

In the example of FIG. 48, the UE uses an AI-based encoder to compress the mapped CSI as

$${[ {\hat{H}}_{PRB \times Port}^{mapped} ]}_{comp} .$$

The BS first uses a corresponding decoder and obtains the mapped CSI. Then, the BS uses AI for CSI in-painting and obtains the full-frequency CSI. The AI module is two-sided (i.e., at both the UE and BS side).

Although FIG. 48 illustrates one example CSI in-painting framework 4800, various changes may be made to FIG. 48. For example, various changes to compression could be made, etc., according to particular needs.

In the embodiments described herein, the patch-level mapping patterns may reduce the UE side CSI in-painting complexity using masked autoencoders.

In some embodiments, the complexity can be further reduced by per subband CSI-inpainting. For example, in some embodiments, the BS may configure one or multiple frequency bands or subband for CSI in-painting at the UE. In embodiments such as these, the UE performs CSI in-painting exactly following the frequency band configuration. In some embodiments, the BS may configure one or multiple frequency bands or subbands for CSI in-panting at the UE. In embodiment such as these, the UE may determine the exact subband width for CSI in-painting as a UE implementation option.

In some embodiments, the complexity can be further adjusted by patch decomposition or composition at the UE side. For example, in some embodiments, the BS may configure the patch shape and size to the UE. In embodiments such as these, the UE may exactly follow the patch shape and size configuration. In some embodiments, the BS may configure the patch shape and size to the UE. In embodiment such as these, the UE, based on its computational capability, can decompose the configured patch to smaller patches or compose the configured patches to larger patches according to the mapping pattern (especially regular mapping patterns).

As noted above, various embodiments of the present disclosure provide for signaling to indicate CSI-RS ports and relative configuration of sparsely sub-selected CSI-RS ports to a UE.

In some embodiments, configuration signaling for CSI-RS resource and CSI-RS port to resource mapping may include a CSI-RS resource configuration (part I) and a CSI-RS port to resource mapping configuration (part II):
Part I: CSI-RS resource configuration: includes the RE mapping of CSI-RS in time, frequency, and CDM code domain. The number of transmitted CSI-RS ports is configured by Part I.
Part II: CSI-RS port to resource mapping configuration: Part II maps the CSI-RS port index to each of the transmitted CSI-RS port (configured in Part I). The maximum possible CSI-RS port index is equal or larger than the transmitted CSI-RS ports in each PRB.

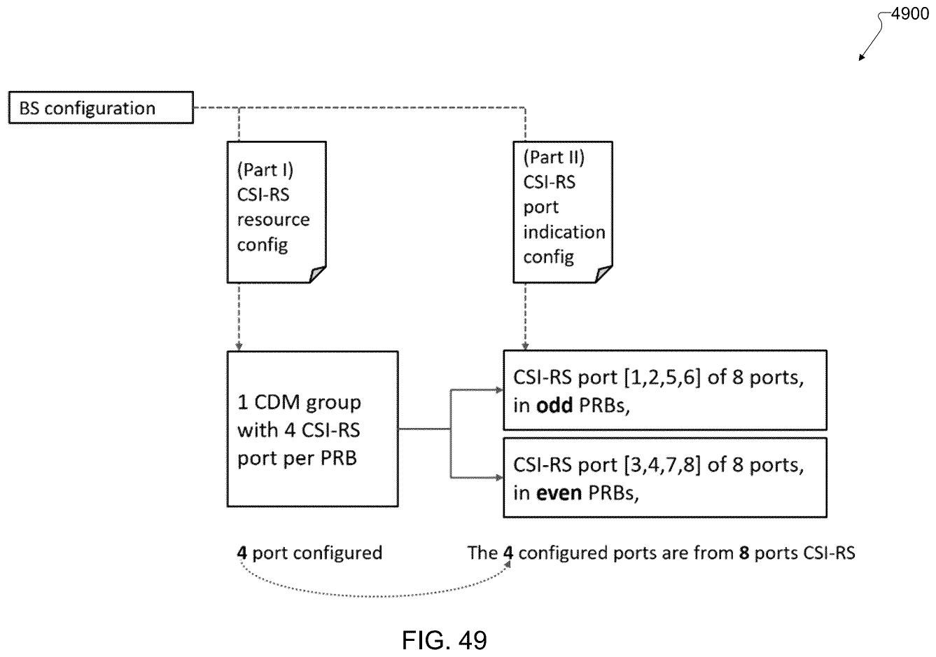

In embodiments such as these, the BS may configure per PRB CSI-RS resources through one or multiple CDM groups in Part I, and the BS may configure for the UE Part II, which indicates the CSI-RS port index of each port configured in Part I. The CSI-RS port indexes configuration is for one or multiple PRB in a cycle. An example is shown in FIG. 49.

FIG. 49 illustrates an example configuration signaling for CSI-RS resource and CSI-RS port to resource mapping 4900 according to embodiments of the present disclosure. The embodiment of configuration signaling for CSI-RS resource and CSI-RS port to resource mapping of FIG. 49 is for illustration only. Different embodiments of configuration signaling for CSI-RS resource and CSI-RS port to resource mapping could be used without departing from the scope of this disclosure.

In an example of FIG. 49, the BS configures for the UE a Part I, which indicates 4 CSI-RS ports per PRB, the 4 ports for example are in a CDM-FD2-TD2 group. The BS also configures for the UE a Part II indicating that the 4 CSI-RS ports in odd PRBs are actually CSI-RS ports #1˜ #4 of an 8-port CSI-RS. The 4 CSI-RS ports in even PRBs are actually CSI-RS ports #5˜ #8 of an 8 port CSI-RS.

Although FIG. 49 illustrates one example of configuration signaling for CSI-RS resource and CSI-RS port to resource mapping 4900, various changes may be made to FIG. 49. For example, various changes to the number of ports could be made, etc., according to particular needs.

In some embodiments, configuration signaling for sparsely sub-sampled CSI-RS may include two Parts (Part I & Part II′):
Part I: CSI-RS resource configuration: includes the RE mapping of CSI-RS in time, frequency, and CDM code domain. Part I comprises a full-port CSI-RS resource configuration (i.e., the number of configured CSI-RS ports equals the maximum CSI-RS port index).
Part II′: CSI-RS port sub-sampling configuration. Controlled by Part II′, the actual transmitted CSI-RS ports are sub-sampled from the CSI-RS ports configured in the CSI-RS resource configuration (i.e., Part I), yield a sparse CSI-RS configuration. The CSI-RS port index remains as in Part I, or is reconfigured by Part II′.

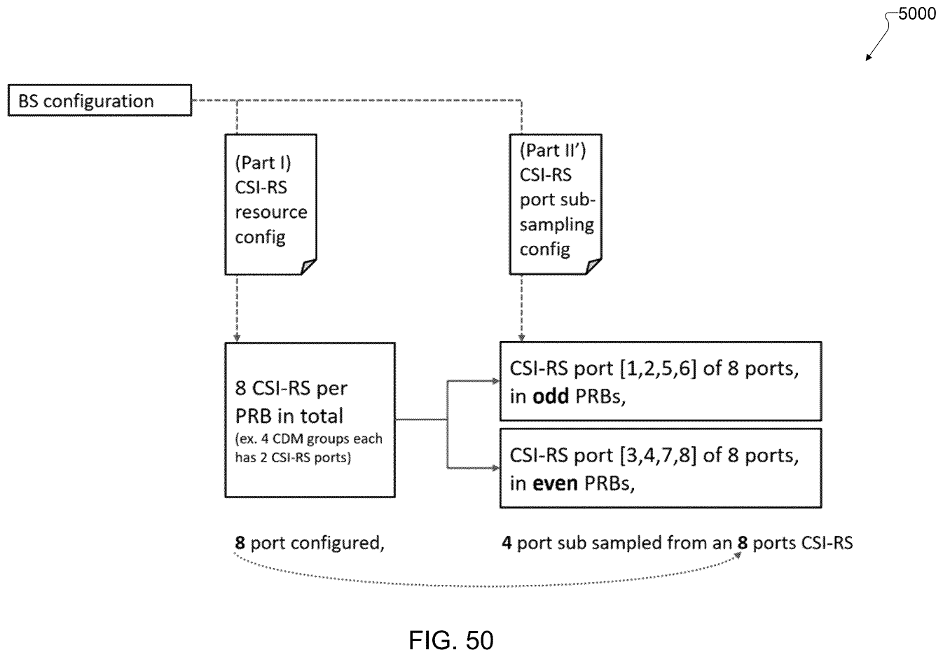

In embodiments such as these, the BS configures full-port CSI-RS resources through one or multiple CDM groups in Part I, across in one or multiple PRBs, and the BS may configure for the UE Part II′, which indicates which CSI-RS ports or CDM groups are kept, and others are masked (not to transmit). The BS can also configure CSI-RS port numbering in Part II′. After jointly parsing both Part I and Part II, UE acquires the CSI-RS resource and the sparse CSI-RS port configuration. An example is shown in FIG. 50.

FIG. 50 illustrates an example configuration signaling for sparsely sub-sampled CSI-RS 5000 according to embodiments of the present disclosure. The embodiment of configuration signaling for sparsely sub-sampled CSI-RS of FIG. 50 is for illustration only. Different embodiments of configuration signaling for sparsely sub-sampled CSI-RS could be used without departing from the scope of this disclosure.

In an example of FIG. 50, the BS configures for the UE a Part I, which indicates 8 CSI-RS ports per PRB, the 8 ports for example are in two CDM-FD2-TD2 groups. The BS also configures for the UE a Part II′ indicating that the odd PRBs contain CSI-RS ports #1˜ #4 sub-sampled from the 8 port CSI-RS. The even PRBs contain CSI-RS ports #5˜ #8 sub-sampled from the 8 port CSI-RS.

Although FIG. 50 illustrates one example of configuration signaling for sparsely sub-sampled CSI-RS 5000, various changes may be made to FIG. 50. For example, various changes to the number of ports could be made, etc., according to particular needs.

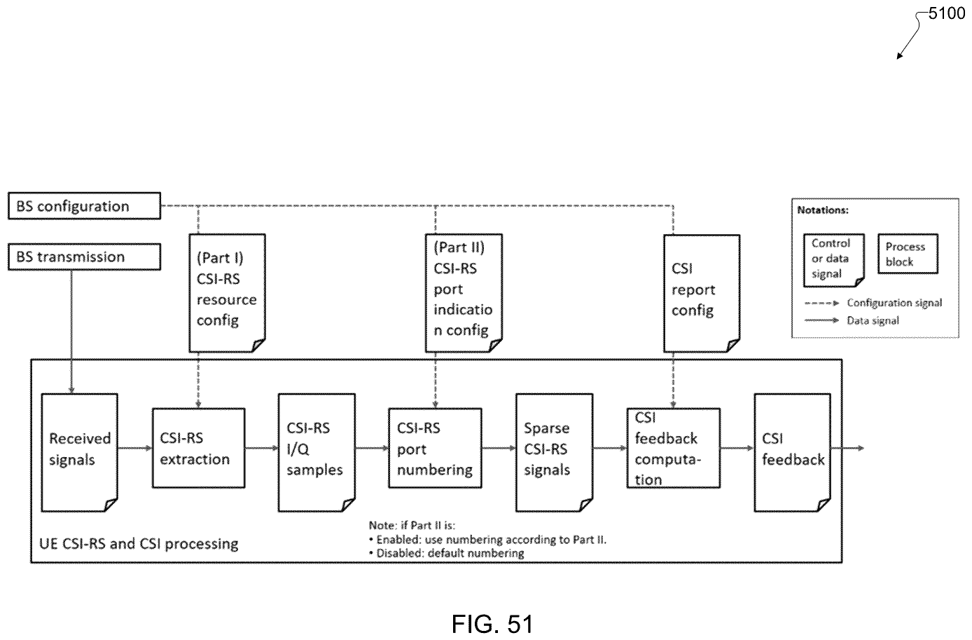

In some embodiments, a BS may configure a sparse CSI-RS reception to a UE through a Part I and Part II, similar as shown in FIG. 51.

FIG. 51 illustrates another example configuration signaling for sparsely sub-sampled CSI-RS 5100 according to embodiments of the present disclosure. The embodiment of configuration signaling for sparsely sub-sampled CSI-RS of FIG. 51 is for illustration only. Different embodiments of configuration signaling for sparsely sub-sampled CSI-RS could be used without departing from the scope of this disclosure.

In the example of FIG. 51, the UE locates the time-frequency resource and extracts CSI-RS from received signal according to the Part I configuration. The UE performs per received CSI-RS port channel estimation and obtains CSI (e.g., in an I/Q format). The UE parses the CSI-RS port indexes of each received CSI-RS port according to the Part II configuration. The UE conducts other process (e.g. CSI reporting) according to other configurations from the BS (e.g., the CSI report config).

In addition,
If Part II has not been configured:
   The total number of CSI-RS ports equals the number of CSI-RS ports configured in Part I.
   The number of transmitted CSI-RS ports equals the number of CSI-RS ports configured in Part I.
   The CSI-RS port index uses the default numbering methodology in Part I, e.g., 1, 2, 3, etc.
If Part II has been configured:
   The total number of the CSI-RS ports is determined by the CSI-RS port with maximum port index configured in Part II. Such a number is greater or equal to the number of CSI-RS ports configured by Part I.
   The number of transmitted CSI-RS ports per PRB equals the number of CSI-RS ports per PRB configured by Part I.
   The CSI-RS port indexes a configured by Part II.

Although FIG. 51 illustrates one example of configuration signaling for sparsely sub-sampled CSI-RS 5100, various changes may be made to FIG. 51. For example, various changes to the number of ports could be made, etc., according to particular needs.

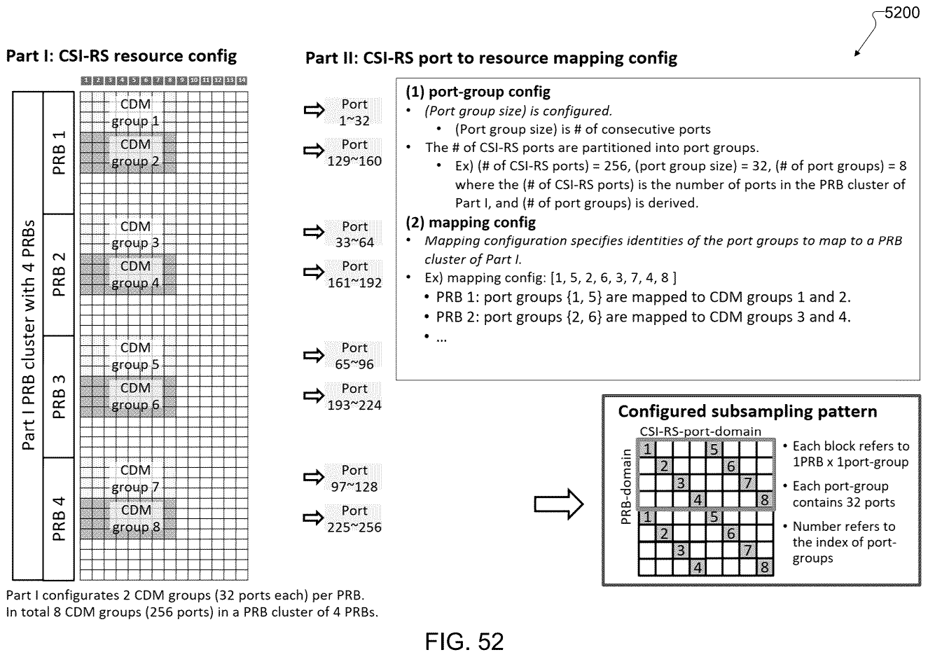

In some embodiments, in Part I, the BS may configure one or multiple CDM groups per PRB, and one or multiple such consecutive PRBs in a PRB cluster. The PRB clusters consecutively repeat and occupy a configured CSI-RS frequency band. In embodiments such as these, in Part II, the BS configures CSI-RS port group, through the number of consecutive CSI-RS port in a port group. The maximum CSI-RS port index equals the total number of CSI-RS ports in the PRB cluster of Part I. Thus, the number of the port groups is derived. Additionally, Part II comprises a mapping configuration of the identities of the port groups to a PRB cluster of Part I (i.e., the PRB cluster of Part II equals the PRB cluster of Part I). An example is shown in FIG. 52.

FIG. 52 illustrates another example configuration signaling for sparsely sub-sampled CSI-RS 5200 according to embodiments of the present disclosure. The embodiment of configuration signaling for sparsely sub-sampled CSI-RS of FIG. 52 is for illustration only. Different embodiments of configuration signaling for sparsely sub-sampled CSI-RS could be used without departing from the scope of this disclosure.

In one example as shown in FIG. 52, Part I configures 2 of 32-port CDM group per PRB; the PRB cluster of Part I includes 4 PRBs, i.e., 8 CDM groups with 256 CSI-RS ports in total in one PRB cluster. Part II configures port group size as 32, hence the number of port per port group is derived as 8=256/32. Part II configures a mapping of port group index to the PRB cluster of Part I configuration. The port group with index [1, 5, 2, 6, 3, 7, 4, 8] are mapped to the CDM groups in the PRB cluster of Part I. Configured by Part I and Part II, the resulting sparse CSI-RS sampling pattern in PRB and port group domain is shown on the bottom-right of FIG. 52

In another example as shown in FIG. 52, the port group size in Part II signaling is hard coded as the number of ports in each CDM group. In this example, the port group size in Part II signaling is absent, and the number of port groups equals the number of CDM groups in Part I signaling.

Although FIG. 52 illustrates one example of configuration signaling for sparsely sub-sampled CSI-RS 5200, various changes may be made to FIG. 52. For example, various changes to the number of ports could be made, etc., according to particular needs.

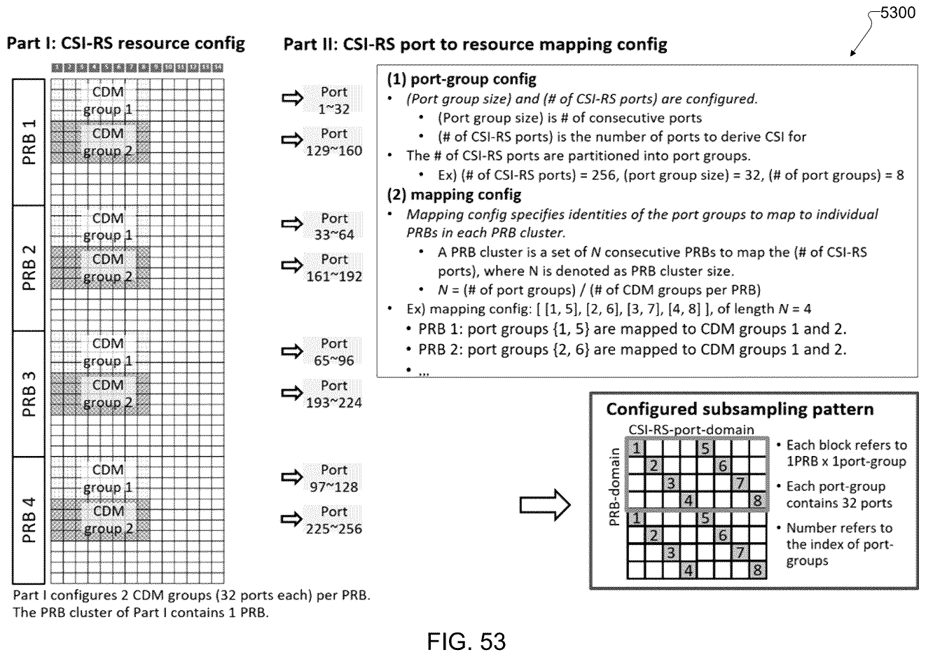

In some embodiments, in Part I, the BS may configure one or multiple CDM groups per PRB, and such configuration is applied to each PRB in the configured CSI-RS frequency band (i.e., the PRB cluster of Part I contains 1 PRB). In embodiments such as these, in Part II, the BS configures the CSI-RS port group, through the (i) number of consecutive CSI-RS port in a port group, and (ii) the total number of CSI-RS ports. Thus, the number of the port groups is derived. Additionally, Part II comprises mapping configuration of the identities of the port groups to a PRB cluster comprising a set of N consecutive PRBs, where N equals the total number of CSI-RS ports divided by the number of CSI-RS ports configured per PRB in Part I. For each PRB in the PRB cluster, the mapping configuration in Part II specifies the identities of the port groups to map to that PRB. An example is shown in FIG. 53.

FIG. 53 illustrates another example configuration signaling for sparsely sub-sampled CSI-RS 5300 according to embodiments of the present disclosure. The embodiment of configuration signaling for sparsely sub-sampled CSI-RS of FIG. 53 is for illustration only. Different embodiments of configuration signaling for sparsely sub-sampled CSI-RS could be used without departing from the scope of this disclosure.

In one example, as shown in FIG. 53, Part I configures 2 of 32-port CDM group per PRB. Part II configures port group size as 32 and the total number of CSI-RS ports are 256, hence the number of port per port group is derived as 8=256/32. Part II configures a mapping of port group index to the PRB cluster of 4 consecutive PRBs. For the 4 PRBs, the port group with index [1, 5], [2, 6], [3, 7], and [4, 8] are mapped respectively according to Part II. Configured by Part I and Part II, the resulted sparse CSI-RS sampling pattern in PRB and port group domain is on the bottom-right of FIG. 53. The PRB cluster of Part I is different (contains fewer PRBs) from Part II.

In another example, as shown in FIG. 53, the port group size in Part II signaling is hard coded as the number of ports in each CDM group. In this example, the port group size in Part II signaling is absent, and the number of port groups equals the number of CSI-RS ports in Part II signaling divided by the number of CDM groups in Part I signaling.

Although FIG. 53 illustrates one example of configuration signaling for sparsely sub-sampled CSI-RS 5300, various changes may be made to FIG. 53. For example, various changes to the number of ports could be made, etc., according to particular needs.

Both the examples of FIG. 52 and FIG. 53 comprise the configuration of the following four parameters in the first column in Table 1 (i.e., the number of CDM groups per PRB, the number of PRBs per PRB cluster, the total number of CSI-RS ports, and the port group size, i.e., the number of CSI-RS ports in a port group).
In the example of FIG. 52, the Part I signaling comprises the configuration of CDM groups, including the number of CDM groups per PRB, the number of CSI-RS ports in each CDM group, and the number of PRBs in each PRB cluster. The total number of CSI-RS ports is derived by the number of CDM group per PRB multiplied by the number of CSI-RS ports per CDM group and multiplied by the number of PRBs in a PRB cluster.
In the example of FIG. 53, the Part I signaling comprises the configuration of CDM groups, including the number of CDM groups per PRB and the number of CSI-RS ports in each CDM group. The Part II signaling comprises the total number of the CSI-RS ports. The PRB cluster size is derived by the total number of CSI-RS ports divided by the number of CDM groups per PRB.

TABLE 1
Key parameters for CSI-RS port groups
configurations in Embodiment 1

| Parameters | Alternative 1 | Alternative 2 |
|---|---|---|
| # of (CDM groups) | Part I | Part I |
| per PRB | | |
| # of PRBs per | Part I | Derived |
| (PRB cluster) | | |
| # of total | Derived | Part II |
| CSI-RS ports | | |
| Port group size | Part II | Part II |

In some embodiments, when the BS configures multiple CSI-RS configuration with a different total number of CSI-RS ports in different time instances, one common Part-I in in the example of FIG. 53 can be reused, however, a different Part-I signaling message per instance is needed in the example of FIG. 52.
For example: as in Table 2, a BS transmits a 256-port CSI-RS every 160 ms, meanwhile, the BS transmits a 64-port CSI-RS with the other 3-quarters of ports are muted (e.g., for energy saving) every 20 ms. Table 2 illustrates the Part-I and Part-II configurations using the two alternatives for such a scenario.

TABLE 2
Example of different signaling for the configuration of 256 ports
and 64 ports CSI-RS using the embodiments as in FIG. 52 and FIG. 53

CSI-RS configuration

| in different | FIG. 52 | FIG. 53 | |
|---|---|---|---|
| time instances | embodiment | embodiment | |
| 256 ports | Part I: | Part I: | Part II: |
| | 2 CDM groups | 2 CDM groups | 32 ports in |
| | per PRB | per PRB | one group |
| | 32 ports per | 32 ports per | 256 ports |
| | CDM group | CDM group | in total |
| | 4 PRBs in | | |
| | one cluster | | |
| | Part II: | | |
| | 32 ports in | | |
| | one group | | |
| 64 ports | Part I: | | Part II: |
| (75% of | 2 CDM groups | | 32 ports in |
| the ports | per PRB | | one group |
| are muted) | 32 ports per | | 64 ports |
| | CDM group | | in total |
| | 1 PRBs in | | |
| | one cluster | | |
| | Part II: | | |
| | 32 ports in | | |
| | one group | | |

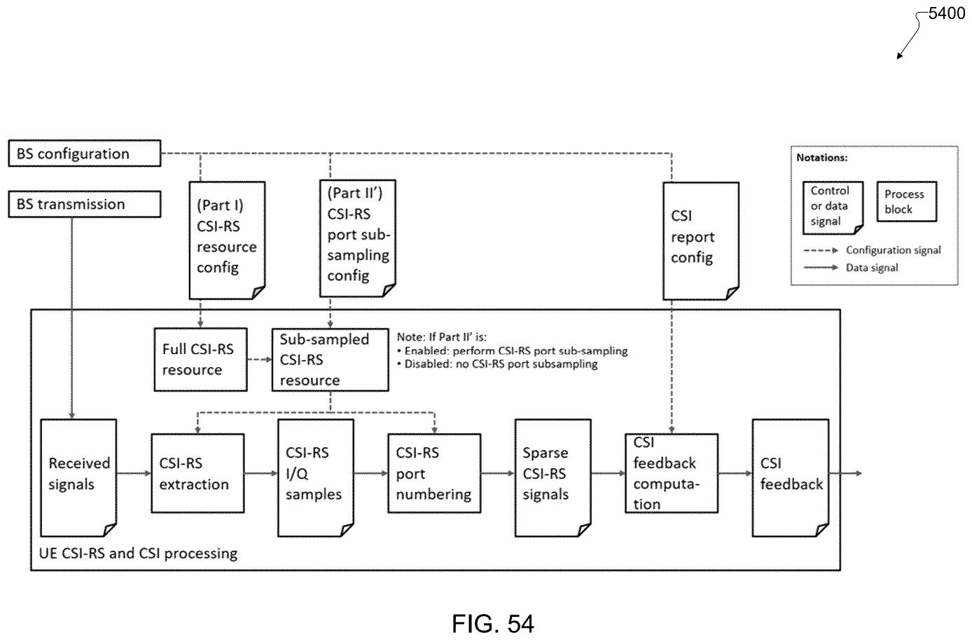

In some embodiments, a BS configures a sparse CSI-RS reception to a UE through Part I and Part II′, similar as shown in FIG. 54.

FIG. 54 illustrates another example configuration signaling for sparsely sub-sampled CSI-RS 5400 according to embodiments of the present disclosure. The embodiment of configuration signaling for sparsely sub-sampled CSI-RS of FIG. 54 is for illustration only. Different embodiments of configuration signaling for sparsely sub-sampled CSI-RS could be used without departing from the scope of this disclosure.

In the example of FIG. 54, the UE locates the time-frequency resource and obtains the CSI-RS port indexes, by jointly parsing Part I and Part II′ configurations. From Part I, the UE parses the CSI-RS resource before CSI-RS subsampling; From Part II′, the UE parses the CSI-RS resource down selection and CSI-RS port indexes. Then the UE conducts extraction of CSI-RS from received signal, CSI-RS port channel estimation and obtain CSI (e.g., in I/Q format), CSI-RS port numbering, and other process, (e.g. CSI reporting), according to other configurations from the BS (e.g., the CSI report config).

In addition:
If Part II′ has not been configured:
   The number of total CSI-RS ports equals the number of CSI-RS ports configured in Part I.
   The number of transmitted CSI-RS ports equals the number of CSI-RS ports configured in Part I.
   The CSI-RS port indexes uses the default numbering methodology in Part I.
If Part II′ has been configured:
   The number of total CSI-RS ports equals the number of CSI-RS ports configured in Part I.
   The number of transmitted CSI-RS ports is configured by Part II′. Such a number is smaller or equal to the number of CSI-RS ports configured in Part I.
   The CSI-RS port indexes uses the numbering configured by Part II′.

Although FIG. 54 illustrates one example of configuration signaling for sparsely sub-sampled CSI-RS 5400, various changes may be made to FIG. 54. For example, various changes to the number of ports could be made, etc., according to particular needs.

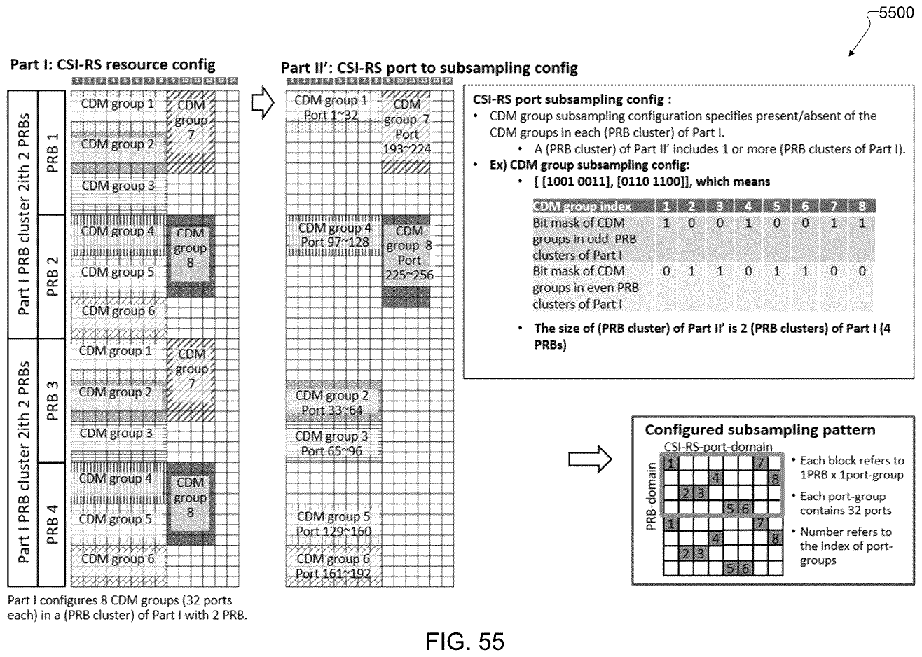

In some embodiments, the full port CSI-RS resource configuration is included in Part I. In embodiments such as these, Part II′ configures the present or absent of the CSI-RS ports configured in Part I. An example is shown in FIG. 55.

FIG. 55 illustrates another example configuration signaling for sparsely sub-sampled CSI-RS 5500 according to embodiments of the present disclosure. The embodiment of configuration signaling for sparsely sub-sampled CSI-RS of FIG. 55 is for illustration only. Different embodiments of configuration signaling for sparsely sub-sampled CSI-RS could be used without departing from the scope of this disclosure.

In the example of FIG. 55, which is an example of 256 port CSI-RS, Part I comprises configurations of 8 CDM group each with 32 CSI-RS ports in a PRB cluster of 2 PRBs, illustrated on the left side of FIG. 55. Part II′ comprises the CDM group subsampling configuration. N=2 bit masks are configured, where N is the size of PRB cluster of Part II′, which includes N of consecutive PRB clusters configured in Part I. N bits masks are configured for N consecutive PRB clusters configured in Part I. Each bit mask has 8 bits corresponding to the 8 CDM groups in the PRB cluster configured in Part I. The k-th bit in the bit mask indicates the present or absent of the k-th CDM group in the PRB cluster. Configured by Part I and Part II′, the resulting sparse CSI-RS sampling pattern in PRB and port group domain are shown on the bottom-right of FIG. 55. The Part II′ configuration is signaled through (i) RRC signaling, (ii) MAC-CE signaling, or (iii) both RRC signaling and MAC-CE signaling.

Although FIG. 55 illustrates one example of configuration signaling for sparsely sub-sampled CSI-RS 5500, various changes may be made to FIG. 55. For example, various changes to the number of ports could be made, etc., according to particular needs.

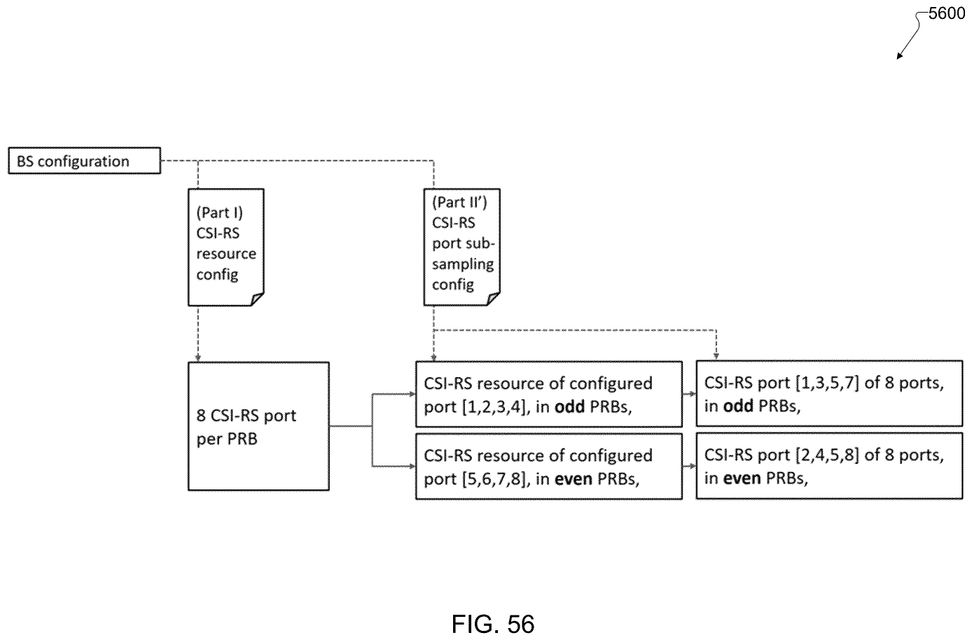

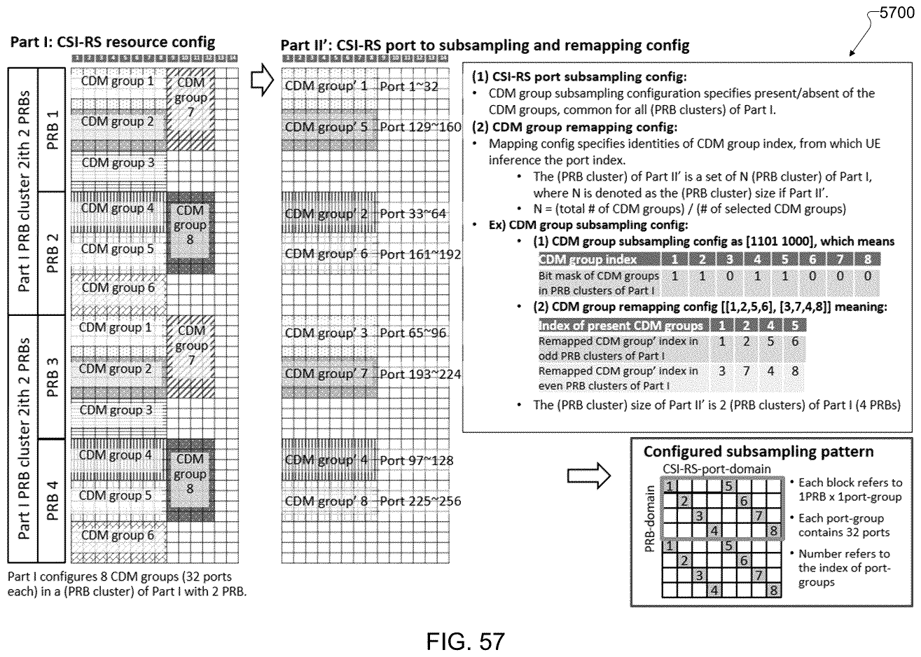

In some embodiments, the full port CSI-RS resource configuration is included in Part I. In embodiments such as these, Part II′ configures the presence or absence of the CSI-RS ports configured in Part I. Additionally, Part II′ configures the remapping of CSI-RS port index of the present CSI-RS ports. Examples are shown in FIG. 56 and FIG. 57.

FIG. 56 illustrates another example configuration signaling for sparsely sub-sampled CSI-RS 5600 according to embodiments of the present disclosure. The embodiment of configuration signaling for sparsely sub-sampled CSI-RS of FIG. 56 is for illustration only. Different embodiments of configuration signaling for sparsely sub-sampled CSI-RS could be used without departing from the scope of this disclosure.

In the example of FIG. 56, Part I configures 8 CSI-RS ports per PRB, in which the PRB cluster of Part I is 1 PRB. Part II′ configures the presence of absence of the CSI-RS ports with a pattern repeating every 2 PRBs or 2 PRB clusters of Part I configuration. The CSI-RS resource of ports #1˜ #4 are selected in the 1st PRB in every subband, then the CSI-RS ports #1, #3, #5, and #7 are mapped to the CSI-RS resource of the four ports. The CSI-RS resource of ports #5˜#8 are selected in the 2nd PRB in every subband, then the CSI-RS ports #2, #4, #6, and #8 are mapped to the CSI-RS resource of the four ports.

Although FIG. 56 illustrates one example of configuration signaling for sparsely sub-sampled CSI-RS 5600, various changes may be made to FIG. 56. For example, various changes to the number of ports could be made, etc., according to particular needs.

FIG. 57 illustrates another example configuration signaling for sparsely sub-sampled CSI-RS 5500 according to embodiments of the present disclosure. The embodiment of configuration signaling for sparsely sub-sampled CSI-RS of FIG. 57 is for illustration only. Different embodiments of configuration signaling for sparsely sub-sampled CSI-RS could be used without departing from the scope of this disclosure.

In the example of FIG. 57, which is an example of 256 port CSI-RS, Part I comprises configurations of 8 CDM group each with 32 CSI-RS ports in a PRB cluster of 2 PRBs, illustrated on the left side of FIG. 57. Part II comprises CDM group subsampling configuration though a bit mask with 8 bits, e.g., [1101 1000], which configures the CDM group [1, 2, 4, 5] are present and the CDM groups [3, 4, 7, 8] are absent. The subsampling configuration is common for all PRB clusters configured in Part I. Additionally, the CDM group index remapping is configured in Part II′. M=2 remapping vectors are configured. M is the size of PRB cluster of Part II′, which includes M consecutive PRB clusters configured in Part I. For each remapping vector has 4 entries, for to the 4 present CDM groups respectively. The value of the entry is the remapped index of CDM group (noted as CDM group'). In this example, the present CDM groups [1,2,4,5] are mapped with CDM group' [1,2,5,6] in the odd PRB clusters configured in part I; the present CDM groups [1,2,4,5] are mapped with CDM group' [3,7,4,8] in the even PRB clusters configured in part I; The CSI-RS port index is inferred from the index of CDM group' (remapped). Configured by Part I and Part II′, the resulting sparse CSI-RS sampling pattern in PRB and port group domain is on the bottom-right of FIG. 57 The Part II′ configuration is signaled through (i) RRC signaling, (ii) MAC-CE signaling, or (iii) both RRC signaling and MAC-CE signaling.

Although FIG. 57 illustrates one example of configuration signaling for sparsely sub-sampled CSI-RS 5700, various changes may be made to FIG. 57. For example, various changes to the number of ports could be made, etc., according to particular needs.

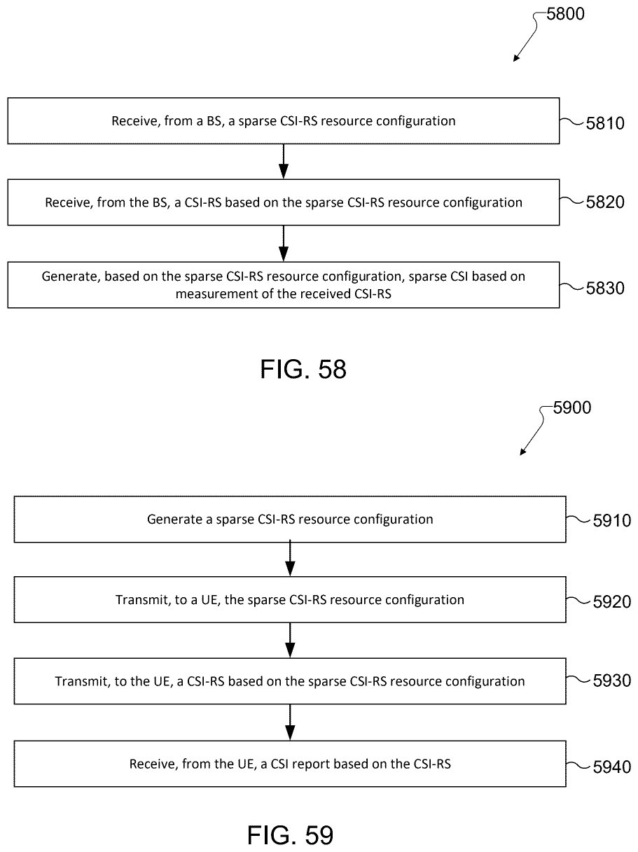

FIG. 58 illustrates an example method for low overhead CSI-RS transmission and CSI feedback 5800 according to embodiments of the present disclosure. An embodiment of the method illustrated in FIG. 58 is for illustration only. One or more of the components illustrated in FIG. 58 may be implemented in specialized circuitry configured to perform the noted functions or one or more of the components may be implemented by one or more processors executing instructions to perform the noted functions. Other embodiments of a method for low overhead CSI-RS transmission and CSI feedback could be used without departing from the scope of this disclosure.

In the example of FIG. 58, the method 5800 begins at step 5810. At step 5810, a UE receives, from a BS, sparse CSI-RS resource configuration.

In some embodiments, the sparse CSI-RS resource configuration may include a patch configuration. In embodiments such as these, the patch configuration may indicate at least one of a patch size, a patch shape, a shape index, and a patch indexing methodology.

In some embodiments, the sparse CSI-RS resource configuration may include a mapping pattern configuration. In embodiments such as these, the mapping pattern configuration may indicate at least one of a mapping pattern type, a density, a mapping pattern size, and an index of orthogonal mapping patterns.

In some embodiments, the sparse CSI-RS resource configuration includes a patch to physical resource mapping configuration. In embodiments such as these, the patch to physical resource mapping configuration may map CSI-RS ports associated with a patch to a single OFDM symbol. In some other embodiments, the patch to physical resource mapping configuration may map CSI-RS ports associated with a patch to a plurality of OFDM symbols. Still, in some other embodiments, the patch to physical resource mapping configuration may map CSI-RS ports associated with a patch to one or more CDM groups.

At step 5820, the UE receives, from the BS, a CSI-RS based on the sparse CSI-RS resource configuration. At step 5830, the UE generates, based on the sparse CSI-RS resource configuration, sparse CSI based on measurement of the received CSI-RS.

In some embodiments, the UE may in-paint CSI missing from the sparse CSI via a MAE to generate full-frequency CSI from the CSI-RS, use a Type-I or Type-II codebook to generate a full-frequency CSI report based on the full-frequency CSI, and transmit the full-frequency CSI report to the BS.

In some embodiments, the UE may in-paint CSI missing from the sparse CSI via a MAE to generate full-frequency CSI from the CSI-RS, use a compression auto encoder (CAE) to generate a full-frequency CSI report based on the full-frequency CSI, and transmit the full-frequency CSI report to the BS.

In some embodiments, the UE may use a Type-I or Type-II codebook to generate a sparse CSI report based on the sparse CSI, and transmit the sparse CSI report to the BS.

In some embodiments, the UE may a compression auto encoder (CAE) to generate a sparse CSI report based on the sparse CSI, and transmit the sparse CSI report to the BS.

Although FIG. 58 illustrates one example method for low overhead CSI-RS transmission and CSI feedback 5800, various changes may be made to FIG. 58. For example, while shown as a series of steps, various steps in FIG. 58 could overlap, occur in parallel, occur in a different order, occur any number of times, be omitted, or replaced by other steps.

FIG. 59 illustrates another example method for low overhead CSI-RS transmission and CSI feedback 5900 according to embodiments of the present disclosure. An embodiment of the method illustrated in FIG. 59 is for illustration only. One or more of the components illustrated in FIG. 59 may be implemented in specialized circuitry configured to perform the noted functions or one or more of the components may be implemented by one or more processors executing instructions to perform the noted functions. Other embodiments of a method for low overhead CSI-RS transmission and CSI feedback could be used without departing from the scope of this disclosure.

In the example of FIG. 59, the method 5900 begins at step 5910. At step 5910, a BS generates a sparse CSI-RS resource configuration.

In some embodiments, the sparse CSI-RS resource configuration may include a patch configuration. In embodiments such as these, the patch configuration may indicate at least one of a patch size, a patch shape, a shape index, and a patch indexing methodology.

In some embodiments, the sparse CSI-RS resource configuration may include a mapping pattern configuration. In embodiments such as these, the mapping pattern configuration may indicate at least one of a mapping pattern type, a density, a mapping pattern size, and an index of orthogonal mapping patterns.

In some embodiments, the sparse CSI-RS resource configuration includes a patch to physical resource mapping configuration. In embodiments such as these, the patch to physical resource mapping configuration may map CSI-RS ports associated with a patch to a single OFDM symbol. In some other embodiments, the patch to physical resource mapping configuration may map CSI-RS ports associated with a patch to a plurality of OFDM symbols. Still, in some other embodiments, the patch to physical resource mapping configuration may map CSI-RS ports associated with a patch to one or more CDM groups.

At step 5920, the BS transmits, to a UE, the sparse CSI-RS resource configuration. At step 5930, the BS transmits, to the UE, a CSI-RS based on the sparse CSI-RS resource configuration. At step 5940, the BS receives, from the UE, a CSI report based on the CSI-RS.

In some embodiments, the CSI report may be a full-frequency CSI report is generated by the UE using a Type-I or Type-II codebook, and the BS may reconstruct full-frequency CSI from the full-frequency CSI report using the Type-I or Type-II codebook.

In some embodiments, the CSI report may be a full-frequency CSI report is generated by the UE using a CAE, and the BS may reconstruct full-frequency CSI from the full-frequency CSI report using a CSI decompressor.

In some embodiments, the CSI report may be a sparse CSI report is generated by the UE using a Type-I or Type-II codebook, and the BS may reconstruct sparse CSI from the sparse CSI report using a CSI decompressor. The BS may also in-paint CSI missing from the sparse CSI via a MAE to generate full-frequency CSI from the sparse CSI.

In some embodiments, the CSI report may be a sparse CSI report is generated by the UE using a CAE, and the BS may reconstruct sparse CSI from the sparse CSI report using a CSI decompressor. The BS may also in-paint CSI missing from the sparse CSI via a MAE to generate full-frequency CSI from the sparse CSI.

Although FIG. 59 illustrates one example method for low overhead CSI-RS transmission and CSI feedback 5900, various changes may be made to FIG. 59. For example, while shown as a series of steps, various steps in FIG. 59 could overlap, occur in parallel, occur in a different order, occur any number of times, be omitted, or replaced by other steps.

ReAny of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), a sparse channel state information (CSI)-reference signal (RS) resource configuration; and
receive, from the BS, a CSI-RS based on the sparse CSI-RS resource configuration; and
a processor operably coupled to the transceiver, the processor configured to generate, based on the sparse CSI-RS resource configuration, sparse CSI based on measurement of the received CSI-RS.

2. The UE of claim 1, wherein:
the sparse CSI-RS resource configuration includes a patch configuration, and
the patch configuration indicates at least one of a patch size, a patch shape, a shape index, and a patch indexing methodology.

3. The UE of claim 1, wherein:
the sparse CSI-RS resource configuration includes a mapping pattern configuration, and
the mapping pattern configuration indicates at least one of a mapping pattern type, a density, a mapping pattern size, and an index of orthogonal mapping patterns.

4. The UE of claim 1, wherein:
the sparse CSI-RS resource configuration includes a patch to physical resource mapping configuration, and
the patch to physical resource mapping configuration maps CSI-RS ports associated with a patch to a single orthogonal frequency division multiplexing (OFDM) symbol.

5. The UE of claim 1, wherein:
the sparse CSI-RS resource configuration includes a patch to physical resource mapping configuration, and
the patch to physical resource mapping configuration maps CSI-RS ports associated with a patch to a plurality of orthogonal frequency division multiplexing (OFDM) symbols.

6. The UE of claim 1, wherein:
the sparse CSI-RS resource configuration includes a patch to physical resource mapping configuration, and
the patch to physical resource mapping configuration maps CSI-RS ports associated with a patch to one or more code division multiplexing (CDM) groups.

7. The UE of claim 1, wherein:
the processor is further configured to:
in-paint CSI missing from the sparse CSI via a masked auto encoder (MAE) to generate full-frequency CSI from the CSI-RS; and
use a Type-I or Type-II codebook to generate a full-frequency CSI report based on the full-frequency CSI; and
the transceiver is further configured to transmit the full-frequency CSI report to the BS.

8. The UE of claim 1, wherein:
the processor is further configured to:
in-paint CSI missing from the sparse CSI via a masked auto encoder (MAE) to generate full-frequency CSI from the CSI-RS; and
use a compression auto encoder (CAE) to generate a full-frequency CSI report based on the full-frequency CSI; and
the transceiver is further configured to transmit the full-frequency CSI report to the BS.

9. The UE of claim 1, wherein:
the processor is further configured to use a Type-I or Type-II codebook to generate a sparse CSI report based on the sparse CSI; and
the transceiver is further configured to transmit the sparse CSI report to the BS.

10. The UE of claim 1, wherein:
the processor is further configured to use a compression auto encoder (CAE) to generate a sparse CSI report based on the sparse CSI; and
the transceiver is further configured to transmit the sparse CSI report to the BS.

11. A base station (BS) comprising:
A processor configured to generate a sparse channel state information (CSI)-reference signal (RS) resource configuration; and
a transceiver operably coupled to the processor, the transceiver configured to:
transmit, to a user equipment (UE), the sparse CSI-RS resource configuration;
transmit, to the UE, a CSI-RS based on the sparse CSI-RS resource configuration; and
receive, from the UE, a CSI report based on the CSI-RS.

12. The BS of claim 11, wherein:
the sparse CSI-RS resource configuration includes a patch configuration, and
the patch configuration indicates at least one of a patch size, a patch shape, a shape index, and a patch indexing methodology.

13. The BS of claim 11, wherein:
the sparse CSI-RS resource configuration includes a mapping pattern configuration, and
the mapping pattern configuration indicates at least one of a mapping pattern type, a density, a mapping pattern size, and an index of orthogonal mapping patterns.

14. The BS of claim 11, wherein:
the sparse CSI-RS resource configuration includes a patch to physical resource mapping configuration, and
the patch to physical resource mapping configuration maps CSI-RS ports associated with a patch to a single orthogonal frequency division multiplexing (OFDM) symbol.

15. The BS of claim 11, wherein:
the sparse CSI-RS resource configuration includes a patch to physical resource mapping configuration, and
the patch to physical resource mapping configuration maps CSI-RS ports associated with a patch to a plurality of orthogonal frequency division multiplexing (OFDM) symbols.

16. The BS of claim 11, wherein:
the sparse CSI-RS resource configuration includes a patch to physical resource mapping configuration, and
the patch to physical resource mapping configuration maps CSI-RS ports associated with a patch to one or more code division multiplexing (CDM) groups.

17. The BS of claim 11, wherein:
the CSI report is a full-frequency CSI report;
the full-frequency CSI report is generated by the UE using a Type-I or Type-II codebook; and
the processor is further configured to reconstruct full-frequency CSI from the full-frequency CSI report using the Type-I or Type-II codebook.

18. The BS of claim 11, wherein:
the CSI report is a full-frequency CSI report;
the full-frequency CSI report is generated by the UE using a compression auto encoder (CAE); and
the processor is further configured to reconstruct full-frequency CSI from the full-frequency CSI report using a CSI decompressor.

19. The BS of claim 11, wherein:
the CSI report is a sparse CSI report;
the sparse CSI report is generated by the UE using a Type-I or Type-II codebook; and
the processor is further configured to:
reconstruct sparse CSI from the sparse CSI report using a CSI decompressor; and
in-paint CSI missing from the sparse CSI via a masked auto encoder (MAE) to generate full-frequency CSI from the sparse CSI.

20. The BS of claim 11, wherein:
the CSI report is a sparse CSI report;
the sparse CSI report is generated by the UE using a compression auto encoder (CAE); and
the processor is further configured to:
reconstruct sparse CSI from the sparse CSI report using a CSI decompressor; and
in-paint CSI missing from the sparse CSI via a masked auto encoder (MAE) to generate full-frequency CSI from the sparse CSI.
